(19) United States
(12) Patent Application Publication
(10) Pub. No.: US 2026/0349853 A1
(43) Pub. Date: Nov. 5, 2026

(54) System and Method for automated credential generation and propagation based on Artificial Intelligence Agents

(71) Applicant: RedBlock Security, Inc., San Ramon, CA (US)

(72) Inventors: Indus Khaitan, Dublin, CA (US); Rajvardhan Khaitan, Dublin, CA (US); Basem Rizk, Pleasant Hill, CA (US); Aviral Srivastava, Bengaluru (IN)

(73) Assignee: RedBlock Security, Inc., San Ramon, CA (US)

(21) Appl. No.: 19/667,329

(22) Filed: May 4, 2026

Related U.S. Application Data
(60) Provisional application No. 63/799,167, filed on May 2, 2025.
(60) Provisional application No. 63/799,176, filed on May 2, 2025.
(60) Provisional application No. 63/799,184, filed on May 2, 2025.
(60) Provisional application No. 63/799,188, filed on May 2, 2025.
(60) Provisional application No. 63/799,193, filed on May 2, 2025.
(60) Provisional application No. 63/799,199, filed on May 2, 2025.
(60) Provisional application No. 63/810,356, filed on May 22, 2025.
(60) Provisional application No. 63/837,276, filed on Jul. 2, 2025.
(60) Provisional application No. 63/872,640, filed on Aug. 29, 2025.
(60) Provisional application No. 63/872,656, filed on Aug. 29, 2025.
(60) Provisional application No. 63/872,665, filed on Aug. 29, 2025.
(60) Provisional application No. 63/878,629, filed on Sep. 9, 2025.
(60) Provisional application No. 63/880,059, filed on Sep. 11, 2025.
(60) Provisional application No. 63/881,837, filed on Sep. 15, 2025.
(60) Provisional application No. 63/887,721, filed on Sep. 25, 2025.

(51) Int. Cl. G06F 9/54; G06F 21/46; G06V 10/764; G06V 10/82

(52) U.S. Cl. CPC G06F 9/543; G06F 21/46; G06V 10/764; G06V 10/82

(57) ABSTRACT

An agent automates credential generation and identity lifecycle transactions across enterprise applications. The agent applies a trained machine learning model to a pixel-level rendering of a graphical user interface of a producer application to identify credential interface elements that, upon activation, cause the producer application to generate a credential. The agent activates the identified credential interface elements, extracts the credential from the graphical user interface, and propagates the credential to a consumer application by interacting with an existing graphical user interface of the consumer application. The agent further receives a state-change signal from an authoritative system of record, translates an identity lifecycle policy into a sequence of atomic identity lifecycle actions, and effects each atomic action through visual identification and activation of identity lifecycle interface elements rendered within a graphical user interface of an application. The agent, the producer application, and the consumer application execute as distinct computing processes.

### PRIORITY PARA

This application claims the benefit of U.S. Provisional Patent Application No. 63/799,167, filed on May 2, 2025, titled “SYSTEM AND METHOD FOR AGGREGATING API KEYS FROM APPLICATIONS USING ARTIFICIAL INTELLIGENCE” (Atty. Docket No. RDBL1000USP01); U.S. Provisional Patent Application No. 63/799,176, filed on May 2, 2025, titled “SYSTEM AND METHOD FOR UPDATING AND PROPAGATING API KEYS USING ARTIFICIAL INTELLIGENCE” (Atty. Docket No. RDBL1001USP01); U.S. Provisional Patent Application No. 63/799,184, filed on May 2, 2025, titled “SYSTEM FOR REPORTING AND ACTIONING OF USER ROLES IN IDENTITY GOVERNANCE CONTEXT USING ARTIFICIAL INTELLIGENCE” (Atty. Docket No. RDBL1002USP01); U.S. Provisional Patent Application No. 63/799,188, filed on May 2, 2025, titled “SYSTEM FOR DETECTION AND REMEDIATION OF SECURITY CONFIGURATION DRIFTS IN WEB APPLICATIONS USING INTERFACE-CENTRIC AI AGENTS” (Atty. Docket No. RDBL1003USP01); U.S. Provisional Patent Application No. 63/799,193, filed on May 2, 2025, titled “SYSTEM AND METHOD FOR CAPTURING AND AUDITING WEB-BASED AI AGENT INTERACTIONS” (Atty. Docket No. RDBL1004USP01); U.S. Provisional Patent Application No. 63/799,199, filed on May 2, 2025, titled “SYSTEM AND METHOD FOR AUTOMATED CREDENTIAL GENERATION AND PROPAGATION BASED ON ARTIFICIAL INTELLIGENCE AGENTS” (Atty. Docket No. RDBL1005USP01); U.S. Provisional Patent Application No. 63/810,356, filed on May 22, 2025, titled “System and Method for Deterministic Validation of Automation Workflows Guided by Large Language Models” (Atty. Docket No. RDBL1006USP01); U.S. Provisional Patent Application No. 63/837,276, filed on Jul. 2, 2025, titled “SYSTEM AND METHOD FOR AUTOMATED EXPLORATION OF APPLICATION SOFTWARE” (Atty. Docket No. RDBL1007USP01); U.S. Provisional Patent Application No. 63/880,059, filed on Sep. 11, 2025, titled “SYSTEM AND METHOD FOR AUTOMATED EXPLORATION OF APPLICATION SOFTWARE” (Atty. Docket No. RDBL1007USP02); U.S. Provisional Patent Application No. 63/872,640, filed on Aug. 29, 2025, titled “SYSTEM AND METHOD FOR INTEGRATING NON-API APPLICATIONS WITH IDENTITY PLATFORMS BASED ON ARTIFICIAL INTELLIGENCE” (Atty. Docket No.

RDBL1008USP01); U.S. Provisional Patent Application No. 63/878,629, filed on Sep. 9, 2025, titled “SYSTEM AND METHOD FOR INTEGRATING NON-API APPLICATIONS WITH IDENTITY PLATFORMS BASED ON ARTIFICIAL INTELLIGENCE” (Atty. Docket No. RDBL1008USP02); U.S. Provisional Patent Application No. 63/887,721, filed on Sep. 25, 2025, titled “HIERARCHICAL STRUCTURING OF GRAPHICAL USER INTERFACE ELEMENTS IN APPLICATION SOFTWARE PAGES” (Atty. Docket No. RDBL1009USP01); U.S. Provisional Patent Application No. 63/872,656, filed on Aug. 29, 2025, titled “SYSTEM AND METHOD FOR IDENTITY-CENTRIC ACTIVITY LOG CAPTURE FROM APPLICATIONS LACKING PROGRAMMATIC INTERFACES” (Atty. Docket No. RDBL1010USP01); U.S. Provisional Patent Application No. 63/872,665, filed on Aug. 29, 2025, titled “AGENTIC ARTIFICIAL INTELLIGENCE FOR AUTOMATED CONNECTOR CONFIGURATION AND APPLICATION ONBOARDING IN IDENTITY PLATFORMS” (Atty. Docket No. RDBL1011USP01); and U.S. Provisional Patent Application No. 63/881,837, filed on Sep. 15, 2025, titled “TASK-SPECIFIC HIGH-LEVEL LANGUAGE FRAMEWORK FOR STRUCTURED INTERACTION WITH LARGE LANGUAGE MODELS” (Atty. Docket No. RDBL1012USP01). All of the foregoing provisional applications are hereby incorporated by reference for all purposes.

### TECHNICAL FIELD

The technology disclosed relates to artificial-intelligence-type computers, digital data processing systems, corresponding data processing methods, and products for emulation of intelligence, including knowledge-based systems, reasoning systems, knowledge acquisition systems, systems for reasoning with uncertainty, adaptive systems, machine learning systems, and artificial neural networks. More particularly, the technology relates to application security management, and specifically to automated systems and methods for detecting and remediating security configuration drifts across enterprise web applications using AI agents configured to read and interact with graphical user interfaces (GUIs) of those applications.

The technology disclosed relates to artificial-intelligence-type computers, digital data processing systems, corresponding data processing methods, and products for emulation of intelligence, including knowledge-based systems, reasoning systems, knowledge acquisition systems, systems for reasoning with uncertainty, adaptive systems, machine learning systems, and artificial neural networks. More particularly, the technology relates to enterprise identity and access management, and specifically to automated systems and methods for credential generation, credential propagation, and identity lifecycle automation across enterprise applications using AI agents configured to identify and activate interface elements rendered within graphical user interfaces (GUIs) of those applications.

### BACKGROUND

Modern enterprises rely on a heterogeneous estate of applications, including software-as-a-service platforms, customer relationship management tools, financial reporting systems, internal administrative dashboards, application programming interface key management consoles, third-party partner platforms, and cloud service provider consoles. Each application exposes its own administrative graphical user interface for credential and identity lifecycle operations, including issuance of application programming interface keys, generation of authentication tokens, configuration of OAuth credentials, enrollment of identity certificates, creation of user accounts, modification of user roles and group memberships, and deactivation of user accounts. A material subset of these applications exposes credential and identity lifecycle operations through rendered graphical user interfaces without providing corresponding structured application programming interfaces for those operations, or with application programming interfaces that are published on a delayed cadence or that cover only a subset of the operations exposed through the graphical user interface. Security administrators and identity governance teams are therefore required to manually issue credentials at producer applications, distribute the issued credentials to consumer applications, and execute identity lifecycle changes across the enterprise estate by interacting with the respective graphical user interfaces. The manual workflow does not scale across an enterprise estate of tens or hundreds of participating applications and is difficult to reconcile with regulatory and contractual frameworks that require ongoing evidence of credential and identity lifecycle compliance.

Existing automated approaches do not adequately address this problem. Application-programming-interface-based identity governance and administration platforms query each application's backend through structured interfaces and accordingly have limited reach over credential and identity lifecycle operations that are accessible through the rendered graphical user interface of the respective application. Robotic process automation tools and general-purpose screen automation utilities navigate rendered interfaces, but they rely on hand-coded interface element locators that fracture upon revisions to the graphical user interface and are designed for general task automation rather than for credential and identity lifecycle operations across an enterprise application estate. As a result, an unaddressed gap exists between application-programming-interface-based identity governance tools and general-purpose interface automation tools, and a need remains for an improved technique for credential generation, credential propagation, and identity lifecycle automation across enterprise applications at scale.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A illustrates an exemplary system architecture of an application management platform for deploying one or more artificial intelligence (AI) agent systems for enterprise application management, according to certain embodiments.

FIG. 1B illustrates an exemplary system architecture of a single AI agent system deployed within a network environment including a plurality of enterprise users, a plurality of agent command systems, and a set of enterprise applications, according to certain embodiments.

FIG. 1C illustrates an alternative system architecture of the application management platform in which the AI agent system is communicatively coupled to agent command systems and a set of enterprise applications through a plurality of networks, according to certain embodiments.

FIG. 2A illustrates an architectural diagram depicting an evolution of enterprise infrastructure models from network centric paradigms to application and data centric paradigms, according to certain embodiments.

FIG. 2B is a block diagram of an AI agent based enterprise identity orchestration and credential automation platform, according to certain embodiments.

FIG. 2C is an architectural diagram illustrating integration of AI agent based identity governance across connected applications and disconnected applications within a hybrid enterprise infrastructure, according to certain embodiments.

FIG. 2D is a connectivity framework diagram between enterprise users, an identity control system, and a plurality of applications integrated with an AI agent system, according to certain embodiments.

FIG. 2E is a system workflow diagram showing an AI agent driven remediation process initiated by contextual security signals and executed across enterprise applications, according to certain embodiments.

FIG. 2F illustrates a conceptual diagram depicting AI agent behavioral learning for autonomous execution of identity lifecycle tasks across a large set of business applications, according to certain embodiments.

FIG. 3A illustrates an exemplary internal architecture of an agentic AI platform including a perception module, a planning module, an execution module, and supporting identity governance modules deployed within an enterprise network infrastructure, according to certain embodiments.

FIG. 3B illustrates a system architecture of a graphical user interface (GUI)-based agentic AI credential automation system configured to interface with producer applications, consumer applications, and a credential vault via GUI-based interactions, according to certain embodiments.

FIG. 4 is a system architecture for automated credential generation and propagation through visual identification and activation of graphical user interface elements, according to certain embodiments.

FIG. 5 is a block diagram illustrating an internal decomposition of an agent into an agent execution manager, a credential generation agent, a copy-paste interface automation module, and a credential storage workflow engine, according to certain embodiments.

FIG. 6 is a flowchart depicting a method for automated credential generation and propagation performed by an agent through interaction with a graphical user interface of a producer application, according to certain embodiments.

FIG. 7 illustrates an exemplary architecture of a trained autoencoder configured to produce visual feature representations of interface elements from pixel-level rendering of a graphical user interface and to classify the visual feature representations into credential interface elements and non-credential interface elements, according to certain embodiments.

FIG. 8 is an architectural diagram illustrating a triangulation between a producer application, an agent, and a consumer application as distinct computing processes executing in respective process contexts, according to certain embodiments.

FIG. 9 illustrates an exemplary copy-paste credential propagation workflow performed across a graphical user interface of a producer application and an existing graphical user interface of a consumer application, according to certain embodiments.

FIG. 10 illustrates an example identity lifecycle propagation workflow for a leaver event performed through visual identification and activation of graphical user interface elements, in accordance with example embodiments of the disclosure.

FIG. 11 illustrates an example identity lifecycle propagation workflow for a mover event performed through visual identification and activation of graphical user interface elements, in accordance with example embodiments of the disclosure.

FIG. 12 illustrates an example identity lifecycle propagation workflow for a joiner event performed through visual identification and activation of graphical user interface elements, in accordance with example embodiments of the disclosure.

FIG. 13 is a block diagram of a credential vault configured to provide encryption-at-rest, role-based retrieval, credential versioning and rotation, and time-to-live expiration of stored credentials, according to certain embodiments.

FIG. 14 illustrates an exemplary adaptation of an agent to changes in a graphical user interface of a producer application through reapplication of a trained autoencoder to a modified graphical user interface, according to certain embodiments.

FIG. 15 is a workflow diagram depicting parallel triggering of a credential generation agent, a copy-paste interface automation module, and a credential storage workflow engine by an agent execution manager within an atomic transaction boundary, according to certain embodiments.

FIG. 16 illustrates a credential lifecycle timeline and a tamper-evident audit record stored in a secure audit repository for each performance of the method, according to certain embodiments.

FIG. 17 is a hardware view of a computing system on which an agent for automated credential generation and propagation is implemented, according to certain embodiments.

FIG. 18 illustrates a block diagram of an example trigger ingestion sub-architecture for receiving, validating, deduplicating, and dispatching identity lifecycle state-change signals, in accordance with example embodiments of the disclosure.

FIG. 19 illustrates a block diagram of an example policy interpretation pipeline for translating identity lifecycle policy into one or more atomic graphical user interface actions, in accordance with example embodiments of the disclosure.

FIG. 20 illustrates a block diagram of an example cross-application identity lifecycle propagation architecture for propagating a single identity lifecycle event across a plurality of consumer applications under a cross-application atomic transaction boundary, in accordance with example embodiments of the disclosure.

FIG. 21 is a schematic representation of an encoder-decoder architecture.

FIG. 22 shows an overview of an attention mechanism added onto an RNN encoder-decoder architecture.

FIG. 23 is a schematic representation of the calculation of self-attention showing one attention head.

FIG. 24 is a depiction of several attention heads in a Transformer block.

FIG. 25 is an illustration that shows how one can use multiple workers to compute the multi-head attention in parallel, as the respective heads compute their outputs independently of one another.

FIG. 26 is a portrayal of one encoder layer of a Transformer network.

FIG. 27 shows a schematic overview of a Transformer model.

FIG. 28 is a depiction of a Vision Transformer (ViT).

FIG. 29 illustrates a processing flow of the Vision Transformer (ViT).

FIG. 30 shows example software code that implements a Transformer block.

FIG. 31 illustrates an example configuration of a computing device that can be used to implement the systems and techniques described herein.

### DETAILED DESCRIPTION OF DRAWINGS

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

### Overview

The implementations described herein introduce systems and methods for automated credential generation and propagation through visual identification and activation of graphical user interface (GUI) elements. In some implementations, an agent operates as an autonomous orchestration entity interposed between a producer application and a consumer application. The agent receives a credential generation trigger from an identity control system. The agent then captures a pixel-level rendering of a GUI of the producer application. The agent applies a trained autoencoder to produce visual feature representations of the pixel-level rendering. The agent classifies regions of the pixel-level rendering as credential interface elements based on the visual feature representations. The agent activates the credential interface elements to elicit generation of a newly-created credential at the producer application. The agent then propagates the newly-created credential to one or more consumer applications.

The disclosed approach treats interface-centric visual automation as a core building block of enterprise identity governance. The approach enables deployment across heterogeneous application portfolios that include legacy systems, third-party software-as-a-service platforms, and disconnected applications that do not expose programmatic interfaces. The system performs end-to-end credential generation, propagation, and storage exclusively through interaction with rendered GUIs. The system thereby eliminates dependency on bespoke programmatic integration adapters, accommodates GUI redesigns at participating applications without retraining of the trained autoencoder, and produces tamper-evident audit records of the credential lifecycle for regulatory compliance.

### Indicia of Novelty, Inventiveness, Non-Obviousness, and Subject-Matter Eligibility

The following description identifies technical effects and concrete improvements to computer functionality produced by the technology disclosed. The technology disclosed is rooted in specific technical mechanisms that operate on defined data structures, execute through processor instructions, and produce tangible improvements to the credential generation and propagation system 400 and to the functioning of the underlying computing system.

### Concrete Improvement to a Technological Process

The system 400 is directed to a concrete technological process. The credential generation agent 406 captures a pixel-level rendering of the graphical user interface 424 of the producer application 422 through a graphical user interface ingestion component, which performs frame buffer reads or operating-system-level rendering hooks against the producer application 422. The trained autoencoder of the credential generation agent 406 receives the pixel-level rendering and produces visual feature representations of regions of the pixel-level rendering, the visual feature representations being computed through a sequence of learned convolutional and attention transformations parameterized by trained model weights. The credential interface element classifier of the credential generation agent 406 receives the visual feature representations and produces coordinate-and-label outputs that identify credential interface elements rendered within the graphical user interface 424. The activation triggering logic of the credential generation agent 406 emits input events directed to coordinates of the identified credential interface elements, the input events comprising pointer events, keyboard events, and synthetic touch events delivered through operating-system-level input event interfaces. The copy submodule 408A of the copy-paste interface automation module 408 detects the copy interface element rendered within the graphical user interface 424 following generation of the newly-created credential, activates the copy interface element through a corresponding input event, and stores the newly-created credential in a credential extraction buffer of the agent 404. The paste submodule 408B detects the paste interface element rendered within the existing graphical user interface 428 of the consumer application 426, activates the paste interface element through a corresponding input event, and delivers the newly-created credential from the credential extraction buffer into a corresponding input field of the existing graphical user interface 428. The credential storage workflow engine 412 injects the newly-created credential into the credential vault 420 in encrypted-at-rest form together with credential metadata characterizing the credential type, validity window, scope, owning identity, and source producer application. The agent execution manager 414 orchestrates parallel or sequential execution of the credential generation agent 406, the copy-paste interface automation module 408, and the credential storage workflow engine 412 within an atomic transaction boundary that produces a binary commit or rollback outcome based on collective success or failure of the constituent submodules. The technology disclosed therefore improves a concrete technological process by replacing the application-programming-interface-bound, locator-bound, single-application credential operation approach of existing identity governance and robotic process automation tools with an integrated visual identification, interface activation, copy-paste propagation, encrypted vault storage, and atomic transactional orchestration system that performs specific computational operations on defined data structures.

### Visual Identification of Credential Interface Elements Through a Trained Autoencoder Operating on Pixel-Level Renderings

Existing identity governance and administration platforms identify credential operation targets through structured application programming interfaces published by the target application. A platform that consumes only application programming interfaces of the target application captures the operations exposed under those interfaces but does not identify operations that are accessible only through the rendered graphical user interface of the target application, and does not operate against target applications that do not expose application programming interfaces for the relevant credential operations. Existing robotic process automation tools identify interface elements through hand-coded interface element locators expressed as XPath queries, cascading style sheet selectors, document object model traversals, or template-based image matches. The hand-coded interface element locators fracture upon revisions to the structure, styling, or layout of the rendered graphical user interface and require per-application engineering investment to author and maintain.

The technology disclosed identifies credential interface elements through a trained autoencoder operating on pixel-level renderings. The graphical user interface ingestion component of the credential generation agent 406 captures the pixel-level rendering of the graphical user interface 424 through frame buffer reads or operating-system-level rendering hooks. The trained autoencoder of the credential generation agent 406 receives the pixel-level rendering and produces visual feature representations of regions of the pixel-level rendering through an encoder network that maps the pixel-level rendering into a latent space of reduced dimensionality. The credential interface element classifier of the credential generation agent 406 receives the visual feature representations from the latent space and produces a classification output that distinguishes credential interface elements from non-credential interface elements rendered within the pixel-level rendering, the classification output comprising coordinates of the credential interface elements and labels associated with each set of coordinates. The trained autoencoder is trained on a corpus of pixel-level renderings of graphical user interfaces collected from a plurality of producer applications, the training applying a composite loss function that combines a reconstruction loss between the pixel-level rendering provided as input and a reconstruction produced by a decoder network of the trained autoencoder, and a classification loss between the classification output produced by the credential interface element classifier and ground-truth annotations of the corpus. The trained autoencoder thereby identifies credential interface elements across producer applications that the trained autoencoder has not previously encountered, and across revisions to the graphical user interface of a producer application that the trained autoencoder has previously encountered. This mechanism eliminates the application-programming-interface dependency of existing identity governance platforms and the locator brittleness of existing robotic process automation tools, and produces a substrate of identified credential interface elements on which downstream activation, extraction, and propagation operations are performed.

### Triangulated Three-Process Architecture Among Producer Application, Agent, and Consumer Application

Existing credential operation approaches couple the credential operation logic with either the producer application that issues the credential or the consumer application that consumes the credential. A platform that operates as a per-application connector running within the address space of the producer application performs credential operations only at that producer application and requires a corresponding connector at each consumer application that the credential is to be propagated to. A platform that operates as a per-application connector running within the address space of the consumer application performs credential consumption only at that consumer application and depends on the producer application to deliver the credential through a structured channel.

The technology disclosed implements a triangulated arrangement among three distinct computing processes comprising the producer application 422 representing a first computing process, the agent 404 representing a second computing process, and the consumer application 426 representing a third computing process. The first computing process, the second computing process, and the third computing process execute on a single hardware platform under separate process boundaries enforced by an operating system, on multiple hardware platforms communicatively coupled through a network, or on a combination of hardware platforms within a hybrid deployment topology. The agent 404 communicates with the producer application 422 through capture of a pixel-level rendering of the graphical user interface 424 and emission of input events directed to coordinates of identified credential interface elements rendered within the graphical user interface 424. The agent 404 communicates with the consumer application 426 through capture of a pixel-level rendering of the existing graphical user interface 428 and emission of input events directed to coordinates of identified paste interface elements rendered within the existing graphical user interface 428. The agent 404 thereby performs the credential generation operation at the producer application 422 and the credential consumption operation at the consumer application 426 without requiring co-residency with either the producer application 422 or the consumer application 426 and without requiring the producer application 422 or the consumer application 426 to expose application programming interfaces for the credential operations. This mechanism eliminates the per-application connector dependency of existing credential operation approaches and produces an application-agnostic credential automation fabric in which a single trained autoencoder of the agent 404 generalizes across the producer application 422 and the consumer application 426 of arbitrary heterogeneous applications.

### Atomic Transactional Orchestration of Constituent Submodules within a Bounded Autonomy Span

Existing credential operation approaches execute the constituent operations of credential issuance, credential propagation, and credential storage as independent steps without a transactional boundary that binds the steps to a single commit-or-rollback outcome. A platform that issues a credential at the producer application and propagates the credential to the consumer application without a transactional boundary leaves the producer application and the consumer application in inconsistent states upon failure of any constituent step, with the credential issued at the producer application but not delivered to the consumer application, or with the credential delivered to the consumer application but not stored in the credential vault. The inconsistent states require manual reconciliation and produce orphaned credentials that constitute a security exposure.

The technology disclosed orchestrates the constituent operations of credential issuance, credential propagation, and credential storage within an atomic transaction boundary maintained by the agent execution manager 414. The agent execution manager 414 receives a credential generation instruction from the identity control system 402, decomposes the credential generation instruction into atomic tasks comprising at least one of credential creation, credential update, credential removal, credential rotation, and credential propagation, and dispatches the atomic tasks to the credential generation agent 406, the copy-paste interface automation module 408, and the credential storage workflow engine 412 for parallel or sequential execution within the atomic transaction boundary. The agent execution manager 414 tracks an outcome status of each atomic task reported by the credential generation agent 406, the copy-paste interface automation module 408, and the credential storage workflow engine 412 upon completion of the corresponding atomic task. The agent execution manager 414 commits the credential generation and propagation workflow upon receipt of a success outcome status from each of the credential generation agent 406, the copy-paste interface automation module 408, and the credential storage workflow engine 412, and rolls back partial state upon receipt of a failure outcome status from any of the credential generation agent 406, the copy-paste interface automation module 408, and the credential storage workflow engine 412. The rollback emits compensating operations that invalidate the newly-created credential at the producer application 422 through invocation of a credential revocation operation, remove the newly-created credential from the credential vault 420, and remove the newly-created credential from the existing graphical user interface 428 of the consumer application 426. This mechanism eliminates the partial-state inconsistency of existing credential operation approaches and produces a single coherent commit or rollback outcome across the producer application 422, the consumer application 426, and the credential vault 420.

### Tamper-Evident Audit Record Schema Anchored to Operative Steps Within an Autonomy Span

Existing credential operation approaches record credential operations through unstructured log files appended by individual platform components without a defined schema that ties each operative step to a corresponding evidentiary record. A platform that records credential operations through unstructured log files produces audit data that requires manual reconstruction to associate operational events with the corresponding credential operations and that does not produce evidentiary records suitable for the auditability requirements of regulatory frameworks under which the contracting enterprise operates.

The technology disclosed produces tamper-evident audit records that are anchored to operative steps performed by the agent 404 within an autonomy span between receipt of the credential generation instruction and dispatch of the asynchronous alerts at the conclusion of the workflow. The security and access mediator 416 generates a tamper-evident audit record upon completion of each operative step performed by the agent 404 within the autonomy span, the operative steps comprising activation of the credential interface elements rendered within the graphical user interface 424, extraction of the newly-created credential from the graphical user interface 424, delivery of the newly-created credential to the existing graphical user interface 428 of the consumer application 426, and dispatch of the asynchronous alerts. The tamper-evident audit record produced by the security and access mediator 416 comprises a producer identifier identifying the producer application 422, a consumer identifier identifying the consumer application 426, a timestamp expressing the time of completion of the operative step in a common time reference, a credential type identifying the type of the newly-created credential, and an outcome status indicating whether the operative step completed successfully. The tamper-evident audit records produced by the security and access mediator 416 are stored in a secure audit repository sealed using cryptographic chaining, an append-only ledger, a write-once-read-many storage medium, or a hash chain anchored to an immutable timestamping service. This mechanism produces a structured evidentiary record assembled from the underlying operational data that ties each operative step performed by the agent 404 to a corresponding tamper-evident audit record, and that supports auditability requirements that existing unstructured log file approaches cannot.

### Three-Process Output Structure from Shared Substrate of Tamper-Evident Audit Records

Existing credential operation approaches produce reporting outputs that address a single operational view, typically the per-application credential issuance log. An identity governance team that requires reporting outputs addressing multiple operational views must reconcile separate output structures computed from separate underlying datasets. The reconciliation requires verification that the separate outputs reflect a consistent view of the operational events. When the separate outputs are computed from distinct datasets with distinct schemas, internal inconsistencies between the outputs render them unsuitable for a coherent compliance review.

The technology disclosed produces a three-process output structure from the shared substrate of tamper-evident audit records produced by the security and access mediator 416. The three-process output structure comprises a producer-level output identifying credential operations performed at the producer application 422, a consumer-level output identifying credential operations affecting the consumer application 426, and a producer-consumer pairwise output identifying credential operations propagating credentials from the producer application 422 to the consumer application 426. The three output tiers are computed from the same tamper-evident audit records, such that the outputs across the three tiers are internally consistent and reflect a single coherent view of the operative steps performed by the agent 404. This mechanism produces a coordinated set of outputs each computed from the shared substrate of tamper-evident audit records, eliminating the internal inconsistency that arises when separate outputs are computed from separate underlying datasets in existing credential operation reporting approaches.

### System Architecture

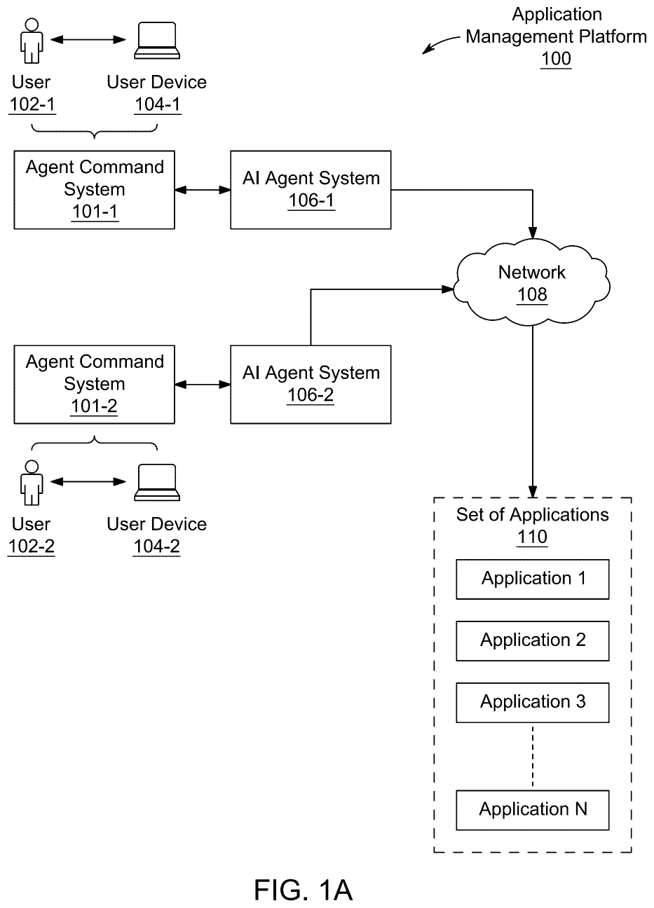

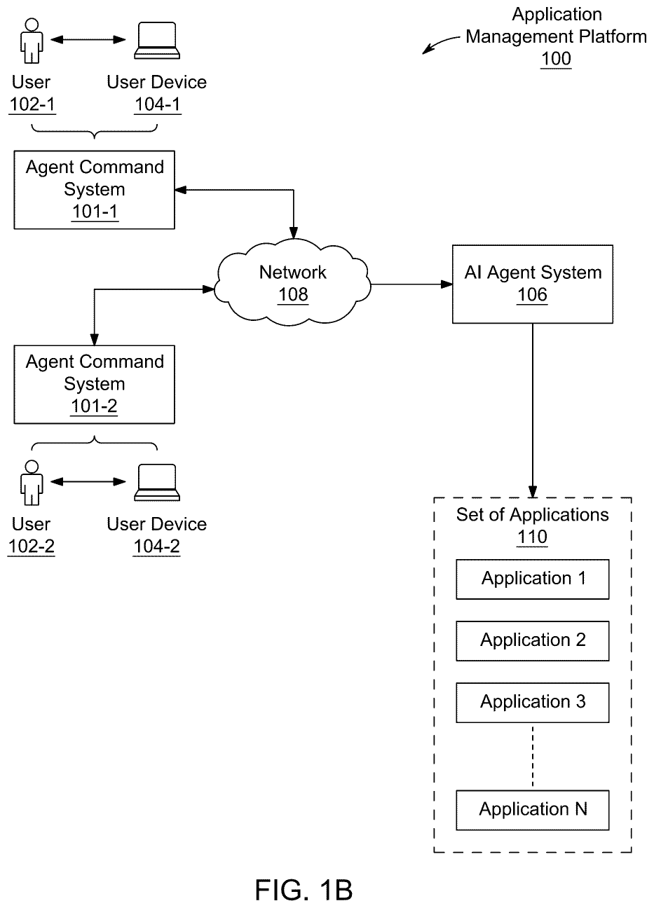

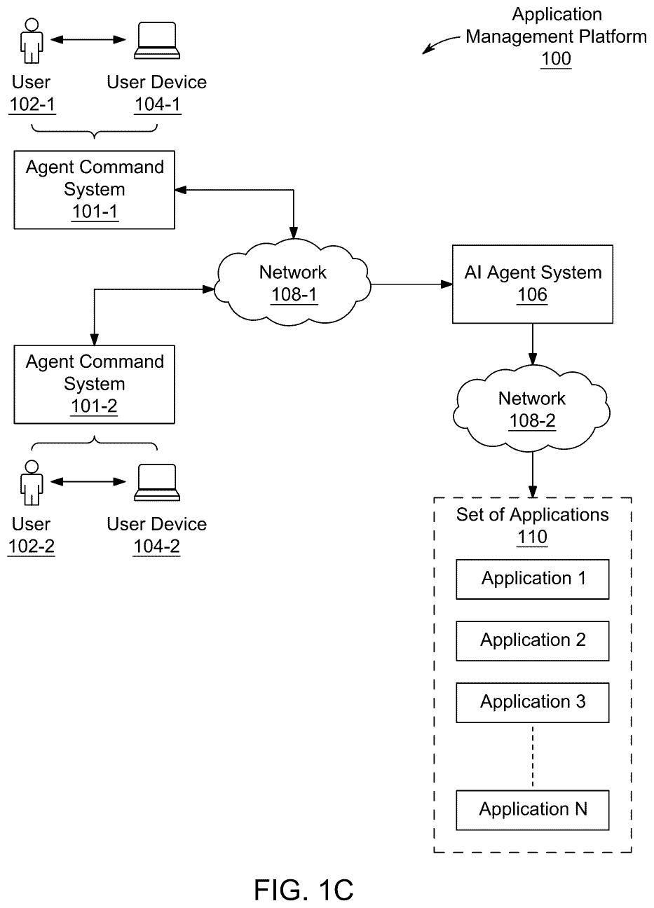

FIG. 1A illustrates an exemplary network diagram depicting an overall system architecture for deploying the application management platform 100, according to various embodiments. FIG. 1A depicts interaction among a plurality of enterprise users, a plurality of user devices, a plurality of agent command systems, a plurality of AI agent systems, and a set of applications over a communication network.

The application management platform 100 includes a plurality of users 102-1 and 102-2, each operating a respective user device 104-1 and 104-2. The user devices 104-1 and 104-2, collectively referred to as user devices 104, may be any computing devices capable of initiating or supporting interaction with components of the application management platform 100. The user devices 104 may include desktop computers, laptops, tablets, smartphones, or other network-enabled terminals. The user devices 104-1 and 104-2 are communicatively linked to other components of the application management platform 100 via a network 108. The network 108 may include any combination of communication technologies, including wired connections, wireless protocols, cellular networks, local area networks (LANs), wide area networks (WANs), metropolitan area networks (MANs), the Internet, or any suitable data transmission medium.

The agent command systems 101-1 and 101-2, collectively referred to as agent command systems 101 and as illustrated in FIG. 1A, refer to command-initiating modules that trigger task execution requests within the AI agent systems 106. The agent command systems 101 operate as entry points into an AI agent execution layer and may originate from a variety of operational contexts within the enterprise environment. Functionally, each agent command system 101 is configured to broker identity and access management instructions, including credential creation, access revocation, entitlement modification, or credential verification, by transmitting structured or unstructured commands to a corresponding AI agent system 106.

In one exemplary embodiment, an agent command system 101 may be realized as an enterprise human resources platform, such as Workday or SuccessFactors, which automatically triggers a new-user provisioning task upon successful onboarding of an employee. Alternatively, an agent command system 101 may be a cloud identity orchestration platform or identity governance solution, such as Okta Workflows or SailPoint, which detects a status change and delegates an appropriate downstream action to an agentic automation layer.

In another scenario, an agent command system 101 may comprise an enterprise-grade ticketing or service desk tool, such as ServiceNow or Jira, where an administrator raises a request for access removal or a credential reset. Once the ticket receives approval, the agent command system 101 generates a task trigger, which an AI agent system 106 receives for execution across relevant applications.

Additionally, an agent command system 101 may be embodied as a Python script or a lightweight command-line utility maintained by enterprise information technology teams. The agent command system 101 may invoke credential management tasks based on custom logic, policy thresholds, or compliance audit findings. For example, a script may be scheduled to review stale accounts, or trigger revocation flows for temporary users whose access is due to expire.

The scope of the agent command systems 101 also extends to externally hosted platforms. For example, a partner organization operating an integration gateway may initiate access modification workflows through representational state transfer (RESTful) callbacks or secure webhooks when a role matrix of a joint project is updated. Similarly, identity-centric middleware, such as Active Directory Federation Services (AD FS) or Azure Conditional Access policies, may initiate dynamic policy enforcement actions through integration with the application management platform 100.

Furthermore, websites that serve as operational hubs for user provisioning, including custom-built contractor registration portals or partner self-service applications, may function as instances of the agent command systems 101. These web portals collect user metadata, roles, and authorization preferences and transmit the metadata, the roles, and the authorization preferences as task directives to the agentic execution layer for automated credential provisioning.

The AI agent systems 106-1 and 106-2, collectively referred to as AI agent systems 106, serve as intermediary execution and orchestration layers between the agent command systems 101 and the set of applications 110. In the embodiment of FIG. 1A, the plurality of AI agent systems 106 may be deployed to manage tasks across various application domains, organizational units, or enterprise environments. Each AI agent system 106 receives task instructions or event triggers from a corresponding agent command system 101 and performs operations with respect to one or more applications in the set of applications 110.

A set of applications 110 is denoted as application 1, application 2, application 3, and continuing through application N. The applications within the set of applications 110 represent tools, platforms, and services utilized by enterprises in operational workflows. Illustrative examples include customer relationship management platforms such as Salesforce, regulatory filing portals such as Securities and Exchange Commission (SEC) submission websites, internal field service management systems, and partner-managed applications hosted on third-party infrastructure. Within the set of applications 110, some applications may be sanctioned enterprise applications that have been vetted and formally approved for use within the enterprise environment. However, not all sanctioned applications are programmatically integrated with enterprise identity systems. For example, Salesforce may be both sanctioned and programmatically connected through secure application programming interfaces (APIs), whereas other sanctioned tools, including a field service application hosted in a partner cloud, may lack programmatic integrations entirely and may be accessible through graphical user interfaces.

In cases of applications lacking programmatic integration, an AI agent system 106 is positioned to bridge the integration gap by executing graphical user interface (GUI)-based workflows. The AI agent system 106 functions across both API-enabled and GUI-only applications without requiring custom connectors for every application, thereby supporting a wide spectrum of use cases. The applications denoted by reference numeral 110, including application 1 through application N, represent the diversity in application connectivity and accessibility.

The application management platform 100 provides an operational control plane for deployment, configuration, and update management of the AI agent systems 106 across the enterprise environment. The application management platform 100 may further serve as an interface through which deployment packages, including deployment application template (DAT) files containing task templates and user interface locators, are delivered and version controlled. Version-controlled deployment ensures that application-specific logic can be updated without requiring modification to enterprise systems or target applications.

Operationally, when a task is initiated, including onboarding a new employee or revoking access for a departing contractor, the AI agent system 106 identifies relevant applications, determines whether the relevant applications are sanctioned or unsanctioned, and further determines whether programmatic access is available. Where APIs exist, the AI agent system 106 may utilize the APIs. Where no APIs are exposed, the AI agent system 106 performs interface-based automation by identifying credential fields, invoking generation elements, interacting with application controls, and confirming task completion through visual confirmation or response logging.

FIG. 1B illustrates an exemplary architecture of the AI agent system 106 deployed in a network environment. As depicted in FIG. 1B, a plurality of users 102-1 through 102-N operate respective user devices 104-1 through 104-N, the user devices being communicatively connected to the AI agent system 106 via the network 108. In the embodiment of FIG. 1B, a single AI agent system 106 serves the plurality of users 102-1 through 102-N and coordinates task execution across the set of applications 110.

The users 102 represent individuals or entities that require interaction with the AI agent system 106 for accessing enterprise functionalities or initiating enterprise workflows. The users 102 may include enterprise employees, external customers, partners, vendors, and contractors. Within an enterprise, the users 102 may take the form of managers, analysts, administrative staff, or compliance officers. For example, a marketing manager may request insights into sales performance metrics, while a data analyst may query historical usage patterns to train predictive models. Each interaction is facilitated through the user devices 104, which may include desktop computers, laptops, mobile phones, or tablets configured to transmit queries or task instructions to the AI agent system 106.

The AI agent system 106 functions as an intelligent middleware layer, interfacing with user instructions or task directives and performing corresponding task executions within the enterprise infrastructure. Upon receiving requests from the user devices 104-1 through 104-N or task directives from the agent command systems 101, the AI agent system 106 interprets an objective of the request or directive, references one or more semantic models, and orchestrates an execution strategy. The execution may involve data extraction from enterprise databases, task automation across enterprise applications, generation of alerts and recommendations, or credential and entitlement management operations.

An underlying semantic model employed by the AI agent system 106 maps concepts, relationships, and terminologies specific to the enterprise and an operational domain of the enterprise. The semantic model may incorporate language-specific and language-independent elements and may maintain a knowledge graph that encapsulates industry-specific vocabularies, inter-entity relationships, and organizational hierarchies. The semantic model allows the AI agent system 106 to provide meaningful and contextually accurate responses, even when user inputs are ambiguous, multilingual, or incomplete. For example, the AI agent system 106 may infer that a query about “partner logins” likely pertains to privileged account access in partner-facing systems and may respond accordingly.

The AI agent system 106 is capable of initiating omni-channel communication, providing task updates, delivering alerts, recommending actions, and handling real-time queries via chat, voice, or system notification interfaces. The AI agent system 106 may also proactively interact with the users 102 to suggest workflow improvements or to flag policy violations. For example, if a departing employee retains access to sensitive systems, the AI agent system 106 may initiate a revocation task and notify a security team.

The architecture is adaptable to various industry verticals including manufacturing, financial services, healthcare, oil and gas, and telecommunications. The AI agent system 106 is designed to accommodate industry-specific models, allowing the AI agent system 106 to process domain-relevant queries and execute tasks with high specificity and compliance.

The network 108 facilitates data transfer between the user devices 104-1 through 104-N and the AI agent system 106. In some embodiments, multiple interconnected networks 108 may be present between the user devices 104-1 through 104-N and the AI agent system 106. The network 108 may be a private network, a public network, or a hybrid network. The network 108 may be a local area network (LAN) or a wide area network (WAN).

The network 108 may be connected via wired or wireless links. Wired links may include digital subscriber line (DSL), coaxial cable lines, Ethernet, fiber optic links, or other links used for network infrastructure. Wireless links may include cellular, BLUETOOTH, Wi-Fi, Worldwide Interoperability for Microwave Access (WiMAX), infrared channels, satellite bands, or other wireless networking technologies. Wireless links may also include any cellular network standards used to communicate among mobile devices, including standards that qualify as 1G, 2G, 3G, 4G, 5G, or Long Term Evolution (LTE). Network standards may qualify as one or more generations of mobile telecommunication standards by fulfilling a specification or standards including specifications maintained by the International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include Advanced Mobile Phone System (AMPS), Global System for Mobile Communications (GSM), General Packet Radio Service (GPRS), Universal Mobile Telecommunications System (UMTS), High Speed Packet Access (HSPA), LTE, LTE Advanced, Mobile WiMAX, and WiMAX Advanced. Cellular network standards may use various channel access methods, including frequency division multiple access (FDMA), time division multiple access (TDMA), code division multiple access (CDMA), or space division multiple access (SDMA). In some embodiments, different types of data may be transmitted via different links and standards. In other embodiments, the same types of data may be transmitted via different links and standards.

The network 108 may be any type and form of network. The geographical scope of the network 108 may vary widely. The network 108 can be a body area network (BAN), a personal area network (PAN), a LAN including an Intranet, a metropolitan area network (MAN), or a WAN including the Internet. The topology of the network 108 may be of any form and may include point-to-point, serial, bus, star, ring, mesh, or tree topologies. The network 108 may be an overlay network that is virtual and sits on top of one or more layers of other networks. The network 108 may be of any network topology capable of supporting the operations described herein. The network 108 may utilize different techniques and layers or stacks of protocols, including the Ethernet protocol, the Internet protocol suite including Transmission Control Protocol over Internet Protocol (TCP/IP) and User Datagram Protocol over Internet Protocol (UDP/IP), the Asynchronous Transfer Mode (ATM) technique, the Synchronous Optical Networking (SONET) protocol, or the Synchronous Digital Hierarchy (SDH) protocol. The TCP/IP Internet protocol suite may include an application layer, a transport layer, an Internet layer including IPv6, or a link layer. The network 108 may be a type of broadcast network, telecommunications network, data communication network, or computer network.

In some implementations, one or more of the users 102-1 through 102-N may access the AI agent system 106 using one or more of the user devices 104-1 through 104-N. The AI agent system 106 may include one or more user interfaces, including browsers and textual or graphical user interfaces, through which the users 102-1 through 102-N may access the AI agent system 106.

The user devices 104-1 through 104-N and the AI agent system 106 may exist on a shared or segmented network. In some embodiments, the users 102 may access the AI agent system 106 remotely via virtual private networks (VPNs) or federated identity mechanisms, while in other embodiments, the users 102 may be co-located within an enterprise premise. The AI agent system 106 may access one or more databases communicatively coupled to the user devices 104-1 through 104-N through the network 108.

The database may be persistent storage that is capable of storing data. The persistent storage may be a local storage unit or a remote storage unit. The persistent storage may be a magnetic storage unit, an optical storage unit, a solid-state storage unit, an electronic storage unit including main memory, or a similar storage unit. The persistent storage may also be a monolithic single device or a distributed set of devices. Each component may include hardware including processing devices, including processors, central processing units (CPUs), and graphics processing units (GPUs), memory including random access memory (RAM), storage devices including a hard disk drive (HDD) and a solid-state drive (SSD), and other hardware devices including a sound card and a video card. The computing system may comprise any suitable type of computing device or machine that has a programmable processor including server computers, desktop computers, laptop computers, tablet computers, smartphones, and set-top boxes. In some examples, the computing system may comprise a single machine or may include multiple interconnected machines including multiple servers configured in a cluster. The computing system may be implemented by a common entity or organization or may be implemented by different entities or organizations.

FIG. 1C illustrates an alternative embodiment of the application management platform 100 depicting a distributed deployment environment of the AI agent system 106 in connection with an enterprise infrastructure. The architecture reflects system elements distributed across a plurality of communication networks 108-1 and 108-2 and demonstrates interactions between enterprise users, agent command systems, and applications.

As depicted in FIG. 1C, the enterprise users 102-1 and 102-2 operate corresponding user devices 104-1 and 104-2, respectively. The user devices 104-1 and 104-2 may include any computing device capable of establishing a network connection and interfacing with enterprise systems, including desktop computers, laptops, mobile phones, or tablet devices. Each user device may interact with a corresponding agent command system 101-1 or 101-2. The agent command systems 101-1 and 101-2 may be communicatively coupled to the AI agent system 106 through a first network 108-1, and the AI agent system 106 may be communicatively coupled to the set of applications 110 through a second network 108-2.

The AI agent system 106 interfaces with the agent command systems 101 and the set of applications 110 across the plurality of networks 108-1 and 108-2 and acts as an intermediary that facilitates intelligent, automated task execution based on enterprise identity controls. The AI agent system 106 may be communicatively coupled with the application management platform 100 that oversees and orchestrates deployment, access provisioning, and lifecycle management of AI-agent-based automation. The applications form a collective set of applications 110 of enterprise-deployed software systems, comprising commonly used platforms including Salesforce, customer relationship management systems, regulatory filing portals, or internally hosted operational tools. The set of applications 110 varies in accordance with each enterprise. The set of applications 110 is a customized set tailored to address the specific requirements of each enterprise.

The architecture of FIG. 1C emphasizes the role of distributed user interactions wherein different users, command-originating systems, and applications may be connected over different network interfaces. Unlike monolithic enterprise systems, the arrangement of FIG. 1C represents the practical reality of hybrid information technology environments where not all applications are uniformly connected or orchestrated under a single identity governance mechanism.

The AI agent system 106 mediates communication and operational requests between command-originating enterprise systems and the managed application ecosystem. The AI agent system 106 may incorporate logic for parsing user instructions or task directives, orchestrating task flows, validating access policies, updating credential states, and sending execution notifications. The AI agent system 106 enables agentic automation even in cases where application integration is incomplete or where manual processes are still used, by employing techniques including interface automation, synthetic API generation, or remote workflow triggers.

By situating the AI agent system 106 between disparate agent command systems and applications, the architecture shown in FIG. 1C supports a flexible, secure, and intelligent mechanism for managing complex enterprise workflows while maintaining identity and access policies enforced across multiple application types and endpoints.

### Exemplary System Architecture

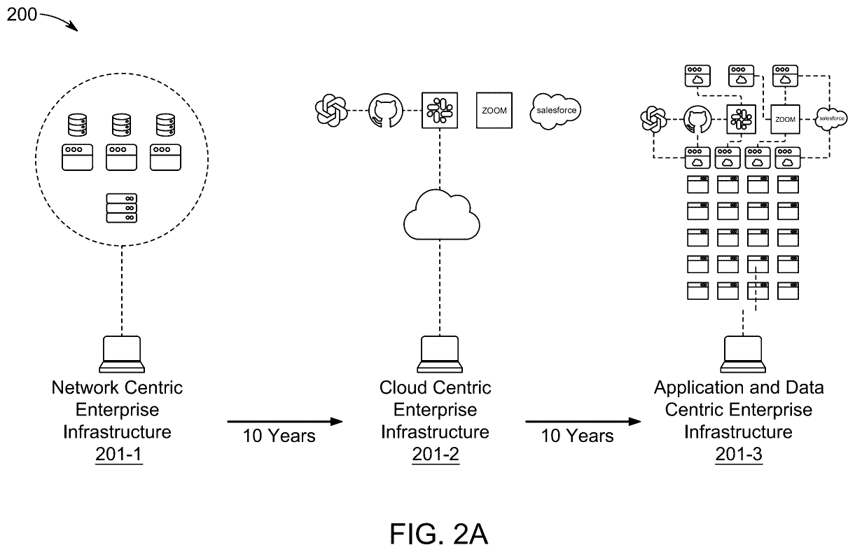

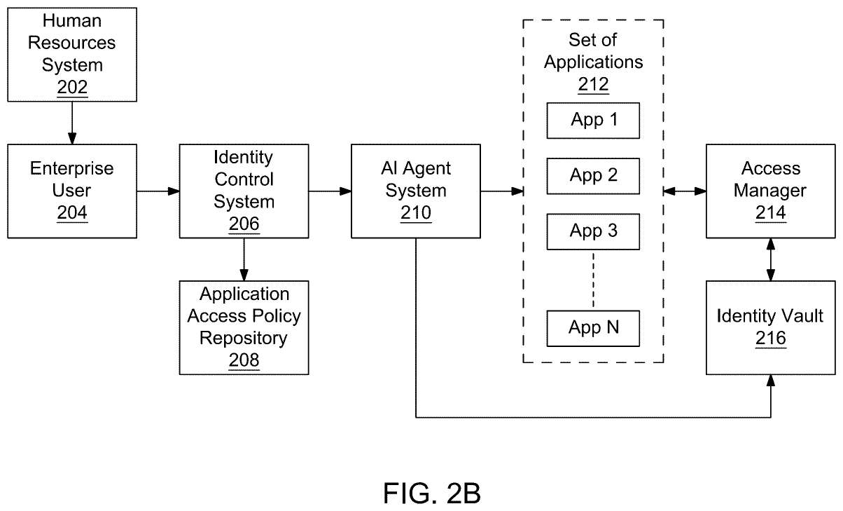

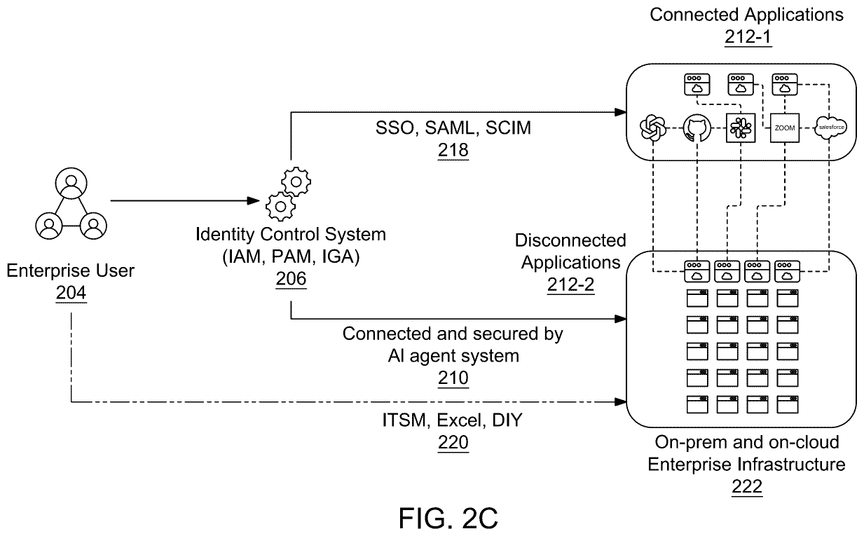

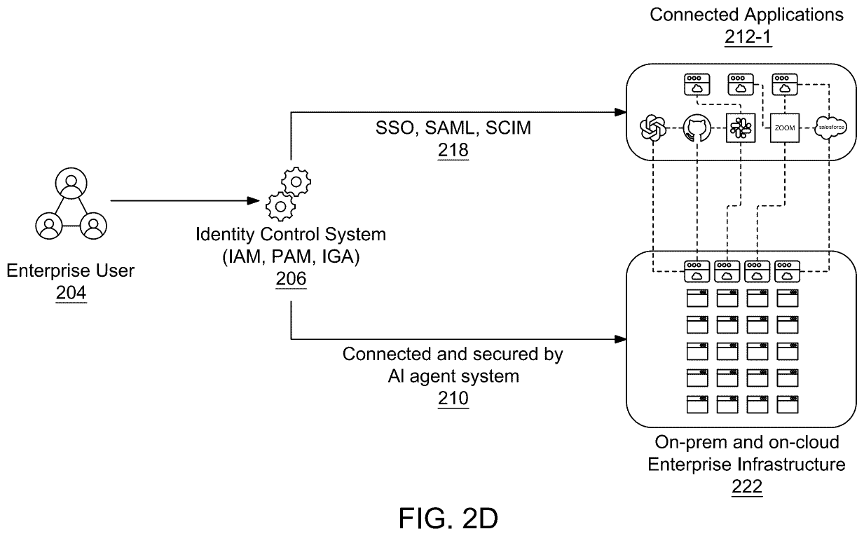

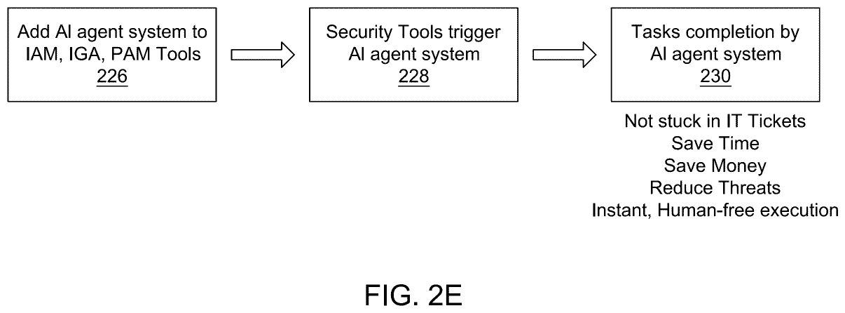

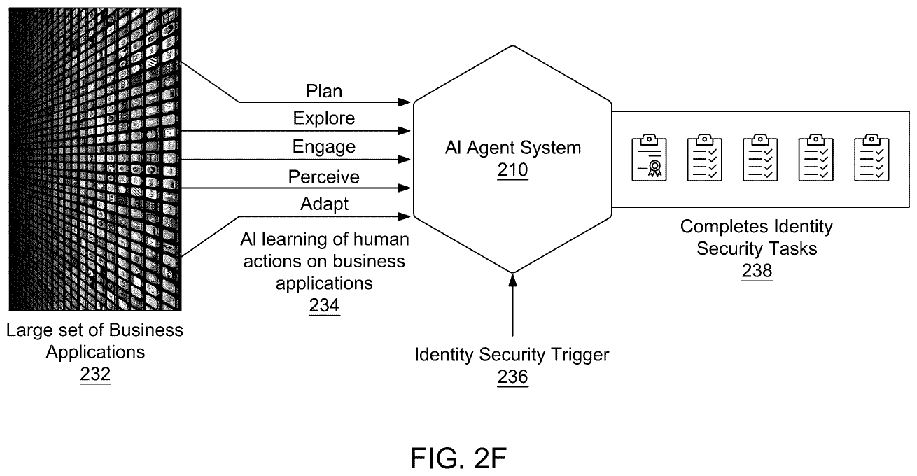

FIG. 2A illustrates an architectural diagram of an exemplary system 200 depicting the evolution of enterprise infrastructure models from network-centric paradigms to application- and data-centric paradigms, in accordance with certain embodiments of the present disclosure. The architectural diagram depicts three successive stages of enterprise infrastructure evolution spanning approximately two decades. A first stage depicts a network-centric enterprise infrastructure 201-1, in which enterprise applications and services are organized around physical network boundaries, on-premises data centers, and perimeter-based security models. A second stage depicts a cloud-centric enterprise infrastructure 201-2, in which enterprise applications and services migrate to cloud-hosted environments, introducing distributed access patterns and multi-tenant service delivery. A third stage depicts an application- and data-centric enterprise infrastructure 201-3, in which the enterprise security and identity perimeter shifts from a network layer to application and data layers, and individual applications and data stores become primary units of access control, policy enforcement, and identity governance. Each transition between successive stages spans approximately ten years. The evolution from the network-centric enterprise infrastructure 201-1 to the application- and data-centric enterprise infrastructure 201-3 creates a heterogeneous application landscape in which enterprise organizations simultaneously operate legacy on-premises applications, cloud-native services, and third-party platforms with varying degrees of integration, connectivity, and programmatic accessibility. The heterogeneity of the application- and data-centric enterprise infrastructure 201-3 forms the operational context in which the AI agent system described herein operates.

FIG. 2B illustrates an exemplary system 200 of an AI agent-based enterprise identity orchestration and credential automation platform, in accordance with certain embodiments of the present disclosure. The system 200 is implemented within a secure enterprise network environment and comprises a plurality of functional modules and system components, including a human resources system 202, an enterprise user 204, an identity control system 206, an application access policy repository 208, an AI agent system 210, a set of applications 212 comprising application 1 through application N, an access manager 214, and an identity vault 216.

The human resources system 202 is a centralized enterprise repository that maintains user-specific attributes and employment metadata, including designation, department, employment status, access eligibility criteria, and historical access records. For example, upon onboarding a new employee into a marketing department, the human resources system 202 stores the relevant role, project assignment, and department-specific flags that inform downstream access decisions. When an employee transitions from one department to another or exits the organization, the human resources system 202 updates the employment status accordingly.

The enterprise user 204 may be an internal administrative system, service entity, or administrative user operating within the enterprise infrastructure that fetches the employee details from the human resources system 202. The employee details include identity attributes, department-based entitlements, project-specific roles, and policy flags that define a scope of application access for the employee. For example, the enterprise user 204 may detect that an employee assigned to a financial audit project is eligible for limited access to an enterprise financial ledger application while being denied access to engineering development platforms.

The identity control system 206 serves as a decision engine that interprets enterprise-defined access control policies and determines an eligible set of applications each employee is permitted to access. The identity control system 206 may utilize static policy rules, dynamic access condition evaluation, or role-based access control logic to determine entitlements. For example, a data analyst joining a compliance team may be granted view-only access to compliance dashboards, whereas a senior compliance officer may be granted editing and submission privileges. Based on the determined scope of access, the identity control system 206 triggers either a credential creation task upon employee onboarding or a revocation task upon employee exit or access expiration.

The application access policy repository 208 is a dedicated storage layer or configuration store that maintains policy documents, compliance checklists, access templates, and entitlement definitions. The application access policy repository 208 may include per-application authentication modes, credential types, and compliance requirements. For example, a customer relationship management system may require multi-factor authentication using time-based tokens, while a regulatory submission platform may require access through a secure virtual private network (VPN). The identity control system 206 consults the application access policy repository 208 when making determinations regarding access provisioning or deprovisioning.

The AI agent system 210 functions as an intelligent execution layer that translates an intent derived from the identity control system 206 into a series of task executions across multiple heterogeneous applications. The AI agent system 210 orchestrates a credential creation, modification, or removal process and communicates with both connected and disconnected applications. For example, a customer relationship management platform may be a sanctioned and programmatically accessible application supporting standard authentication protocols, while a third-party treasury interface hosted on a partner cloud infrastructure may require interface automation using robotic process automation (RPA) or semantic uniform resource locator (URL)-based mapping. The AI agent system 210 handles both categories with equal agility, providing consistent and audit-friendly execution.

The set of applications 212, comprising application 1 through application N, represents a portfolio of enterprise tools and applications that employees may need to access. The set of applications 212 includes customer relationship management platforms, regulatory submission platforms, internal operational tools hosted on private cloud, and third-party partner interfaces. Some applications within the set of applications 212 are classified as sanctioned and support direct programmatic access, while other applications may be unlisted, disconnected, or legacy systems that do not expose modern application programming interfaces. For example, a sanctioned system may allow secure identity federation, while an unsanctioned procurement portal may require screen-based automation or manual form parsing.

The access manager 214 supervises overall task execution and maintains auditability. The access manager 214 verifies that credential lifecycle management activities, including provisioning, updates, and revocations, are completed successfully, logged appropriately, and aligned with enterprise compliance expectations. For example, in scenarios where a deprovisioning task fails due to an unreachable application, the access manager 214 may escalate an issue to an administrator and trigger a retry loop. The access manager 214 may also enforce temporal access constraints, including expiring credentials issued for short-term contractors, and may maintain versioned audit logs to support forensic analysis and compliance reporting.

The identity vault 216 functions as a secure storage module for credentials issued to enterprise users. The identity vault 216 may store usernames, passwords, application programming interface tokens, multi-factor secrets, and biometric templates. For example, when an employee is granted access to a cloud database, generated credentials are securely stored in the identity vault 216 in compliance with encryption-at-rest policies, audit logging, access expiration, and role-based retrieval constraints. The identity vault 216 may support zero-trust integrations with endpoint agents to facilitate secure credential injection at runtime.

The components of the system 200 operate in coordination to provide seamless, policy-compliant, and secure identity orchestration within complex enterprise environments. The AI-driven architecture of the system 200 provisions user access in accordance with verified human resources data and policy data, and executes tasks including application programming interface key refresh and user deactivation proactively, even for applications not directly connected to enterprise identity systems.

FIG. 2C illustrates an architectural diagram depicting integration of AI agent-based identity governance across connected applications and disconnected applications within a hybrid enterprise infrastructure, in accordance with certain embodiments of the present disclosure. FIG. 2C depicts the enterprise user 204 coupled to the identity control system 206 implementing identity and access management (IAM), privileged access management (PAM), and identity governance and administration (IGA) functions. The identity control system 206 is communicatively coupled to the AI agent system 210, which is communicatively coupled to both a set of connected applications 212-1 and a set of disconnected applications 212-2 within an on-premises and on-cloud enterprise infrastructure 222. The connected applications 212-1 are integrated with the identity control system 206 via standardized protocols including single sign-on (SSO), security assertion markup language (SAML), and system for cross-domain identity management (SCIM) 218. The disconnected applications 212-2 are applications that lack native protocol integration and are managed using alternative methods, including information technology service management (ITSM) tickets, spreadsheet-based tracking, or custom-built tools 220. The AI agent system 210 bridges a gap between the connected applications 212-1 and the disconnected applications 212-2 by providing automated identity governance capabilities across both categories of applications irrespective of availability of a programmatic interface.

FIG. 2D illustrates an exemplary connectivity framework between enterprise users, the identity control system, and a plurality of applications integrated with the AI agent system, in accordance with certain embodiments of the present disclosure. FIG. 2D depicts the enterprise user 204 coupled to the identity control system 206 implementing IAM, PAM, and IGA functions. The identity control system 206 is communicatively coupled to the AI agent system 210, which is communicatively coupled to the connected applications 212-1 deployed on the on-premises and on-cloud enterprise infrastructure 222 via SSO, SAML, and SCIM 218. FIG. 2D illustrates an alternative embodiment in which an enterprise application landscape comprises primarily connected applications 212-1, and the AI agent system 210 operates alongside standardized identity federation and provisioning protocols.

FIG. 2E is a system workflow diagram showing an AI agent-driven remediation process initiated by contextual security signals and executed across enterprise applications, in accordance with certain embodiments of the present disclosure. FIG. 2E depicts three sequential stages. At a first stage 226, the AI agent system 210 is added to IAM, IGA, and PAM tools, integrating agentic automation capabilities into existing identity governance infrastructure. At a second stage 228, security tools trigger the AI agent system 210 in response to identity lifecycle events, policy violations, or security incidents. At a third stage 230, the AI agent system 210 completes identity security tasks across an enterprise application estate, achieving instant, human-free execution, time savings, cost reduction, and threat mitigation.

FIG. 2F is a conceptual diagram depicting AI agent behavioral learning for autonomous execution of identity lifecycle tasks in enterprise applications, in accordance with certain embodiments of the present disclosure. FIG. 2F depicts the AI agent system 210 that learns from human actions on business applications 234 within a large set of business applications 232. The AI agent system 210 acquires behavioral patterns through a sequence of learning stages comprising plan, explore, engage, perceive, and adapt. Upon receiving an identity security trigger 236, the AI agent system 210 completes identity security tasks 238 across the large set of business applications 232 by applying learned behavioral patterns to autonomously navigate, interpret, and interact with enterprise application interfaces.

### Internal Functional Modules

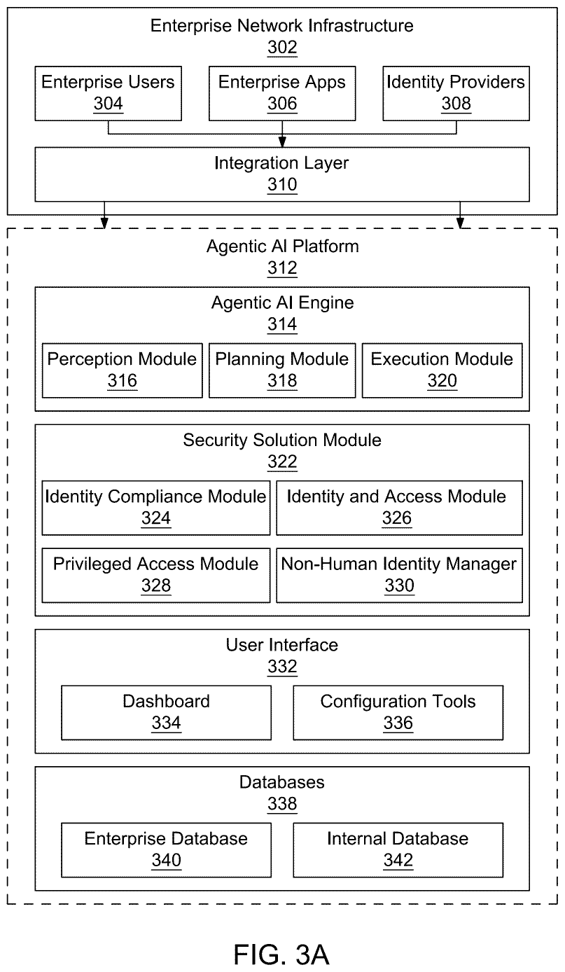

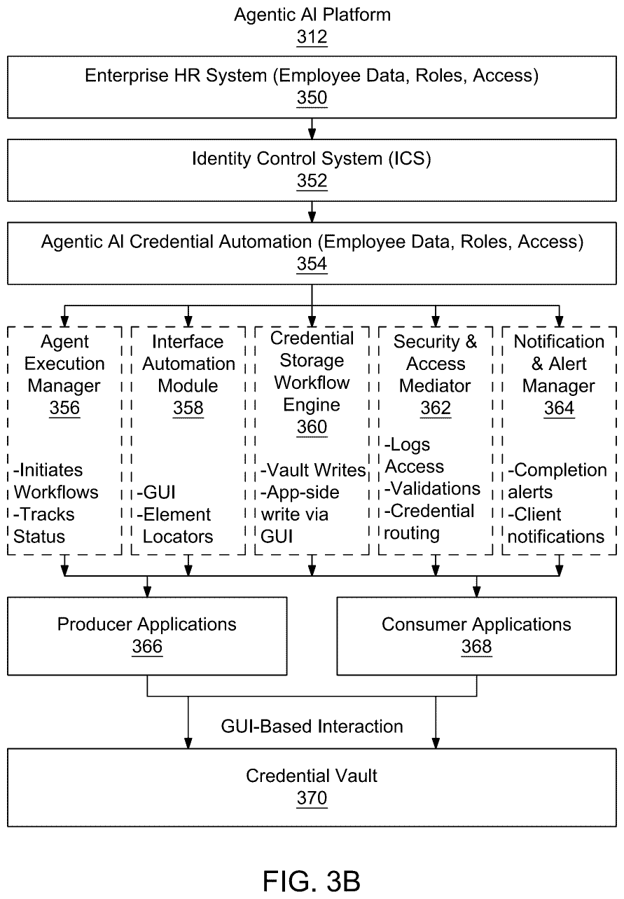

FIG. 3A illustrates an exemplary system architecture depicting internal functional modules of the agentic AI platform, in accordance with certain embodiments of the present disclosure. The architecture is deployed within an enterprise network infrastructure 302 and is communicatively coupled to enterprise users 304, enterprise applications 306, and identity providers 308 via an integration layer 310.

The architecture comprises an agentic AI platform 312 containing an agentic AI engine 314. The agentic AI engine 314 comprises a perception module 316, a planning module 318, and an execution module 320. The perception module 316 is configured to detect and interpret user interface elements rendered on graphical interfaces of enterprise applications using computer vision and image recognition techniques. The planning module 318 is configured to decompose identity governance intents into structured execution plans by interpreting user instructions, evaluating policy constraints, and determining a sequence of actions to be performed across target enterprise applications. The execution module 320 is configured to carry out actions determined by the planning module 318 by generating and executing simulated user interactions with the enterprise application interfaces, including mouse-click simulation, keyboard-input simulation, and form-field population.

The agentic AI platform 312 further comprises a security solution module 322, an identity compliance module 324, an identity and access module 326, a privileged access module 328, and a non-human identity manager 330. The security solution module 322 provides security validation and enforcement across platform workflows. The identity compliance module 324 monitors and enforces compliance with regulatory and organizational access control policies. The identity and access module 326 manages user identity lifecycle operations including provisioning, deprovisioning, and entitlement review. The privileged access module 328 manages elevated access privileges and privileged session controls. The non-human identity manager 330 manages credentials and access privileges associated with service accounts, machine identities, and automated processes.

The architecture comprises a user interface 332 including a dashboard 334 and configuration tools 336 accessible to enterprise administrators and compliance personnel. The architecture is communicatively coupled to databases 338 including an enterprise database 340 and an internal database 342 that store identity records, access policies, credential metadata, and audit logs.

### Agentic AI Credential Automation System

FIG. 3B illustrates the agentic AI platform 312, described with reference to FIG. 3A, configured as an agentic AI credential automation system for performing graphical user interface (GUI)-based orchestration for enterprise identity workflows, in accordance with certain embodiments of the present disclosure. FIG. 3B depicts a credential automation subsystem within the agentic AI platform 312, bridging enterprise policy engines with application endpoints through an intelligent middleware capable of credential generation, injection, and lifecycle management.

The agentic AI platform 312, as depicted in FIG. 3B, comprises an enterprise human resources (HR) system 350 that functions as an authoritative data source for user identity attributes, including employee data, roles, and access entitlements. The enterprise HR system 350 maintains updated metadata about each employee and acts as an originator of identity provisioning or deprovisioning events.

An identity control system (ICS) 352 receives the user identity attributes from the enterprise HR system 350 and evaluates organizational access policies. The identity control system 352 determines application access, triggers credential creation or removal, and stores policy metadata. For example, upon offboarding, the identity control system 352 triggers workflows to remove application-level access, which are then delegated to the credential automation subsystem.

An agentic AI credential automation module 354 functions as a middleware execution engine configured to translate access decisions into executable actions. The agentic AI credential automation module 354 receives the employee data, the roles, and the access entitlements from the identity control system 352 and serves as a core protocol abstraction layer capable of interacting with a heterogeneous application ecosystem. The agentic AI credential automation module 354 orchestrates credential issuance, revocation, and updates across both connected and disconnected systems.

The agentic AI credential automation module 354 comprises an agent execution manager 356, an interface automation module 358, a credential storage workflow engine 360, a security and access mediator 362, and a notification and alert manager 364. The agent execution manager 356 initiates workflows and tracks execution status by decomposing incoming identity intents into atomic sub-tasks and routing the sub-tasks to appropriate modules. For example, upon receiving an instruction to generate a new application programming interface key, the agent execution manager 356 may trigger the credential storage workflow engine 360 and a credential generation workflow in parallel.

The interface automation module 358 facilitates GUI-level automation for applications that lack standard application programming interface connectivity. The interface automation module 358 includes logic for identifying GUI elements including input fields, buttons, dropdowns, and dynamic frames using element locators. The interface automation module 358 enables the agentic AI platform 312 to perform programmatic interactions with external systems in a human-like manner.

The credential storage workflow engine 360 manages secure handling and routing of credentials. The credential storage workflow engine 360 supports vault write operations to a centralized credential vault 370 and application-side write operations via GUI interfaces. For example, a newly created application programming interface key for a field service application may be stored in the credential vault 370 while also being simultaneously injected into an application user management portal.

The security and access mediator 362 logs access events, performs policy validations, and manages credential routing during workflow execution. The security and access mediator 362 monitors transactional success or failure and is configured to enforce conditional logic including time-based access expiry and escalation rules.

The notification and alert manager 364 handles completion alerts and client notifications across the agentic AI platform 312. Upon successful completion of credential-related operations, the notification and alert manager 364 sends alerts to appropriate stakeholders including system administrators, compliance officers, or application owners.

Producer applications 366 represent internal enterprise systems configured to generate credentials, including credential generators, application programming interface key generators, and internal administrative user interfaces. Consumer applications 368 are target systems that rely on generated credentials for user access, including regulatory submission applications, customer relationship management platforms, field operations tools, and treasury systems. The agentic AI credential automation module 354 interacts with both the producer applications 366 and the consumer applications 368 via GUI-based interaction.

The credential vault 370 serves as a centralized storage repository for enterprise credentials. The credential vault 370 is updated via the credential storage workflow engine 360 and supports credential rotations and time-to-live (TTL) enforcement. The credential vault 370 stores credentials including passwords, application programming interface keys, and authentication tokens in an encrypted format, and maintains credentials that are valid and within expiration boundaries.

The agentic AI platform 312, as depicted in FIG. 3B, facilitates a GUI-driven, application-agnostic, and audit-enforced identity orchestration mechanism that reduces dependency on application-specific application programming interfaces. The agentic AI platform 312 is updatable through deployment application template (DAT) files, allowing new applications to be integrated without system reengineering.

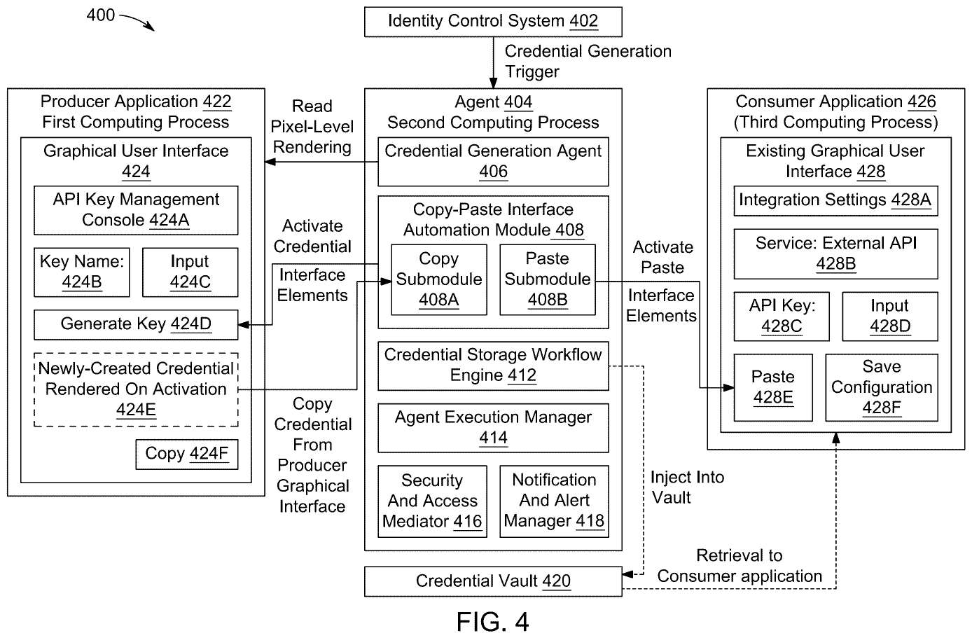

Having described the broader enterprise context within which the present technology operates, including the agentic artificial intelligence platform of FIGS. 1A through 1C, the historical evolution of enterprise infrastructure of FIG. 2A, the identity governance and access management framework of FIGS. 2B through 2F, and the internal architecture of the agentic artificial intelligence credential automation platform of FIGS. 3A and 3B, the present disclosure now turns to the specific architecture by which credential generation and propagation are performed by an agent through visual identification and activation of graphical user interface elements. While the foregoing figures establish the operating environment, the identity control system, and the producer-consumer application landscape in which the agent is deployed, they do not address the technical mechanism by which the agent identifies the credential interface elements within a graphical user interface of a producer application, causes activation of the identified credential interface elements, and propagates a resulting credential to a consumer application without reliance on application-specific programmatic interfaces. The architecture described in conjunction with FIG. 4 onward addresses this mechanism.

### System Architecture for Automated Credential Generation and Propagation

FIG. 4 illustrates an exemplary system architecture 400 for automated credential generation and propagation through visual identification and activation of graphical user interface elements. The system 400 comprises an agent 404 executing as a second computing process, a producer application 422 executing as a first computing process, and a consumer application 426 executing as a third computing process, the agent 404, the producer application 422, and the consumer application 426 comprising distinct computing processes executing in respective process contexts. The agent 404 is communicatively coupled to an identity control system 402 from which the agent 404 receives a credential generation instruction, and the agent 404 is configured to identify, from visual content of a graphical user interface 424 of the producer application 422, one or more credential interface elements that, upon activation, cause the producer application 422 to output at least one credential for use by the consumer application 426, the identifying being performed using a trained machine learning model of the agent 404 operating on learned visual features extracted from pixel-level rendering of the graphical user interface 424. The system 400 will now be described in greater detail.

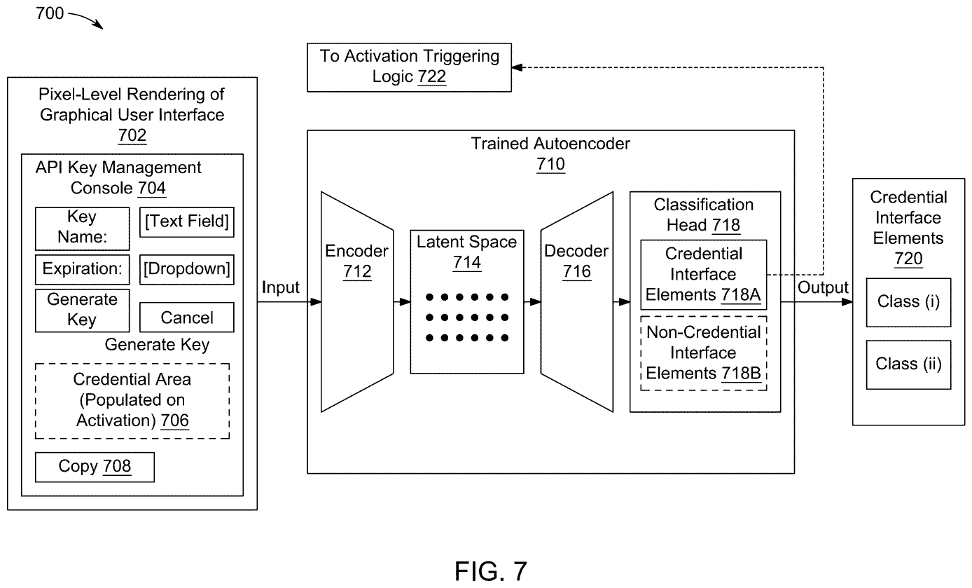

The system architecture, three-module agent decomposition, method workflow, autoencoder operation, three-process triangulation, copy-paste propagation, credential vault organization, dynamic graphical user interface adaptation, atomic transaction orchestration, credential lifecycle audit, and computing system implementation described in conjunction with FIG. 4 through FIG. 14 collectively constitute the architectural and operational framework by which the agent identifies the credential interface elements, causes activation thereof, and propagates the at least one credential to the consumer application. Within this framework, the trained machine learning model of the agent operates as the perceptual mechanism by which visual content of the graphical user interface of the producer application is converted into the visual feature representations classified to identify the credential interface elements. As described in conjunction with FIG. 7, one implementation of the trained machine learning model comprises a trained autoencoder having an encoder, a latent space, a decoder, and a classification head. However, the trained machine learning model is not limited to the autoencoder implementation, and may be realized using a variety of machine learning architectures, neural network topologies, and inference logic configurations.

FIG. 4 illustrates a system architecture 400 for automated credential generation and propagation through visual identification and activation of graphical user interface elements, in accordance with certain embodiments of the present disclosure. The system architecture 400, also referred to as the system 400, is configured to automate at least a portion of a credential lifecycle by identifying credential interface elements rendered within a graphical user interface, activating the credential interface elements to cause generation of a newly-created credential at a producer application, copying or otherwise capturing the newly-created credential from the producer application, storing the newly-created credential in a credential vault, and propagating the newly-created credential to a consumer application through an existing graphical user interface. In certain implementations, the system 400 performs the credential generation and propagation workflow without requiring an application-specific programmatic interface at one or more participating applications, thereby allowing the system 400 to operate with legacy systems, third-party software-as-a-service platforms, disconnected applications, or other applications that expose credential operations primarily through rendered graphical user interfaces.

The system 400 comprises an identity control system 402, an agent 404, and a credential vault 420. The system 400 further operates with a producer application 422 having a graphical user interface 424 and a consumer application 426 having an existing graphical user interface 428. The producer application 422 represents a first computing process, the agent 404 represents a second computing process, and the consumer application 426 represents a third computing process. The first, second, and third computing processes may execute on a single hardware platform under separate process boundaries, on multiple hardware platforms communicatively coupled through a network, or on a combination of local, virtualized, containerized, cloud-based, or hybrid computing environments. The identity control system 402 supplies a credential generation trigger to the agent 404, and the agent 404 executes a credential workflow involving the producer application 422, the consumer application 426, and the credential vault 420.

The identity control system 402 is configured to operate as a policy orchestration system for initiating credential generation. The identity control system 402 may determine whether a credential is to be created based on an enterprise policy, an identity entitlement, a user onboarding event, a role transition, a ticketing request, a security policy, or another credential provisioning condition. In response to the determination, the identity control system 402 emits the credential generation trigger to the agent 404. In some embodiments, the identity control system 402 may be implemented as, or may communicate with, an identity governance and administration platform, an identity and access management platform, a privileged access management platform, a human resources system, a ticketing system, a security information and event management system, or another enterprise control system.

The agent 404 is a computing process configured to receive the credential generation trigger and coordinate performance of the credential generation and propagation workflow. The agent 404 includes a credential generation agent 406, a copy-paste interface automation module 408, a credential storage workflow engine 412, an agent execution manager 414, a security and access mediator 416, and a notification and alert manager 418. The copy-paste interface automation module 408 includes a copy submodule 408A and a paste submodule 408B. The agent 404 may be realized as a software process, a containerized workload, a virtual machine workload, a serverless function, a background automation service, or a hardened enterprise automation process. The agent 404 is configured to interact with the producer application 422 and the consumer application 426 at a visual interface layer by reading pixel-level renderings of graphical user interfaces and by issuing input events to identified graphical user interface elements.

The credential generation agent 406 is configured to process the credential generation trigger and identify credential interface elements within the graphical user interface 424 of the producer application 422. The credential generation agent 406 may read or capture a pixel-level rendering of the graphical user interface 424 and analyze the pixel-level rendering to locate interface elements involved in generating a credential. In some embodiments, the credential generation agent 406 applies a trained autoencoder or another machine-learning-based visual recognition model to produce visual feature representations of the pixel-level rendering and to classify regions of the pixel-level rendering as credential interface elements. The credential interface elements may include input fields, labels, action controls, dropdown selectors, scope controls, expiration controls, confirmation controls, credential display regions, and copy controls. After identifying the credential interface elements, the credential generation agent 406 causes the agent 404 to activate one or more of the credential interface elements to elicit generation of the newly-created credential by the producer application 422.

The copy-paste interface automation module 408 is configured to automate transfer of the newly-created credential from the producer application 422 to the consumer application 426 through graphical user interface operations. The copy submodule 408A is configured to identify and activate a copy interface element rendered within the graphical user interface 424 of the producer application 422 after the newly-created credential has been generated. The copy submodule 408A may copy the newly-created credential from the graphical user interface 424 into a transient credential buffer, secure clipboard region, protected memory location, or other temporary credential transfer structure maintained or controlled by the agent 404. The paste submodule 408B is configured to identify and activate a paste interface element within the existing graphical user interface 428 of the consumer application 426 and to insert the newly-created credential into a corresponding credential input field of the existing graphical user interface 428.

The credential storage workflow engine 412 is configured to manage storage operations associated with the newly-created credential. The credential storage workflow engine 412 may cause the newly-created credential to be injected into the credential vault 420 as a secured credential record. The secured credential record may include the newly-created credential and associated credential metadata, including a credential type, source application identifier, target application identifier, validity period, scope, owner identity, version identifier, or status indicator. In some embodiments, the credential storage workflow engine 412 coordinates with the paste submodule 408B and with storage interface elements of the consumer application 426 so that the newly-created credential is also committed through the existing graphical user interface 428 of the consumer application 426. In certain implementations, the credential storage workflow engine 412 performs validation of the newly-created credential before storage, including format validation, metadata validation, policy validation, or destination validation.

The agent execution manager 414 is configured to coordinate execution of the credential workflow within the agent 404. The agent execution manager 414 may receive or process the credential generation trigger, determine tasks to be performed by the credential generation agent 406, the copy-paste interface automation module 408, and the credential storage workflow engine 412, and control the sequence or concurrency of those tasks. In some embodiments, the agent execution manager 414 decomposes the credential generation trigger into task operations including credential generation, credential capture, credential storage, credential propagation, and credential commitment at the consumer application 426. The agent execution manager 414 may track task status, detect workflow errors, retry failed operations, suspend execution upon detection of a policy violation, or initiate rollback or remediation operations to reduce inconsistent credential states among the producer application 422, the consumer application 426, and the credential vault 420.

The security and access mediator 416 is configured to enforce access and security constraints during operation of the agent 404. The security and access mediator 416 may validate whether the credential generation trigger is authorized, determine whether the producer application 422 and the consumer application 426 are approved destinations for the newly-created credential, and control routing of the newly-created credential to the credential vault 420 or to the consumer application 426. The security and access mediator 416 may also produce audit records for workflow operations. The audit records may identify a producer application, a consumer application, a credential type, an execution timestamp, an initiating identity, a destination identity, and an outcome status. In some embodiments, the audit records are tamper-evident audit records generated using a hash chain, an append-only store, a write-once-read-many storage medium, or another integrity-preserving audit mechanism.

The notification and alert manager 418 is configured to generate notifications associated with the credential workflow. The notification and alert manager 418 may dispatch an alert when credential generation succeeds, when credential storage succeeds, when credential propagation to the consumer application 426 succeeds, or when any workflow operation fails. The notification and alert manager 418 may transmit notifications to the identity control system 402, an administrator, an application owner, a compliance system, a security operations system, or another subscribing recipient. Notifications may be transmitted through electronic mail, messaging platforms, webhook callbacks, syslog feeds, monitoring systems, or other enterprise notification channels.

The credential vault 420 is configured to store credentials generated or propagated by the system 400. The credential vault 420 may store the newly-created credential in encrypted-at-rest form together with credential metadata. The credential vault 420 may support credential versioning, credential rotation, time-to-live enforcement, role-based retrieval, access logging, and audit trail generation. Credential types stored in the credential vault 420 may include API keys, passwords, authentication tokens, certificates, shared secrets, multi-factor authentication seeds, or other machine-readable or human-readable credentials. The credential vault 420 is configured to receive the newly-created credential from the credential storage workflow engine 412 and to provide authorized retrieval of the newly-created credential to the consumer application 426 or to another authorized system.

The producer application 422 represents the first computing process and includes the graphical user interface 424 through which the newly-created credential is generated. In the illustrated embodiment, the graphical user interface 424 includes an API key management console 424A, a key name label 424B, an input field 424C, a generate key control 424D, a newly-created credential rendered on activation 424E, and a copy control 424F. The API key management console 424A provides an interface region for generating an API key or another credential. The key name label 424B identifies the input field 424C into which a credential name, credential identifier, or other generation parameter may be entered. The generate key control 424D is activatable to cause the producer application 422 to generate the newly-created credential. The newly-created credential rendered on activation 424E represents the credential display region populated after activation of the generate key control 424D. The copy control 424F is activatable to copy the newly-created credential from the graphical user interface 424 for use by the agent 404. In certain embodiments, the producer application 422 lacks an application programming interface for credential generation, and the agent 404 therefore performs credential generation by visually identifying and activating elements of the graphical user interface 424.

The consumer application 426 represents the third computing process and includes the existing graphical user interface 428 through which the newly-created credential is consumed. In the illustrated embodiment, the existing graphical user interface 428 includes an integration settings region 428A, a service selector 428B, an API key label 428C, an input field 428D, a paste control 428E, and a save configuration control 428F. The integration settings region 428A provides an interface region for configuring an external service or integration. The service selector 428B identifies a service, such as an external API, for which the newly-created credential is to be used. The API key label 428C identifies the input field 428D into which the newly-created credential is to be inserted. The paste control 428E is activatable to paste or otherwise insert the newly-created credential into the input field 428D. The save configuration control 428F is activatable to commit the newly-created credential within the consumer application 426. In certain embodiments, the consumer application 426 lacks an application programming interface for credential consumption, and the agent 404 therefore propagates the newly-created credential by visually identifying and activating elements of the existing graphical user interface 428.

During an exemplary operation, the identity control system 402 emits the credential generation trigger to the agent 404. The agent execution manager 414 coordinates execution of the workflow within the agent 404. The credential generation agent 406 reads a pixel-level rendering of the graphical user interface 424 of the producer application 422, identifies credential interface elements associated with the API key management console 424A, and causes input to be provided to the input field 424C based on the key name label 424B or based on information included in the credential generation trigger. The credential generation agent 406 then activates the generate key control 424D, causing the producer application 422 to render the newly-created credential as the newly-created credential rendered on activation 424E. The copy submodule 408A activates the copy control 424F and copies the newly-created credential from the graphical user interface 424 into a protected transfer location associated with the agent 404.

After the newly-created credential has been copied, the paste submodule 408B interacts with the existing graphical user interface 428 of the consumer application 426. The paste submodule 408B identifies the integration settings region 428A, determines the relevant service selector 428B, identifies the input field 428D associated with the API key label 428C, and activates the paste control 428E to insert the newly-created credential into the input field 428D. The paste submodule 408B or the credential storage workflow engine 412 may then cause activation of the save configuration control 428F to commit the newly-created credential within the consumer application 426. In parallel with, before, or after the consumer-side propagation operation, the credential storage workflow engine 412 causes the newly-created credential to be stored in the credential vault 420. The credential vault 420 may subsequently provide authorized retrieval of the newly-created credential to the consumer application 426 according to an applicable access policy.

Throughout the credential workflow, the security and access mediator 416 validates access conditions, controls credential routing, and generates audit records associated with credential generation, copying, storage, retrieval, propagation, and commitment. The notification and alert manager 418 generates workflow notifications upon completion, failure, or policy-triggered interruption of the credential workflow. In this manner, the system 400 provides a visual-interface-based credential automation architecture in which the producer application 422, the agent 404, the credential vault 420, and the consumer application 426 cooperate to generate, store, and propagate a newly-created credential across distinct computing processes.

### Internal Architecture of the Agent

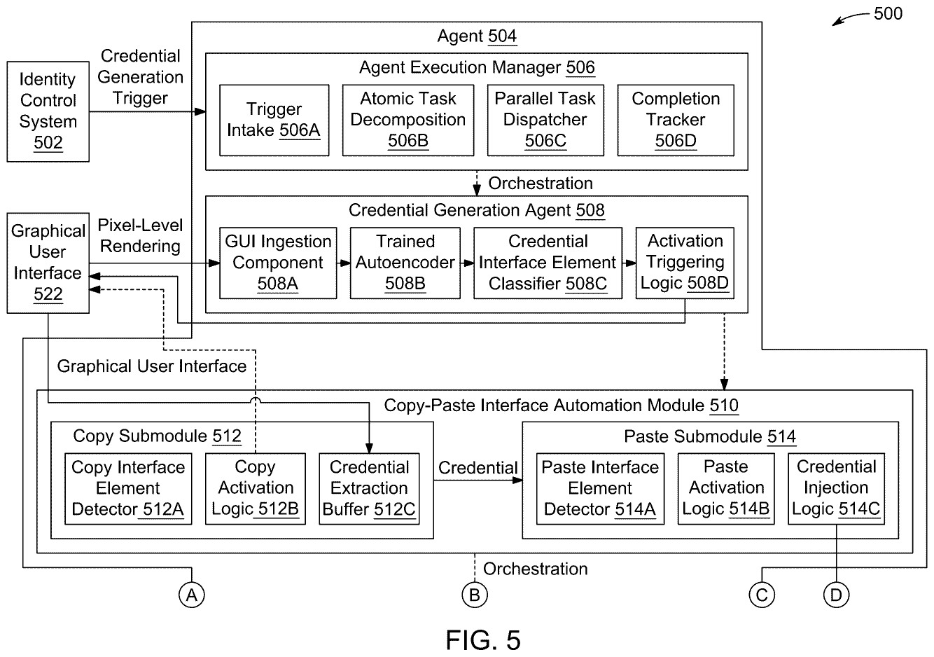

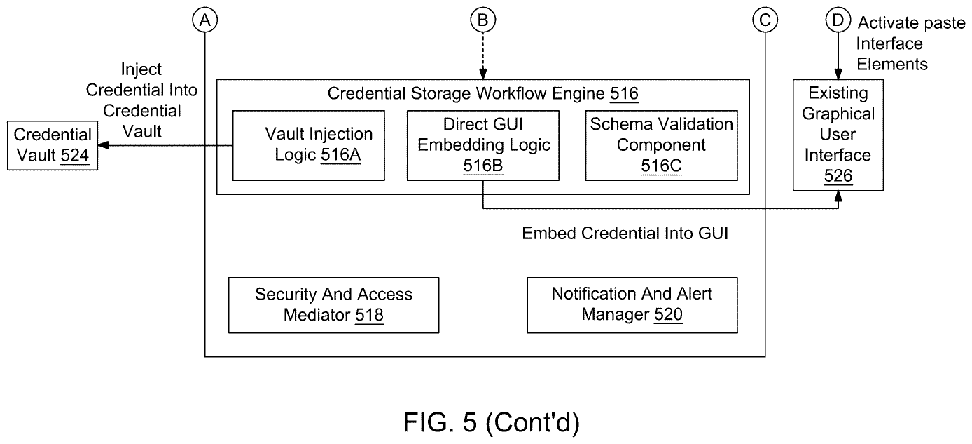

FIG. 5 illustrates a detailed internal architecture 500 of the agent 504 of FIG. 4, in accordance with certain embodiments of the present disclosure. The detailed internal architecture 500, also referred to as the architecture 500, decomposes the agent 504 into its constituent submodules and depicts the orchestration relationships among the submodules during execution of a credential generation and propagation workflow. The architecture 500 is depicted across two sheets connected through continuity markers A, B, C, and D, and is communicatively coupled with an identity control system 502 that emits the credential generation trigger, a graphical user interface 522 of a producer application from which a newly-created credential is generated, an existing graphical user interface 526 of a consumer application into which the newly-created credential is injected, and a credential vault 524 that stores the newly-created credential in encrypted-at-rest form.

The agent 504 includes an agent execution manager 506, a credential generation agent 508, a copy-paste interface automation module 510 having a copy submodule 512 and a paste submodule 514, a credential storage workflow engine 516, a security and access mediator 518, and a notification and alert manager 520. The agent execution manager 506 is positioned at the top of the orchestration hierarchy of the agent 504 and dispatches orchestration directives to the credential generation agent 508, the copy-paste interface automation module 510, and the credential storage workflow engine 516. The security and access mediator 518 and the notification and alert manager 520 operate as cross-cutting modules that interact with the foregoing modules during execution of the workflow.

The agent execution manager 506 is configured to receive the credential generation trigger from the identity control system 502 and to coordinate execution of the workflow within the agent 504. The agent execution manager 506 includes a trigger intake 506A, an atomic task decomposition component 506B, a parallel task dispatcher 506C, and a completion tracker 506D. The trigger intake 506A is configured to receive the credential generation trigger from the identity control system 502 and validate structural integrity of the credential generation trigger against an expected schema. The atomic task decomposition component 506B is configured to decompose the credential generation trigger into a set of atomic tasks, including credential creation, credential update, credential removal, credential rotation, and credential propagation. The parallel task dispatcher 506C is configured to dispatch the atomic tasks to the credential generation agent 508, the copy-paste interface automation module 510, and the credential storage workflow engine 516 for parallel or sequential execution within an atomic transaction boundary. The completion tracker 506D is configured to monitor execution status of each atomic task, detect failures, and trigger commit operations upon successful completion of all atomic tasks or rollback operations upon failure of any constituent task.

The credential generation agent 508 is configured to perform visual identification and activation of credential interface elements rendered within the graphical user interface 522 of the producer application. The credential generation agent 508 includes a graphical user interface ingestion component 508A, a trained autoencoder 508B, a credential interface element classifier 508C, and an activation triggering logic 508D. The graphical user interface ingestion component 508A is configured to capture the pixel-level rendering of the graphical user interface 522 of the producer application through screen acquisition, frame buffer reads, or operating-system-level rendering hooks. The trained autoencoder 508B is configured to receive the pixel-level rendering and produce visual feature representations of the pixel-level rendering through an encoder network that maps the pixel-level rendering into a latent space and a decoder network that produces a reconstruction loss-based supervisory signal during training. The credential interface element classifier 508C is configured to classify regions of the pixel-level rendering as credential interface elements based on the visual feature representations produced by the trained autoencoder 508B, and to output coordinates and labels of the credential interface elements. The activation triggering logic 508D is configured to emit input events directed to the credential interface elements identified by the credential interface element classifier 508C, including pointer events, keyboard events, and synthetic touch events, to elicit generation of the newly-created credential at the producer application.

The copy-paste interface automation module 510 includes the copy submodule 512 and the paste submodule 514, and is configured to extract the newly-created credential from the graphical user interface 522 of the producer application and inject the newly-created credential into the existing graphical user interface 526 of the consumer application. The copy submodule 512 includes a copy interface element detector 512A, a copy activation logic 512B, and a credential extraction buffer 512C. The copy interface element detector 512A is configured to detect a copy interface element rendered within the graphical user interface 522 of the producer application following generation of the newly-created credential. The copy activation logic 512B is configured to activate the copy interface element identified by the copy interface element detector 512A through emission of an input event directed to the copy interface element. The credential extraction buffer 512C is configured to receive the newly-created credential extracted from the graphical user interface 522 upon activation of the copy interface element and to maintain the newly-created credential in transient form within the agent 504 for subsequent injection by the paste submodule 514.

The paste submodule 514 includes a paste interface element detector 514A, a paste activation logic 514B, and a credential injection logic 514C. The paste interface element detector 514A is configured to detect a paste interface element rendered within the existing graphical user interface 526 of the consumer application. The paste activation logic 514B is configured to activate the paste interface element identified by the paste interface element detector 514A through emission of an input event directed to the paste interface element. The credential injection logic 514C is configured to deliver the newly-created credential from the credential extraction buffer 512C of the copy submodule 512 into a corresponding input field of the existing graphical user interface 526 of the consumer application following activation of the paste interface element.

The credential storage workflow engine 516 includes a vault injection logic 516A, a direct graphical user interface embedding logic 516B, and a schema validation component 516C. The vault injection logic 516A is configured to inject the newly-created credential into the credential vault 524 as a versioned, encrypted-at-rest record together with credential metadata characterizing the credential type, validity window, scope, owning identity, and source producer application. The direct graphical user interface embedding logic 516B is configured to embed the newly-created credential directly into the existing graphical user interface 526 of the consumer application by activating storage interface elements rendered on the existing graphical user interface 526. The schema validation component 516C is configured to confirm structural conformance of the newly-created credential to expected formats prior to storage, including verification of credential length, character set, and prefix conventions associated with the credential type.

The security and access mediator 518 is configured to enforce policy constraints during execution of the workflow by validating access events, performing policy validations, routing the newly-created credential to authorized destinations, and producing tamper-evident audit records, in correspondence with the security and access mediator 416 described in connection with FIG. 4. The notification and alert manager 520 is configured to dispatch asynchronous alerts to subscribing recipients including the identity control system 502, enterprise administrators, compliance officers, application owners, and security operations teams upon completion or failure of the workflow, in correspondence with the notification and alert manager 418 described in connection with FIG. 4.

FIG. 5 further depicts the operative flow within the architecture 500 across the two sheets connected through the continuity markers A, B, C, and D. On the first sheet, the credential generation trigger emitted by the identity control system 502 enters the trigger intake 506A of the agent execution manager 506, is decomposed into atomic tasks by the atomic task decomposition component 506B, and is dispatched in parallel or in sequence by the parallel task dispatcher 506C to the credential generation agent 508 and the copy-paste interface automation module 510. The graphical user interface ingestion component 508A captures the pixel-level rendering of the graphical user interface 522, the trained autoencoder 508B produces the visual feature representations, the credential interface element classifier 508C classifies the credential interface elements, and the activation triggering logic 508D emits input events to the graphical user interface 522 to elicit generation of the newly-created credential. The copy interface element detector 512A then detects the copy interface element on the graphical user interface 522, the copy activation logic 512B activates the copy interface element, and the newly-created credential extracted from the graphical user interface 522 is held in the credential extraction buffer 512C. The continuity markers A, B, C, and D carry the operative flow to the second sheet, with marker A carrying the newly-created credential from the copy submodule 512 to the vault injection logic 516A, marker B carrying orchestration to the direct graphical user interface embedding logic 516B, marker C carrying orchestration to the existing graphical user interface 526, and marker D carrying activation directives from the paste submodule 514 to the existing graphical user interface 526. On the second sheet, the schema validation component 516C confirms structural conformance of the newly-created credential to expected formats, the vault injection logic 516A injects the newly-created credential into the credential vault 524 in encrypted-at-rest form, and the direct graphical user interface embedding logic 516B embeds the newly-created credential into the existing graphical user interface 526 of the consumer application. The credential injection logic 514C of the paste submodule 514 cooperates with the paste activation logic 514B to inject the newly-created credential from the credential extraction buffer 512C into the existing graphical user interface 526 along the marker D path. Throughout the operative flow, the security and access mediator 518 produces the tamper-evident audit records, the completion tracker 506D monitors execution status of each atomic task and triggers commit operations upon successful completion of all atomic tasks or rollback operations upon failure of any constituent task, and upon completion of the workflow, the notification and alert manager 520 dispatches the asynchronous alerts to the subscribing recipients including the identity control system 502.

### Method Flowchart for Automated Credential Generation and Propagation

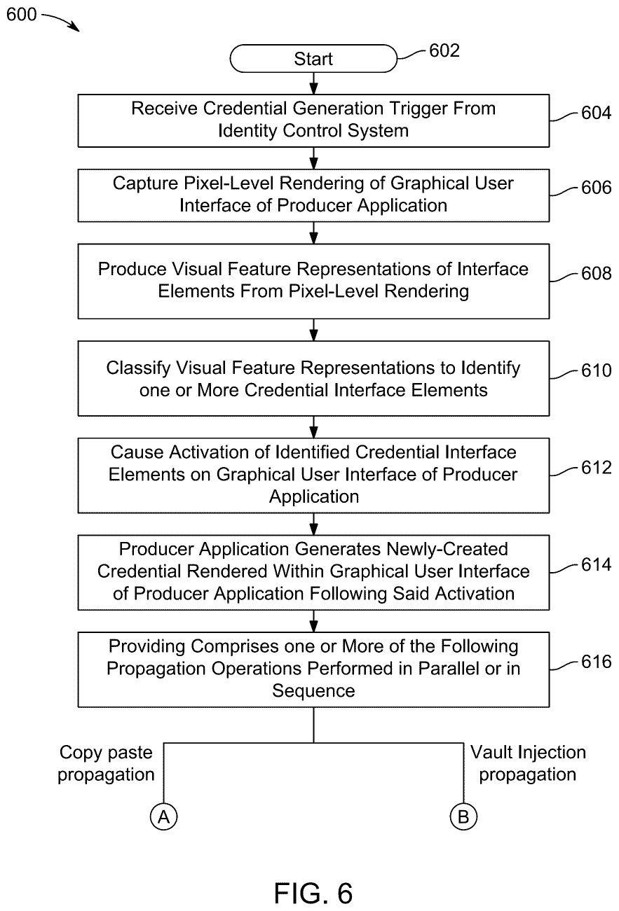

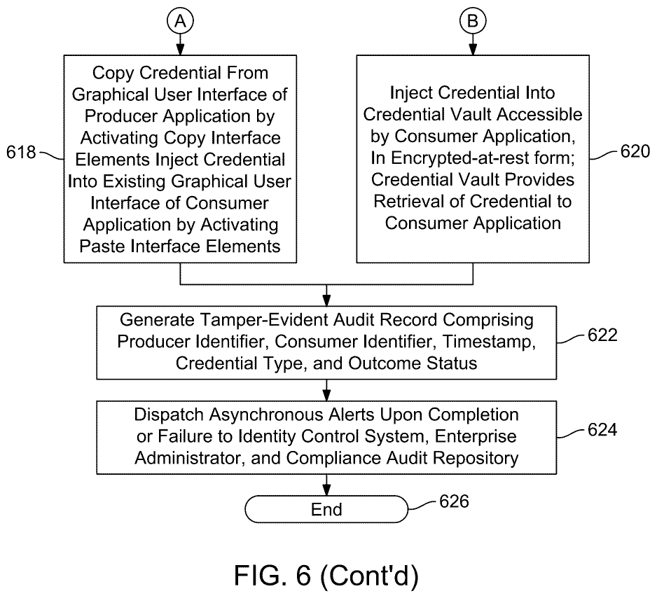

FIG. 6 illustrates a method flowchart 600 for automated credential generation and propagation through visual identification and activation of graphical user interface elements, in accordance with certain embodiments of the present disclosure. The method flowchart 600, also referred to as the method 600, depicts an operative sequence performed by the agent of FIG. 4 and FIG. 5 in response to a credential generation trigger received from the identity control system, beginning at a start state 602 and proceeding through a sequence of operations that collectively render a newly-created credential generated at a producer application and propagated to one or more consumer applications. The method 600 is depicted across two sheets connected through continuity markers A and B, with continuity marker A carrying a copy-paste propagation branch and continuity marker B carrying a vault injection propagation branch.

The method 600 begins at the start state 602 and proceeds to step 604 of receiving the credential generation trigger from the identity control system. The credential generation trigger carries identification of the producer application, identification of the one or more consumer applications, an identifier of an owning identity, and parameters that govern the credential lifecycle, including credential type, validity window, and scope. The agent receives the credential generation trigger through a network interface communicatively coupled with the identity control system or through an API exposed by an upstream orchestration platform.

The method 600 proceeds to step 606 of capturing a pixel-level rendering of a graphical user interface of the producer application. The capture of the pixel-level rendering is performed through screen acquisition application programming interfaces of an underlying operating system, frame buffer reads, or operating-system-level rendering hooks, and produces a raster image that represents the graphical user interface of the producer application as displayed at the time of capture. The method 600 proceeds to step 608 of producing visual feature representations of interface elements from the pixel-level rendering. The visual feature representations are produced through application of the trained autoencoder of FIG. 5 and FIG. 7 that maps the pixel-level rendering into a latent space through an encoder network, with the visual feature representations capturing geometric, textural, and semantic attributes of regions of the pixel-level rendering. The method 600 proceeds to step 610 of classifying the visual feature representations to identify one or more credential interface elements rendered within the graphical user interface of the producer application. The classification at step 610 distinguishes credential interface elements, including credential generation controls, key name input fields, scope toggles, expiration controls, and copy controls, from non-credential interface elements, including unrelated navigation controls, display labels, and decorative elements, and outputs coordinates and labels of the identified credential interface elements.

The method 600 proceeds to step 612 of causing activation of the identified credential interface elements on the graphical user interface of the producer application. The activation is performed through emission of input events directed to the identified credential interface elements, including pointer events, keyboard events, and synthetic touch events, by the activation triggering logic of the credential generation agent of FIG. 5. The method 600 proceeds to step 614 of generating, by the producer application, the newly-created credential rendered within the graphical user interface of the producer application following the activation. The newly-created credential includes a password, an API key, an authentication token, a multi-factor authentication seed, a certificate, or a shared secret, and is rendered within a credential display region of the graphical user interface of the producer application upon completion of the credential generation transaction at the producer application.

The method 600 proceeds to step 616 of providing the newly-created credential to the consumer application, including one or more propagation operations performed in parallel or in sequence. The propagation operations include a copy-paste propagation branch designated by continuity marker A and a vault injection propagation branch designated by continuity marker B. The agent selects between the propagation operations, performs both propagation operations in parallel, or performs the propagation operations in sequence, based on a configured workflow policy associated with the credential generation trigger.

Along the copy-paste propagation branch, the method 600 proceeds to step 618 of copying the newly-created credential from the graphical user interface of the producer application by activating copy interface elements rendered on the graphical user interface and injecting the newly-created credential into an existing graphical user interface of the consumer application by activating paste interface elements rendered on the existing graphical user interface. The activation of the copy interface elements and the paste interface elements is performed by the copy submodule and the paste submodule of the copy-paste interface automation module of FIG. 5, with the newly-created credential held in the credential extraction buffer of the copy submodule between the copy operation and the paste operation.

Along the vault injection propagation branch, the method 600 proceeds to step 620 of injecting the newly-created credential into a credential vault accessible by the consumer application, in encrypted-at-rest form, with the credential vault providing retrieval of the newly-created credential to the consumer application. The injection of the newly-created credential into the credential vault is performed by the vault injection logic of the credential storage workflow engine of FIG. 5, and the credential vault stores the newly-created credential along with credential metadata including credential type, version identifier, TTL value, and a status indicator that takes a value of active or rotated-out.

The method 600 proceeds to step 622 of generating a tamper-evident audit record comprising a producer identifier, a consumer identifier, a timestamp, a credential type, and an outcome status. The tamper-evident audit record is generated by the security and access mediator of FIG. 5 for each step of the method 600 and may be sealed using cryptographic chaining, an append-only ledger, a write-once-read-many storage medium, or a hash chain anchored to an immutable timestamping service. The method 600 proceeds to step 624 of dispatching asynchronous alerts upon completion or failure of the method 600 to the identity control system, an enterprise administrator, and a compliance audit repository. The asynchronous alerts are delivered through electronic mail, instant messaging platforms, webhook callbacks to upstream orchestration systems, or syslog feeds to enterprise monitoring infrastructure. The method 600 terminates at an end state 626.

### Trained Autoencoder Operational View

FIG. 7 illustrates a trained autoencoder operational view 700 of the credential generation agent of FIG. 5, in accordance with certain embodiments of the present disclosure. The trained autoencoder operational view 700, also referred to as the operational view 700, depicts the data path through which a pixel-level rendering of a graphical user interface of a producer application is processed by a trained autoencoder to identify credential interface elements rendered within the graphical user interface, and through which activation directives are emitted to an activation triggering logic for activation of the identified credential interface elements at the producer application. The operational view 700 corresponds to the internal data path of the credential generation agent 508 of FIG. 5 and depicts in finer detail the cooperation among the graphical user interface ingestion component 508A, the trained autoencoder 508B, the credential interface element classifier 508C, and the activation triggering logic 508D of FIG. 5.

The pixel-level rendering of the graphical user interface 702 represents the raster image captured from the graphical user interface of the producer application by the graphical user interface ingestion component of FIG. 5. The pixel-level rendering of the graphical user interface 702 includes an API key management console 704 representing the credential management console of the producer application, a credential area populated on activation 706 representing the credential display region within the graphical user interface that is populated upon activation of a credential generation control, and a copy control 708 representing a copy interface element. The API key management console 704 includes one or more interface controls participating in the credential generation transaction, including a key name input field, an expiration dropdown selector, a generate key control representing the credential generation control, and a cancel control. The credential area populated on activation 706 is unpopulated prior to activation of the generate key control of the API key management console 704 and becomes populated with a newly-created credential upon completion of the credential generation transaction at the producer application.

The trained autoencoder 710 is configured to receive the pixel-level rendering of the graphical user interface 702 as an input and to produce a classification output that identifies credential interface elements rendered within the pixel-level rendering of the graphical user interface 702. The trained autoencoder 710 includes an encoder 712, a latent space 714, a decoder 716, and a classification head 718 arranged in a sequential pipeline. The trained autoencoder 710 is trained on a corpus of pixel-level renderings of graphical user interfaces collected from a plurality of producer applications, with annotations identifying credential interface elements and non-credential interface elements within the corpus. Training of the trained autoencoder 710 is performed through minimization of a composite loss function that combines a reconstruction loss between the pixel-level rendering provided as input and a reconstruction produced by the decoder 716, and a classification loss between the classification output produced by the classification head 718 and ground-truth annotations of the corpus, thereby rendering the trained autoencoder 710 capable of generalizing across producer applications and across user interface revisions of a given producer application.

The encoder 712 is configured to receive the pixel-level rendering of the graphical user interface 702 and to map the pixel-level rendering into the latent space 714 through a sequence of learned transformations, including convolutional layers, attention layers, normalization layers, and non-linear activations. The encoder 712 progressively reduces spatial resolution of the pixel-level rendering and progressively increases representational depth of the resulting feature maps, thereby producing a compressed representation of the pixel-level rendering at the output of the encoder 712. The latent space 714 represents a vector space of reduced dimensionality relative to the pixel-level rendering of the graphical user interface 702, and stores visual feature representations of regions of the pixel-level rendering that capture geometric, textural, and semantic attributes relevant to identification of credential interface elements. The decoder 716 is configured to receive the visual feature representations from the latent space 714 and to produce a reconstruction of the pixel-level rendering through an inverse sequence of learned transformations, including transposed convolutional layers, upsampling layers, normalization layers, and non-linear activations. The reconstruction produced by the decoder 716 is used during training of the trained autoencoder 710 to compute the reconstruction loss component of the composite loss function.

The classification head 718 is configured to receive the visual feature representations from the latent space 714 and to produce a classification output that distinguishes credential interface elements 718A from non-credential interface elements 718B for each region of the pixel-level rendering of the graphical user interface 702. The classification head 718 includes a sequence of fully-connected layers, normalization layers, and a softmax layer that produces a probability distribution over the two classes for each candidate region. The credential interface elements 718A correspond to interface controls participating in the credential generation transaction, including the generate key control of the API key management console 704 and the copy control 708. The non-credential interface elements 718B correspond to interface controls that do not participate in the credential generation transaction, including unrelated navigation controls, decorative elements, and display labels. The classification head 718 retains the credential interface elements 718A for downstream processing and discards the non-credential interface elements 718B.

The credential interface elements 720 represent the output set of credential interface elements identified by the trained autoencoder 710 and include a class (i) and a class (ii) sub-classification that further partitions the credential interface elements 720 into functional sub-categories, including a first sub-class corresponding to credential generation controls and a second sub-class corresponding to copy interface elements. The credential interface elements 720 are emitted to an activation triggering logic 722. The activation triggering logic 722 corresponds to the activation triggering logic 508D of FIG. 5 and is configured to emit input events directed to the credential interface elements 720, including pointer events directed to the generate key control of the API key management console 704, keyboard entry events directed to the key name input field, dropdown selection events directed to the expiration dropdown selector, and pointer events directed to the copy control 708, thereby eliciting generation of the newly-created credential within the credential area populated on activation 706 and subsequent extraction of the newly-created credential through the copy control 708.

FIG. 7 further depicts the operative flow of the operational view 700. The pixel-level rendering of the graphical user interface 702 is captured from the graphical user interface of the producer application and provided as input to the encoder 712 of the trained autoencoder 710. The encoder 712 maps the pixel-level rendering into the latent space 714, and the latent space 714 stores the visual feature representations of regions of the pixel-level rendering. The decoder 716 produces the reconstruction of the pixel-level rendering for use during training of the trained autoencoder 710, and the classification head 718 produces the classification output that distinguishes the credential interface elements 718A from the non-credential interface elements 718B. The credential interface elements 720 are output from the trained autoencoder 710 and are received by the activation triggering logic 722. The activation triggering logic 722 emits the input events to the credential interface elements 720 to elicit generation of the newly-created credential at the producer application. The trained autoencoder 710 thereby provides an interface-centric mechanism that identifies credential interface elements within rendered graphical user interfaces of producer applications without requiring application-specific programmatic interfaces or hand-coded interface element locators, and accommodates user interface revisions of a given producer application through the generalization properties of the trained autoencoder 710.

### End-to-End Credential Generation and Propagation Workflow

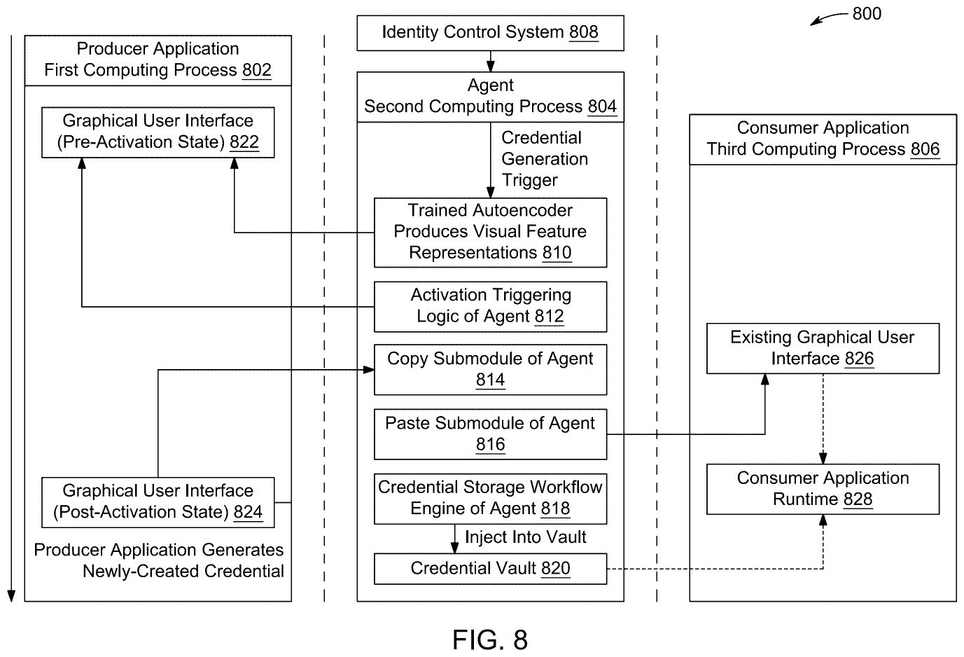

FIG. 8 illustrates a swim-lane interaction diagram 800 depicting an end-to-end credential generation and propagation workflow performed across three distinct computing processes, in accordance with certain embodiments of the present disclosure. The swim-lane interaction diagram 800, also referred to as the diagram 800, depicts the temporal sequence of operations exchanged among a producer application, an agent, and a consumer application during execution of the workflow, beginning at receipt of a credential generation trigger and culminating at delivery of a newly-created credential to the consumer application. The diagram 800 organizes the workflow into three swim lanes corresponding to the three distinct computing processes that participate in the workflow.

The diagram 800 includes a first swim lane corresponding to a producer application 802 representing the first computing process, a second swim lane corresponding to an agent 804 representing the second computing process, and a third swim lane corresponding to a consumer application 806 representing the third computing process. The diagram 800 further depicts an identity control system 808 that emits the credential generation trigger to the agent 804 to initiate the workflow. The producer application 802 corresponds to the producer application 422 of FIG. 4, the agent 804 corresponds to the agent 404 of FIG. 4 and the agent 504 of FIG. 5, the consumer application 806 corresponds to the consumer application 426 of FIG. 4, and the identity control system 808 corresponds to the identity control system 402 of FIG. 4 and the identity control system 502 of FIG. 5.

Within the swim lane of the producer application 802, the diagram 800 depicts a graphical user interface in a pre-activation state 822 representing the graphical user interface of the producer application 802 prior to activation of credential interface elements rendered within the graphical user interface, and a graphical user interface in a post-activation state 824 representing the graphical user interface of the producer application 802 after activation of the credential interface elements and after generation of the newly-created credential by the producer application 802. The graphical user interface in the pre-activation state 822 corresponds to a state of the graphical user interface in which a credential display region is unpopulated and a credential generation control is in a ready-to-activate condition. The graphical user interface in the post-activation state 824 corresponds to a subsequent state of the graphical user interface in which the credential display region is populated with the newly-created credential and a copy interface element is rendered for extraction of the newly-created credential. The diagram 800 further depicts an activity within the swim lane of the producer application 802 in which the producer application 802 generates the newly-created credential rendered within the graphical user interface upon activation of the credential generation control.

Within the swim lane of the agent 804, the diagram 800 depicts a sequence of activities performed by submodules of the agent 804. The trained autoencoder produces visual feature representations 810 representing application of the trained autoencoder of FIG. 5 and FIG. 7 to a pixel-level rendering of the graphical user interface in the pre-activation state 822 to produce visual feature representations of regions of the pixel-level rendering. The activation triggering logic of agent 812 represents the activation triggering logic 508D of FIG. 5 that emits input events directed to the credential interface elements identified through the visual feature representations to elicit generation of the newly-created credential at the producer application 802. The copy submodule of agent 814 represents the copy submodule 512 of FIG. 5 that activates a copy interface element on the graphical user interface in the post-activation state 824 and extracts the newly-created credential into a credential extraction buffer of the agent 804. The paste submodule of agent 816 represents the paste submodule 514 of FIG. 5 that activates a paste interface element on an existing graphical user interface 826 of the consumer application 806 and injects the newly-created credential from the credential extraction buffer into a corresponding input field of the existing graphical user interface 826. The credential storage workflow engine of agent 818 represents the credential storage workflow engine 516 of FIG. 5 that injects the newly-created credential into a credential vault 820 in encrypted-at-rest form, with the credential vault 820 corresponding to the credential vault 524 of FIG. 5.

Within the swim lane of the consumer application 806, the diagram 800 depicts the existing graphical user interface 826 of the consumer application 806 that receives the newly-created credential from the paste submodule of agent 816 through activation of the paste interface element rendered on the existing graphical user interface 826, and a consumer application runtime 828 that consumes the newly-created credential during operation of the consumer application 806. The consumer application runtime 828 retrieves the newly-created credential from the credential vault 820 in operational scenarios in which the newly-created credential is stored in the credential vault 820 by the credential storage workflow engine of agent 818, or receives the newly-created credential through the existing graphical user interface 826 in operational scenarios in which the newly-created credential is inserted into the existing graphical user interface 826 by the paste submodule of agent 816.

FIG. 8 further depicts the operative flow of the diagram 800. The identity control system 808 emits the credential generation trigger to the agent 804. Within the agent 804, the trained autoencoder produces visual feature representations 810 by reading the pixel-level rendering of the graphical user interface in the pre-activation state 822 of the producer application 802. The activation triggering logic of agent 812 then emits input events to the graphical user interface of the producer application 802 to activate the credential interface elements, and the producer application 802 generates the newly-created credential rendered within the graphical user interface in the post-activation state 824. The copy submodule of agent 814 then extracts the newly-created credential from the graphical user interface in the post-activation state 824 of the producer application 802. The paste submodule of agent 816 then injects the newly-created credential into the existing graphical user interface 826 of the consumer application 806. In parallel or in sequence, the credential storage workflow engine of agent 818 injects the newly-created credential into the credential vault 820, and the consumer application runtime 828 retrieves the newly-created credential from the credential vault 820 or receives the newly-created credential through the existing graphical user interface 826. The diagram 800 thereby provides a temporally resolved view of the credential generation and propagation workflow and depicts cooperation among the three distinct computing processes and the cross-process emission of the credential generation trigger by the identity control system 808.

### Copy-Paste Credential Propagation Flow

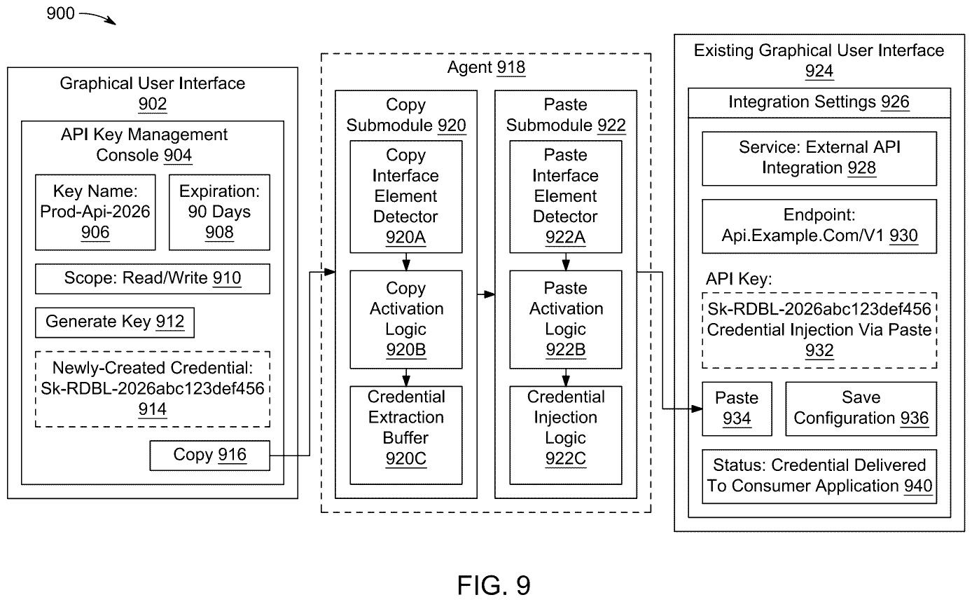

FIG. 9 illustrates a copy-paste credential propagation flow 900 depicting an end-to-end transfer of a newly-created credential from a graphical user interface of a producer application to an existing graphical user interface of a consumer application through cooperation of a copy submodule and a paste submodule of an agent, in accordance with certain embodiments of the present disclosure. The copy-paste credential propagation flow 900, also referred to as the flow 900, depicts a representative implementation of the copy-paste interface automation module 510 of FIG. 5 operating on populated graphical user interfaces of a producer application and a consumer application, with specific exemplary values populated within the graphical user interfaces to illustrate the data path through which the newly-created credential is transferred.

The flow 900 includes a graphical user interface 902 of the producer application, an agent 918, and an existing graphical user interface 924 of the consumer application. The graphical user interface 902 corresponds to the graphical user interface 424 of FIG. 4 and the graphical user interface 522 of FIG. 5, the agent 918 corresponds to the agent 404 of FIG. 4 and the agent 504 of FIG. 5, and the existing graphical user interface 924 corresponds to the existing graphical user interface 428 of FIG. 4 and the existing graphical user interface 526 of FIG. 5.

The graphical user interface 902 of the producer application includes an API key management console 904 representing the credential management console of the producer application, a key name input region 906 populated with an exemplary key name of “Prod-Api-2026,” an expiration selector 908 populated with an exemplary validity window of 90 days, a scope selector 910 populated with an exemplary scope of read/write, a generate key control 912 representing the credential generation control, a newly-created credential 914 rendered upon activation of the generate key control 912 and populated with an exemplary credential value of “Sk-RDBL-2026abc123def456,” and a copy control 916 representing the copy interface element. The exemplary key name, the exemplary validity window, the exemplary scope, and the exemplary credential value are illustrative values populated within the graphical user interface 902 of the producer application for purposes of illustration of the flow 900 and do not limit the values that may be populated within the graphical user interface 902 of the producer application during operation of the flow 900.

The agent 918 includes the copy submodule 920 and the paste submodule 922. The copy submodule 920 includes a copy interface element detector 920A, a copy activation logic 920B, and a credential extraction buffer 920C, in correspondence with the copy submodule 512 of FIG. 5. The paste submodule 922 includes a paste interface element detector 922A, a paste activation logic 922B, and a credential injection logic 922C, in correspondence with the paste submodule 514 of FIG. 5. The copy interface element detector 920A is configured to detect the copy control 916 rendered within the graphical user interface 902 of the producer application following population of the newly-created credential 914, the copy activation logic 920B is configured to activate the copy control 916, and the credential extraction buffer 920C is configured to receive the newly-created credential 914 extracted from the graphical user interface 902 upon activation of the copy control 916. The paste interface element detector 922A is configured to detect a paste control 934 rendered within the existing graphical user interface 924 of the consumer application, the paste activation logic 922B is configured to activate the paste control 934, and the credential injection logic 922C is configured to deliver the newly-created credential from the credential extraction buffer 920C into a corresponding input field of the existing graphical user interface 924 following activation of the paste control 934.

The existing graphical user interface 924 of the consumer application includes an integration settings region 926 representing a configuration panel of the consumer application, a service selector 928 populated with an exemplary service of external API integration, an endpoint input region 930 populated with an exemplary endpoint of “Api.Example.Com/V1,” an API key input region 932 populated with the newly-created credential of “Sk-RDBL-2026abc123def456” upon activation of the paste control 934 by the paste submodule 922 and labeled “Credential Injection Via Paste” to indicate the injection mechanism, the paste control 934 representing the paste interface element, a save configuration control 936 representing the storage interface element that commits the newly-created credential to the consumer application, and a status indicator 940 populated upon completion of the flow 900 with an exemplary status of “Credential Delivered To Consumer Application.” The exemplary service, the exemplary endpoint, and the exemplary status are illustrative values populated within the existing graphical user interface 924 of the consumer application for purposes of illustration of the flow 900 and do not limit the values that may be populated within the existing graphical user interface 924 of the consumer application during operation of the flow 900.

FIG. 9 further depicts the operative flow of the flow 900. Following population of the API key management console 904 of the graphical user interface 902 with the key name input region 906, the expiration selector 908, and the scope selector 910, the generate key control 912 is activated to elicit generation of the newly-created credential 914 by the producer application. The copy interface element detector 920A then detects the copy control 916 within the graphical user interface 902, the copy activation logic 920B activates the copy control 916, and the newly-created credential 914 extracted from the graphical user interface 902 is held within the credential extraction buffer 920C. The paste interface element detector 922A then detects the paste control 934 within the existing graphical user interface 924, the paste activation logic 922B activates the paste control 934, and the credential injection logic 922C delivers the newly-created credential from the credential extraction buffer 920C into the API key input region 932 of the existing graphical user interface 924 of the consumer application. The agent 918 may then activate the save configuration control 936 to commit the newly-created credential to the consumer application, and the status indicator 940 of the existing graphical user interface 924 is populated to indicate that the newly-created credential has been delivered to the consumer application. The flow 900 thereby provides a data path through which the newly-created credential traverses the graphical user interface 902 of the producer application, the credential extraction buffer 920C of the copy submodule 920, the paste submodule 922, and the existing graphical user interface 924 of the consumer application. In certain implementations, the data path is performed without requiring an application-specific programmatic interface at the producer application or the consumer application.

### Exemplary Identity Lifecycle Propagation Workflow for a Leaver Event

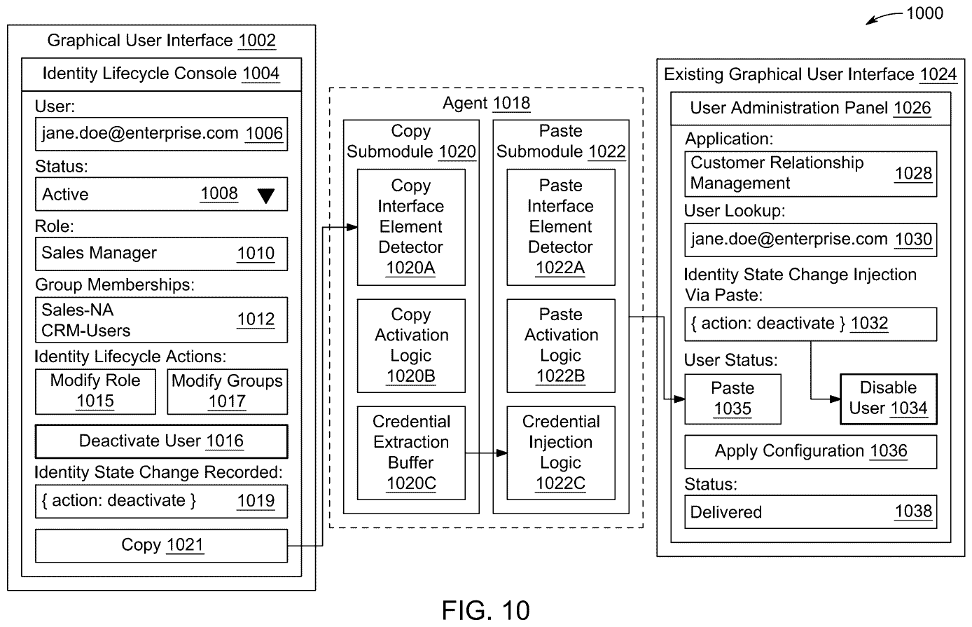

FIG. 10 illustrates an exemplary identity lifecycle propagation workflow 1000 for a leaver event performed through visual identification and activation of graphical user interface elements, in accordance with certain embodiments of the present disclosure.

The identity lifecycle propagation workflow 1000, also referred to as the workflow 1000, depicts a graphical-user-interface-based propagation of an identity state change from an identity lifecycle console to a downstream user administration panel of a consumer application. The workflow 1000 extends the visual-interface automation principles described above in connection with FIG. 9 from credential propagation to identity lifecycle state propagation, including deactivation, suspension, deletion, revocation, or other removal of access of a user account in a target application.

As illustrated, the identity lifecycle propagation workflow 1000 includes a graphical user interface 1002 of a producer application, an identity lifecycle console 1004 rendered within the graphical user interface 1002, an identity lifecycle agent 1018, and an existing graphical user interface 1024 of a consumer application. The graphical user interface 1002 may be rendered by any suitable producer application from which an authorized administrator or an upstream authoritative system initiates a state change to a user identity, including, but not limited to, a system of record, an identity governance and administration platform, an identity provider console, an enterprise human resources information system, or the like. The existing graphical user interface 1024 may be rendered by any suitable consumer application affected by the user identity, including, but not limited to, a customer relationship management system, a collaboration platform, an enterprise productivity suite, an information technology service management system, a financial system, a privileged access console, a disconnected legacy application, or the like.

The identity lifecycle console 1004 may comprise a user identifier field 1006, a status field 1008, a role field 1010, a group memberships field 1012, a modify role control 1015, a deactivate user control 1016, a modify groups control 1017, an identity state change recorded region 1019, and a copy control 1021. In the illustrated embodiment, the user identifier field 1006 is populated with an exemplary user identifier of jane.doe@enterprise.com, the status field 1008 indicates an active status, the role field 1010 indicates an exemplary role of Sales Manager, and the group memberships field 1012 identifies one or more groups to which the user belongs, including Sales-NA and CRM-Users. These values are illustrative and do not limit the user identifiers, statuses, roles, group memberships, or identity attributes that may be represented within the identity lifecycle console 1004.

The identity lifecycle console 1004 may further render one or more lifecycle action controls associated with the user identity. In some examples, the lifecycle action controls may include the modify role control 1015, the deactivate user control 1016, and the modify groups control 1017. In some examples, additional lifecycle action controls may be rendered, including, but not limited to, a suspend user control, a reactivate user control, an access recertification control, a group removal control, a license revocation control, or the like. As illustrated in FIG. 10, the deactivate user control 1016 has been activated, indicating that a leaver action has been invoked with respect to the user identity.

In response to activation of the deactivate user control 1016, the identity lifecycle console 1004 may display, in the identity state change recorded region 1019, a record of the lifecycle action invoked. The record may include any suitable representation of the state change, such as a structured object notation, a serialized artifact, a markup language element, a textual entry, or the like. For example, the record may comprise a structured notation of the form “{action: deactivate}” as illustrated. In some examples, the recorded state change may further include a user identifier, an event identifier, a timestamp, a source system identifier, a prior identity state, a target identity state, a policy identifier, or another identity-related attribute associated with the leaver event.

The copy control 1021 may, when activated, cause the recorded state change to be captured for downstream propagation. In some examples, activation of the copy control 1021 may invoke a copy submodule 1020 of the identity lifecycle agent 1018. The copy submodule 1020 may include a copy interface element detector 1020A configured to identify, from pixel-level rendering of the graphical user interface 1002, the copy control 1021 associated with the recorded state change, a copy activation logic 1020B configured to cause activation of the identified copy control 1021, and a protected transfer buffer configured to retain the recorded state change for delivery to one or more consumer applications. Although the protected transfer buffer may be labeled as a credential extraction buffer in certain implementations, the protected transfer buffer may retain any suitable artifact rendered in the graphical user interface 1002 following activation, including, but not limited to, a credential, a structured event record, an identifier, a policy artifact, or an observable identity state change.

The identity lifecycle agent 1018 may receive the captured state change from the copy submodule 1020 and may identify, based at least in part on the user identifier and the lifecycle action recorded in the state change, one or more consumer applications to which the state change is to be propagated. The identity lifecycle agent 1018 may further include a paste submodule 1022 operable to deliver the captured state change into the consumer application by activating one or more interface elements rendered in the existing graphical user interface 1024. The paste submodule 1022 may include a paste interface element detector 1022A configured to identify, from pixel-level rendering of the existing graphical user interface 1024, one or more paste-target interface elements, a paste activation logic 1022B configured to cause activation of the identified paste-target interface elements, and a credential injection logic 1022C configured to inject the captured state change into the existing graphical user interface 1024.

The existing graphical user interface 1024 may render a user administration panel 1026 comprising an application identifier field 1028, a user lookup field 1030, an identity state change injection via paste region 1032, a disable user control 1034, an apply configuration control 1036, and a status field 1038. In the illustrated embodiment, the application identifier field 1028 identifies an exemplary consumer application as a customer relationship management application, and the user lookup field 1030 is populated with the user identifier jane.doe@enterprise.com, thereby identifying the user account to which the lifecycle action is to be applied within the consumer application.

In response to delivery of the captured state change by the paste submodule 1022, the identity state change injection via paste region 1032 may render the state change as injected into the existing graphical user interface 1024, particularly into a paste 1035 module, as illustrated. The disable user control 1034 of the user administration panel 1026 may be identified from pixel-level rendering of the existing graphical user interface 1024 and activated by the paste submodule 1022, causing the disable user control 1034 to enter an activated state in correspondence with the leaver action recorded at the graphical user interface 1002 of the producer application. In some examples, the identity lifecycle agent 1018 may translate an abstract termination or offboarding policy into one or more application-specific graphical user interface interactions, including locating the user account, opening an account-status selector, selecting a disabled state, confirming a warning dialog, and activating the apply configuration control 1036.

The apply configuration control 1036 may, when activated, cause the consumer application to commit the disablement of the user identity. The status field 1038 may, following commitment, render a confirmation that the state change has been delivered, for example, a “Delivered” indication as illustrated. In some examples, following commitment, the identity lifecycle agent 1018 may further capture a post-activation pixel-level rendering of the existing graphical user interface 1024 and verify, based on the content of the post-activation pixel-level rendering, that the user identity has transitioned to a disabled, suspended, deleted, or otherwise access-revoked state in the consumer application.

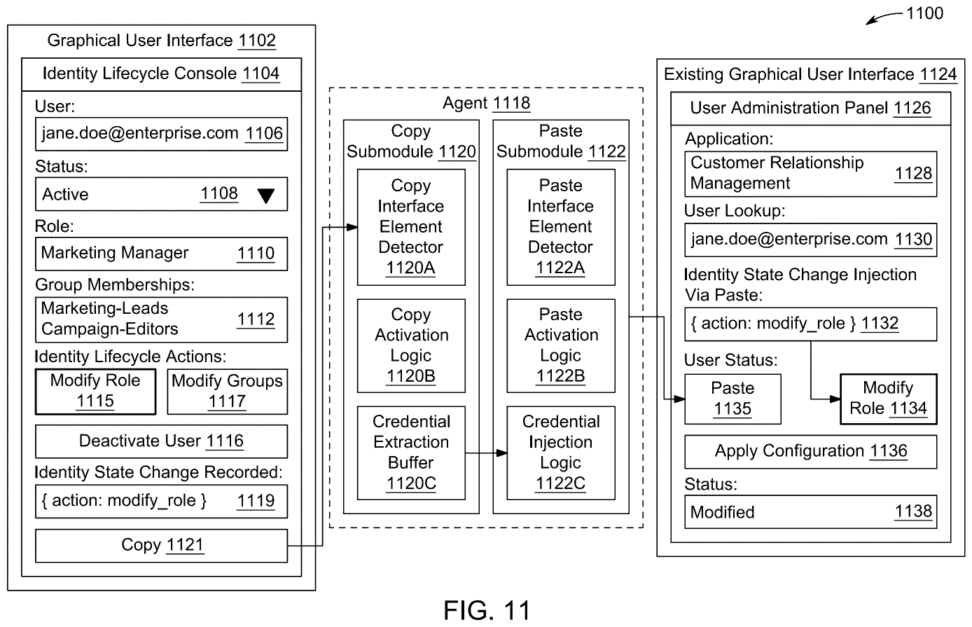

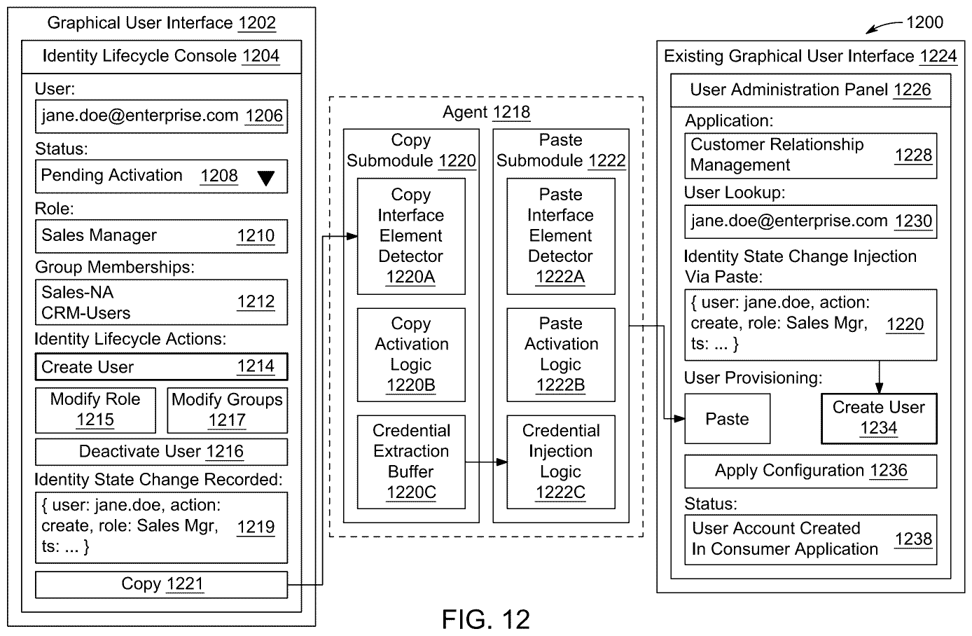

While the illustrated workflow describes a leaver event invoked through activation of the deactivate user control 1016, the workflow 1000 is exemplary and other or additional variations may be utilized. For example, the workflow 1000 may be applied to any number of identity lifecycle action types, as further described below with respect to FIG. 11 and FIG. 12. Many variations are possible.

### Exemplary Identity Lifecycle Propagation Workflow for a Mover Event

FIG. 11 illustrates an exemplary identity lifecycle propagation workflow 1100 for a mover event performed through visual identification and activation of graphical user interface elements, in accordance with certain embodiments of the present disclosure.

The identity lifecycle propagation workflow 1100, also referred to as the workflow 1100, depicts propagation of a role modification, group modification, department transfer, entitlement modification, or other identity attribute change from an identity lifecycle console to a downstream user administration panel of an application. The workflow 1100 may be performed by the same agent architecture described above in connection with FIGS. 4, 5, 9, and 10, with the agent visually identifying interface elements, activating the interface elements, capturing a recorded identity state change, and delivering the identity state change to a consumer application through an existing graphical user interface.

As illustrated, the identity lifecycle propagation workflow 1100 includes a graphical user interface 1102 of a producer application, an identity lifecycle console 1104, an identity lifecycle agent 1118, and an existing graphical user interface 1124 of a consumer application. The graphical user interface 1102 may render a user identifier field 1106, a status field 1108, a role field 1110, a group memberships field 1112, a modify role control 1115, a deactivate user control 1116, a modify groups control 1117, an identity state change recorded region 1119, and a copy control 1121. The existing graphical user interface 1124 may render a user administration panel 1126 comprising an application identifier field 1128, a user lookup field 1130, an identity state change injection via paste region 1132, a modify role control 1134, an apply configuration control 1136, and a status field 1138.

As illustrated, the status field 1108 may display a present status of the user identity, the role field 1110 may display a present or prospective role assignment, and the group memberships field 1112 may display one or more present or prospective group memberships, for example, Marketing-Leads and Campaign-Editors. The modify role control 1115 of the identity lifecycle console 1104 has been activated, indicating that a mover action has been invoked to change the role assignment of the user identity.

In response to activation of the modify role control 1115, the identity state change recorded region 1119 may render a record of the role-modification action invoked. The record may include any suitable representation of the state change, such as a structured notation of the form “{action: modify_role}” as illustrated. In some examples, the recorded identity state change may further include a prior role, a target role, a prior department, a target department, a group-membership delta, a license delta, a manager change, a location change, approval metadata, an effective time, or a policy identifier.

The copy control 1121 may, when activated, cause the recorded state change to be captured by a copy submodule 1120 of the identity lifecycle agent 1118. The copy submodule 1120 may comprise a copy interface element detector 1120A, a copy activation logic 1120B, and a protected transfer buffer configured in the manner described above with reference to FIG. 10. The identity lifecycle agent 1118 may receive the captured state change and may propagate the captured state change to the existing graphical user interface 1124 of the consumer application through operation of a paste submodule 1122. The paste submodule 1122 may comprise a paste interface element detector 1122A, a paste activation logic 1122B, and a credential injection logic 1122C configured in the manner described above with reference to FIG. 10.

The paste interface element detector 1122A may identify, from pixel-level rendering of the existing graphical user interface 1124, the modify role control 1134 or one or more associated user-modification controls corresponding to the mover action. In response to the injection, the identity state change injection via paste region 1132 may render the state change as injected into the existing graphical user interface 1124, particularly into a paste 1135 module, as illustrated. The paste activation logic 1122B may cause activation of the modify role control 1134, causing the consumer application to receive the new role assignment for the user identity. In some examples, the identity lifecycle agent 1118 may further identify and activate one or more selector controls associated with the mover action, including, but not limited to, drop-down selectors, checkboxes, radio buttons, text input fields, toggles, or multi-select group controls, to change the user role, department, group membership, license, or entitlement in accordance with the mover event.

The apply configuration control 1136 may, when activated, cause the consumer application to commit the new role assignment or other mover-related state change. The status field 1138 may, following commitment, render a confirmation that the role modification has been delivered, for example, a “Modified” indication as illustrated. In some examples, following commitment, the identity lifecycle agent 1118 may capture a post-activation pixel-level rendering of the existing graphical user interface 1124 and verify, based on the content of the post-activation pixel-level rendering, that the role or other identity attribute of the user has been modified in the consumer application.

While the illustrated workflow describes a mover event involving a role modification, in some examples, mover events may include any suitable change to the identity attributes of the user, including, but not limited to, group membership changes, attribute changes, manager changes, location changes, license changes, department transfers, promotions, demotions, or the like. The workflow 1100 may therefore be used to translate an abstract organizational policy, such as assigning a user to a new department, into one or more concrete graphical user interface interactions, such as locating a user profile, selecting a target department value from a selector, modifying group memberships, and activating the apply configuration control 1136. The illustrated workflow is exemplary and other or additional variations may be utilized. Many variations are possible.

### Exemplary Identity Lifecycle Propagation Workflow for a Joiner Event

FIG. 12 illustrates an exemplary identity lifecycle propagation workflow 1200 for a joiner event performed through visual identification and activation of graphical user interface elements, in accordance with certain embodiments of the present disclosure.

The identity lifecycle propagation workflow 1200, also referred to as the workflow 1200, depicts graphical-user-interface-based propagation of an onboarding or provisioning state change from an identity lifecycle console to a user administration panel of a consumer application. The workflow 1200 may be used to create a user account, initialize a user profile, assign a role, assign one or more groups, allocate a license, configure an entitlement, or otherwise establish an initial access state for a new user in one or more applications.

As illustrated, the identity lifecycle propagation workflow 1200 includes a graphical user interface 1202 of a producer application, an identity lifecycle console 1204, an identity lifecycle agent 1218, and an existing graphical user interface 1224 of a consumer application. The graphical user interface 1202 may render a user identifier field 1206, a status field 1208, a role field 1210, a group memberships field 1212, an identity lifecycle actions region 1214, a create user control, a modify role control 1215, a deactivate user control 1216, a modify groups control 1217, an identity state change recorded region 1219, and a copy control 1221. The existing graphical user interface 1224 may render a user administration panel 1226 comprising an application identifier field 1228, a user lookup field 1230, an identity state change injection via paste region, a user provisioning control 1234, an apply configuration control 1236, and a status field 1238.

As illustrated in FIG. 12, the status field 1208 may render an indication that the user identity has not yet been activated in the consumer application, for example, a “Pending Activation” indication. The role field 1210 may render a prospective role assignment, for example, Sales Manager, and the group memberships field 1212 may render one or more prospective group memberships, for example, Sales-NA and CRM-Users. The create user control has been activated, indicating that a joiner action has been invoked to create the user identity in one or more consumer applications.

In response to activation of the create user control, the identity state change recorded region may render a record of the create action invoked. The record may include any suitable representation of the state change, such as a structured notation of the form “{user: jane.doe, action: create, role: Sales Mgr, ts: . . . }” as illustrated, wherein “ts” denotes a timestamp associated with the creation event. In some examples, the recorded state change may further include one or more additional onboarding parameters, including, but not limited to, an initial group assignment, a license assignment, a department identifier, a manager identifier, a location identifier, an effective date, or an onboarding template identifier.

The copy control 1221 may, when activated, cause the recorded state change to be captured by a copy submodule 1220 of the identity lifecycle agent 1218. The copy submodule 1220 may comprise a copy interface element detector 1220A, a copy activation logic 1220B, and a protected transfer buffer configured in the manner described above with reference to FIG. 10. A paste submodule 1222 of the identity lifecycle agent 1218 may comprise a paste interface element detector 1222A, a paste activation logic 1222B, and a credential injection logic 1222C. The copy submodule 1220 and the paste submodule 1222 may be configured in the manner described above with reference to FIG. 10.

The identity lifecycle agent 1218 may propagate the captured state change to the existing graphical user interface 1224 of the consumer application. The paste interface element detector 1222A may identify, from pixel-level rendering of the existing graphical user interface 1224, the user provisioning control 1234 corresponding to the joiner action. In response to delivery of the captured state change, the identity state change injection via paste region may render the state change as injected into the existing graphical user interface 1224, particularly into a paste 1235, module as illustrated. The user provisioning control 1234 may then be activated by the paste submodule 1222, causing the consumer application to provision a new user account corresponding to the user identifier.

In some examples, the identity lifecycle agent 1218 may further identify and activate one or more provisioning interface elements within the existing graphical user interface 1224, including, but not limited to, username fields, email fields, role selectors, group selectors, license selectors, manager fields, location fields, or entitlement selectors, to initialize the new user account in accordance with the joiner event. The apply configuration control 1236 may, when activated, cause the consumer application to commit the new account provisioning. The status field 1238 may, following commitment, render a confirmation that the user identity has been created, for example, a “User Account Created In Consumer Application” indication as illustrated.

In some examples, the identity lifecycle agent 1218 may first determine, using the user lookup field 1230 or one or more other interface elements of the existing graphical user interface 1224, whether a corresponding user account already exists in the consumer application. Where no corresponding user account exists, the identity lifecycle agent 1218 may proceed with the create-user workflow described above. Where a corresponding user account already exists, the identity lifecycle agent 1218 may instead update the existing account, reconcile the existing account with the authoritative state, or emit an exception according to a configured policy.

While the illustrated workflow describes a joiner event involving user account creation, in some examples, joiner events may further include any suitable onboarding operations, including, but not limited to, initial role assignment, group provisioning, license assignment, attribute initialization, entitlement assignment, or the like. The workflow 1200 may be performed for one consumer application or for a plurality of consumer applications affected by the joiner event. The illustrated workflow is exemplary and other or additional variations may be utilized. Many variations are possible.

### Credential Vault Architecture

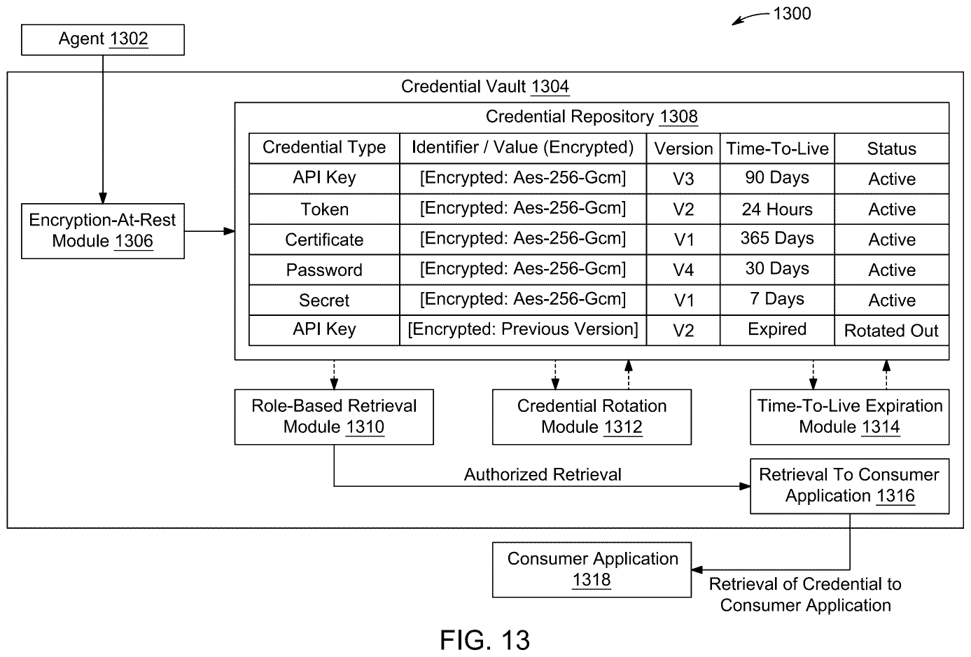

FIG. 13 illustrates a credential vault architecture 1300 depicting the internal organization of the credential vault and the auxiliary modules that govern the lifecycle of credentials stored within the credential vault, in accordance with certain embodiments of the present disclosure. The credential vault architecture 1300, also referred to as the architecture 1300, depicts the data path through which a newly-created credential is delivered from an agent into the credential vault in encrypted-at-rest form, the schema of records maintained within a credential repository internal to the credential vault, the auxiliary modules that perform role-based retrieval, credential rotation, and time-to-live expiration against the credential repository, and the data path through which the credential is retrieved from the credential vault to a consumer application.

The architecture 1300 includes an agent 1302, a credential vault 1304, an encryption-at-rest module 1306, a credential repository 1308, a role-based retrieval module 1310, a credential rotation module 1312, a time-to-live expiration module 1314, a retrieval to consumer application 1316, and a consumer application 1318. The agent 1302 corresponds to the agent 404 of FIG. 4 and the agent 504 of FIG. 5 and is configured to deliver the newly-created credential generated through the credential generation and propagation workflow described in connection with FIG. 4 and FIG. 5 to the credential vault 1304 through the encryption-at-rest module 1306. The consumer application 1318 corresponds to the consumer application 426 of FIG. 4.

The encryption-at-rest module 1306 is configured to receive the newly-created credential from the agent 1302 and to apply an encryption algorithm to the newly-created credential prior to storage within the credential vault 1304. The encryption algorithm includes the Advanced Encryption Standard with a 256-bit key in Galois/Counter Mode (AES-256-GCM), AES-256-CBC, ChaCha20-Poly1305, or other authenticated encryption algorithms, with the encryption key managed through a hardware security module, a cloud-based key management service, or a software-based key store communicatively coupled with the encryption-at-rest module 1306. The encryption-at-rest module 1306 outputs an encrypted credential along with associated authentication data, the encrypted credential being in a form unintelligible to entities lacking access to the encryption key.

The credential vault 1304 is the centralized secure storage repository for enterprise credentials of the architecture 1300 and contains the credential repository 1308. The credential repository 1308 stores credential records organized in a tabular schema, with each credential record including a credential type field, an identifier and value field that holds the encrypted credential, a version field, a time-to-live field, and a status field. The credential type field takes a value selected from API key, token, certificate, password, secret, and other credential types supported by the architecture 1300. The identifier and value field holds the credential value in encrypted form along with a notation of the encryption algorithm applied by the encryption-at-rest module 1306, including a value of “Encrypted: AES-256-GCM” for credentials encrypted using AES-256-GCM and a value of “Encrypted: Previous Version” for credential records that hold a prior version of a rotated credential. The version field takes a version identifier including V1, V2, V3, V4, and other version identifiers assigned by the credential rotation module 1312 upon successive rotations of the credential. The time-to-live field takes a time-to-live value characterizing a validity window of the credential record, including 90 days, 24 hours, 365 days, 30 days, 7 days, and an expired value upon expiration of the validity window. The status field takes a value selected from active and rotated-out, with the active value indicating that the credential record is the current version of the credential and the rotated-out value indicating that the credential record is a prior version of the credential that has been superseded by a successor version. A representative tabular representation of the credential repository 1308 with exemplary credential records corresponding to the depiction of FIG. 13 is provided in the specification as a table.

The role-based retrieval module 1310 is configured to receive retrieval requests from the consumer application 1318 directed to the credential repository 1308 and to enforce role-based access control over the retrieval requests by validating an identity of the consumer application 1318 and an associated set of access entitlements against an access control policy associated with the credential record. The role-based retrieval module 1310 grants the retrieval request when the identity of the consumer application 1318 is associated with an access entitlement matching the access control policy of the credential record, and denies the retrieval request otherwise. The credential rotation module 1312 is configured to perform periodic or event-driven rotation of credential records within the credential repository 1308 by generating a successor credential, marking the prior credential record with the rotated-out status, and creating a successor credential record with the active status and an incremented version identifier. The time-to-live expiration module 1314 is configured to monitor the time-to-live field of credential records within the credential repository 1308 and to mark credential records as expired or to remove credential records from the credential repository 1308 upon elapse of the time-to-live value associated with the credential record.

The retrieval to consumer application 1316 represents an authorized retrieval channel through which the credential vault 1304 delivers a credential record to the consumer application 1318 following grant of a retrieval request by the role-based retrieval module 1310. The retrieval to consumer application 1316 includes a decryption stage that decrypts the encrypted credential held in the identifier and value field of the credential record using the encryption key managed by the encryption-at-rest module 1306, and delivers the decrypted credential to the consumer application 1318 over a secure transport channel. The secure transport channel includes Transport Layer Security (TLS) over Hypertext Transfer Protocol Secure (HTTPS), mutual TLS, or other authenticated and confidential transport mechanisms.

FIG. 13 further depicts the operative flow of the architecture 1300. The agent 1302 delivers the newly-created credential to the encryption-at-rest module 1306, the encryption-at-rest module 1306 encrypts the newly-created credential using the encryption algorithm and outputs the encrypted credential along with associated authentication data, and the credential vault 1304 stores the encrypted credential along with the credential type, the version identifier, the time-to-live value, and the status indicator as a credential record within the credential repository 1308. The credential rotation module 1312 performs periodic or event-driven rotation of credential records within the credential repository 1308, the time-to-live expiration module 1314 marks credential records as expired upon elapse of the time-to-live value, and the role-based retrieval module 1310 enforces role-based access control over retrieval requests directed to the credential repository 1308. Upon grant of a retrieval request by the role-based retrieval module 1310, the retrieval to consumer application 1316 decrypts the encrypted credential held in the credential record and delivers the decrypted credential to the consumer application 1318 over the secure transport channel. The architecture 1300 thereby provides a centralized secure storage and lifecycle management facility for credentials generated through the credential generation and propagation workflow described in connection with FIG. 4 and FIG. 5, with encryption at rest, role-based access control, version-aware rotation, and time-to-live expiration applied as cross-cutting policy controls over the credential repository 1308.

### Dynamic Graphical User Interface Adaptation Scenario

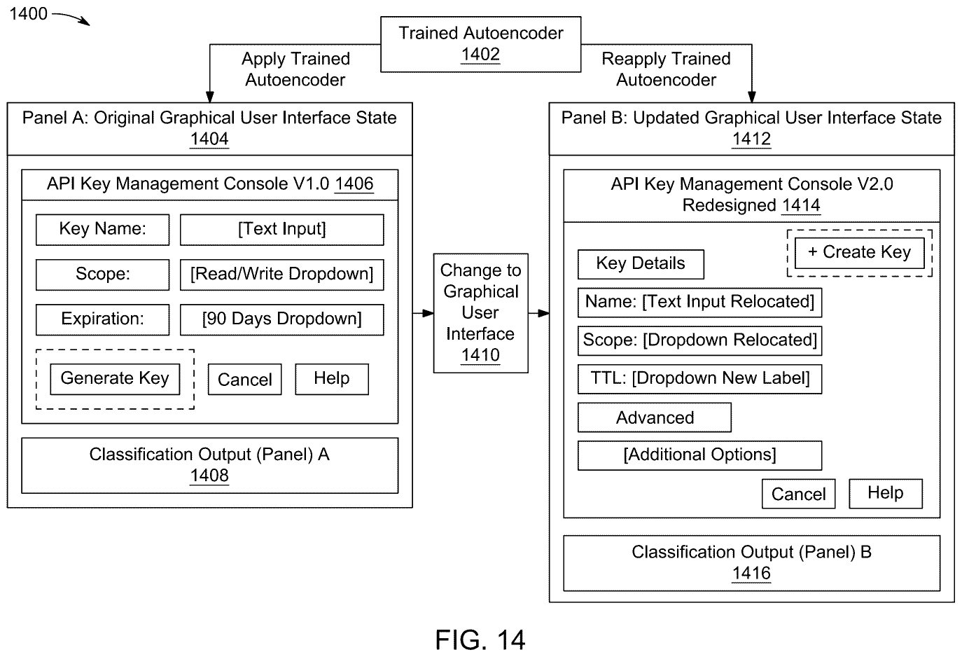

FIG. 14 illustrates a dynamic graphical user interface adaptation scenario 1400 depicting application of a trained autoencoder to two distinct states of a graphical user interface of a producer application separated by a change to the graphical user interface, in accordance with certain embodiments of the present disclosure. The dynamic graphical user interface adaptation scenario 1400, also referred to as the scenario 1400, depicts a generalization property of the trained autoencoder of FIG. 5 and FIG. 7 wherein the trained autoencoder identifies credential interface elements rendered within the graphical user interface of the producer application without retraining or reconfiguration following a redesign of the graphical user interface by the producer application.

The scenario 1400 includes a trained autoencoder 1402, an original graphical user interface state 1404 of the graphical user interface of the producer application, an API key management console V1.0 1406, a classification output of panel A 1408, a change to the graphical user interface 1410, an updated graphical user interface state 1412 of the graphical user interface of the producer application, an API key management console V2.0 redesigned 1414, and a classification output of panel B 1416. The trained autoencoder 1402 corresponds to the trained autoencoder 508B of FIG. 5 and the trained autoencoder 710 of FIG. 7 and is configured to receive a pixel-level rendering of the graphical user interface of the producer application and to produce a classification output that identifies credential interface elements rendered within the graphical user interface.

Panel A of the scenario 1400 depicts the original graphical user interface state 1404 of the graphical user interface of the producer application prior to the change to the graphical user interface 1410. The original graphical user interface state 1404 includes the API key management console V1.0 1406 representing a first version of the credential management console of the producer application. The API key management console V1.0 1406 includes a key name input field labeled “Key Name” associated with a text input control, a scope selector labeled “Scope” associated with a read/write dropdown control, an expiration selector labeled “Expiration” associated with a 90 days dropdown control, a generate key control labeled “Generate Key” representing the credential generation control, a cancel control, and a help control. The trained autoencoder 1402 is applied to the pixel-level rendering of the original graphical user interface state 1404 and produces the classification output of panel A 1408 that identifies the generate key control as the credential generation control among the credential interface elements rendered within the API key management console V1.0 1406.

The change to the graphical user interface 1410 represents a redesign of the graphical user interface of the producer application performed by the producer application independently of the trained autoencoder 1402 and independently of any retraining or reconfiguration of the trained autoencoder 1402. The change to the graphical user interface 1410 includes relocation of existing interface controls within the graphical user interface, addition of new interface controls within the graphical user interface, removal of existing interface controls from the graphical user interface, modification of labels associated with existing interface controls, modification of visual styling including font, color, and spacing of existing interface controls, replacement of existing interface controls with semantically equivalent interface controls of differing visual appearance, or any combination of the foregoing modifications.

Panel B of the scenario 1400 depicts the updated graphical user interface state 1412 of the graphical user interface of the producer application following the change to the graphical user interface 1410. The updated graphical user interface state 1412 includes the API key management console V2.0 redesigned 1414 representing a second version of the credential management console of the producer application. The API key management console V2.0 redesigned 1414 includes a create key control labeled “+ Create Key” representing the credential generation control of the second version, a key details region, a name input field labeled “Name” associated with a relocated text input control, a scope selector labeled “Scope” associated with a relocated dropdown control, a TTL selector labeled “TTL” associated with a dropdown control bearing a new label, an advanced control, an additional options region, a cancel control, and a help control. The trained autoencoder 1402 is reapplied to the pixel-level rendering of the updated graphical user interface state 1412 and produces the classification output of panel B 1416 that identifies the create key control as the credential generation control among the credential interface elements rendered within the API key management console V2.0 redesigned 1414, notwithstanding the relocation, addition, removal, label modification, and visual restyling of the credential interface elements introduced through the change to the graphical user interface 1410.

FIG. 14 further depicts the operative flow of the scenario 1400. The trained autoencoder 1402 is applied to the pixel-level rendering of the original graphical user interface state 1404, the classification output of panel A 1408 identifies the generate key control of the API key management console V1.0 1406 as the credential generation control, and the agent activates the generate key control to elicit generation of a newly-created credential at the producer application. The change to the graphical user interface 1410 thereafter occurs at the producer application, transitioning the graphical user interface from the original graphical user interface state 1404 to the updated graphical user interface state 1412. The trained autoencoder 1402 is reapplied to the pixel-level rendering of the updated graphical user interface state 1412, the classification output of panel B 1416 identifies the create key control of the API key management console V2.0 redesigned 1414 as the credential generation control, and the agent activates the create key control to elicit generation of a subsequent newly-created credential at the producer application. The scenario 1400 thereby illustrates the generalization property of the trained autoencoder 1402 wherein the credential generation and propagation workflow described in connection with FIG. 4 and FIG. 5 continues to operate against the producer application following redesigns of the graphical user interface of the producer application, without retraining of the trained autoencoder 1402, without reconfiguration of the agent, and without development of application-specific programmatic interfaces or hand-coded interface element locators tied to the original graphical user interface state 1404.

### Atomic Transaction Boundary Mechanism

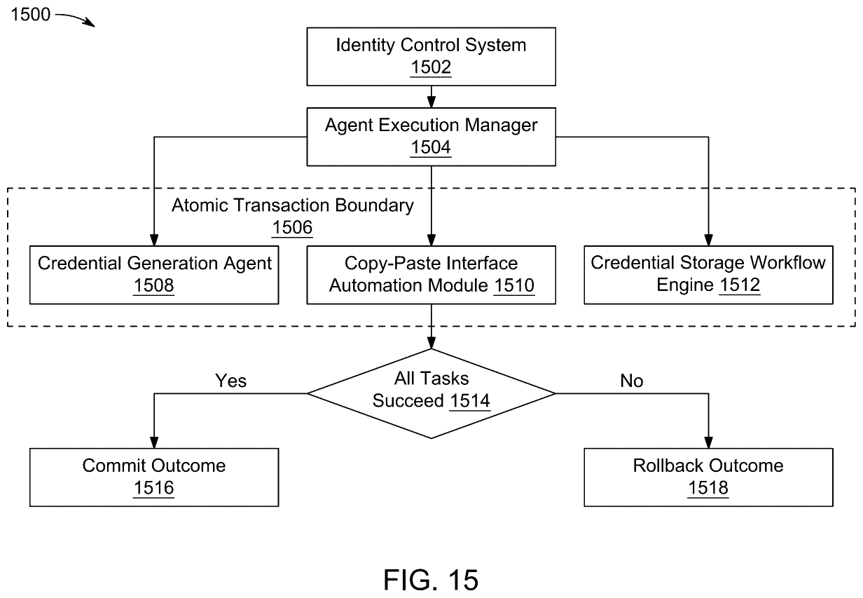

FIG. 15 illustrates an orchestration view 1500 depicting an atomic transaction boundary mechanism through which an agent execution manager coordinates parallel or sequential execution of a credential generation agent, a copy-paste interface automation module, and a credential storage workflow engine, in accordance with certain embodiments of the present disclosure. The orchestration view 1500, also referred to as the view 1500, depicts the transactional control flow that produces a binary commit or rollback outcome based on collective success or failure of the three constituent modules, thereby reducing or avoiding orphaned credentials and inconsistent states across a producer application, a consumer application, and a credential vault.

The view 1500 includes an identity control system 1502, an agent execution manager 1504, an atomic transaction boundary 1506 that encompasses a credential generation agent 1508, a copy-paste interface automation module 1510, and a credential storage workflow engine 1512, an all-tasks-succeed decision node 1514, a commit outcome 1516, and a rollback outcome 1518. The identity control system 1502 corresponds to the identity control system 402 of FIG. 4 and the identity control system 502 of FIG. 5. The agent execution manager 1504 corresponds to the agent execution manager 414 of FIG. 4 and the agent execution manager 506 of FIG. 5. The credential generation agent 1508 corresponds to the credential generation agent 406 of FIG. 4 and the credential generation agent 508 of FIG. 5. The copy-paste interface automation module 1510 corresponds to the copy-paste interface automation module 408 of FIG. 4 and the copy-paste interface automation module 510 of FIG. 5. The credential storage workflow engine 1512 corresponds to the credential storage workflow engine 412 of FIG. 4 and the credential storage workflow engine 516 of FIG. 5.

The identity control system 1502 emits a credential generation trigger to the agent execution manager 1504 to initiate execution of a credential generation and propagation workflow. The agent execution manager 1504 receives the credential generation trigger from the identity control system 1502, decomposes the credential generation trigger into atomic tasks including credential creation, credential update, credential removal, credential rotation, and credential propagation, and dispatches the atomic tasks to the credential generation agent 1508, the copy-paste interface automation module 1510, and the credential storage workflow engine 1512 for parallel or sequential execution within the atomic transaction boundary 1506.

The atomic transaction boundary 1506 represents a transactional scope that encompasses the credential generation agent 1508, the copy-paste interface automation module 1510, and the credential storage workflow engine 1512 during execution of the credential generation and propagation workflow. The atomic transaction boundary 1506 is implemented as a logical scope maintained by the agent execution manager 1504, with each constituent module reporting an outcome status of success or failure to the agent execution manager 1504 upon completion of the atomic task assigned to the constituent module. The credential generation agent 1508 reports the outcome status of success upon successful identification of credential interface elements and successful elicitation of a newly-created credential at the producer application, the copy-paste interface automation module 1510 reports the outcome status of success upon successful extraction of the newly-created credential from a graphical user interface of the producer application and successful injection of the newly-created credential into an existing graphical user interface of the consumer application, and the credential storage workflow engine 1512 reports the outcome status of success upon successful injection of the newly-created credential into the credential vault or successful direct embedding of the newly-created credential into the existing graphical user interface of the consumer application. The atomic transaction boundary 1506 may be implemented through two-phase commit protocols, saga patterns, or compensating transactions across the constituent modules.

The all-tasks-succeed decision node 1514 evaluates the outcome statuses reported by the credential generation agent 1508, the copy-paste interface automation module 1510, and the credential storage workflow engine 1512. The all-tasks-succeed decision node 1514 takes a yes branch upon receipt of the outcome status of success from each of the credential generation agent 1508, the copy-paste interface automation module 1510, and the credential storage workflow engine 1512, and takes a no branch upon receipt of the outcome status of failure from any of the credential generation agent 1508, the copy-paste interface automation module 1510, and the credential storage workflow engine 1512. The yes branch leads to the commit outcome 1516 and the no branch leads to the rollback outcome 1518.

The commit outcome 1516 represents finalization of the credential generation and propagation workflow following collective success of the constituent modules. The commit outcome 1516 includes persistence of the newly-created credential within the credential vault, persistence of the newly-created credential within the existing graphical user interface of the consumer application, generation of a tamper-evident audit record of the workflow, and dispatch of asynchronous alerts to subscribing recipients indicating successful completion of the workflow. The rollback outcome 1518 represents reversal of partial state produced by the constituent modules following failure of any constituent module, to reduce or avoid orphaned credentials and inconsistent states across the producer application, the consumer application, and the credential vault. The rollback outcome 1518 includes invalidation of the newly-created credential at the producer application through invocation of a credential revocation operation, removal of the newly-created credential from the credential vault, removal of the newly-created credential from the existing graphical user interface of the consumer application, generation of a tamper-evident audit record of the failure event, and dispatch of asynchronous alerts to subscribing recipients indicating failure of the workflow together with diagnostic information identifying the failed constituent module.

FIG. 15 further depicts the operative flow of the view 1500. The identity control system 1502 emits the credential generation trigger to the agent execution manager 1504, the agent execution manager 1504 decomposes the credential generation trigger into atomic tasks and dispatches the atomic tasks to the credential generation agent 1508, the copy-paste interface automation module 1510, and the credential storage workflow engine 1512 within the atomic transaction boundary 1506, and the credential generation agent 1508, the copy-paste interface automation module 1510, and the credential storage workflow engine 1512 execute the assigned atomic tasks and report outcome statuses to the agent execution manager 1504. The all-tasks-succeed decision node 1514 evaluates the outcome statuses, with the yes branch routing the workflow to the commit outcome 1516 and the no branch routing the workflow to the rollback outcome 1518. The view 1500 thereby provides an atomic transactional control flow that reduces or avoids orphaned credentials and inconsistent states across the producer application, the consumer application, and the credential vault by binding the operations of the credential generation agent 1508, the copy-paste interface automation module 1510, and the credential storage workflow engine 1512 within the atomic transaction boundary 1506 and producing a binary commit or rollback outcome based on collective success or failure of the constituent modules.

### Credential Lifecycle Audit View

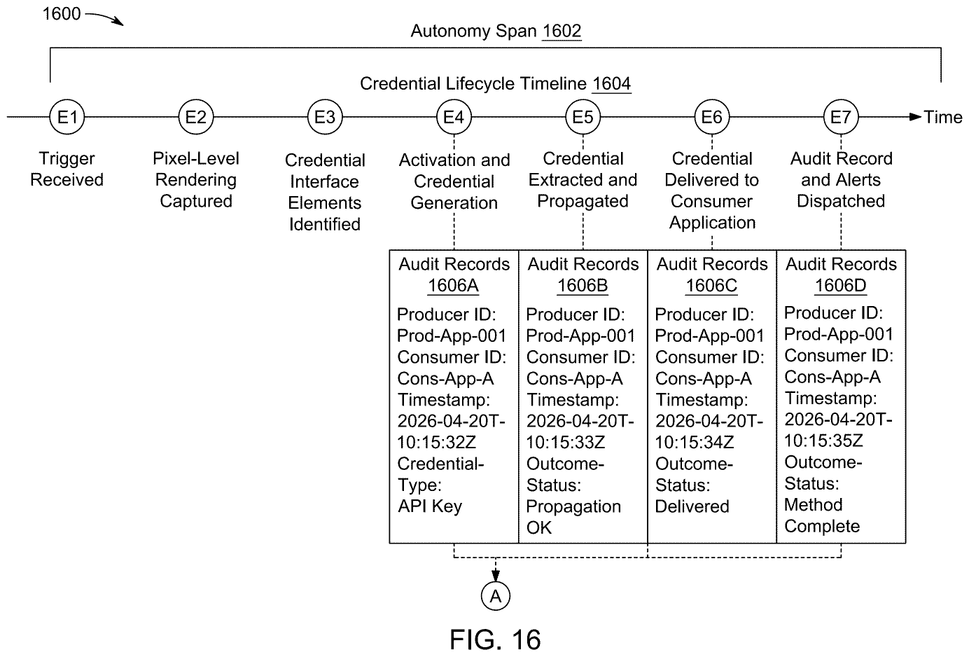

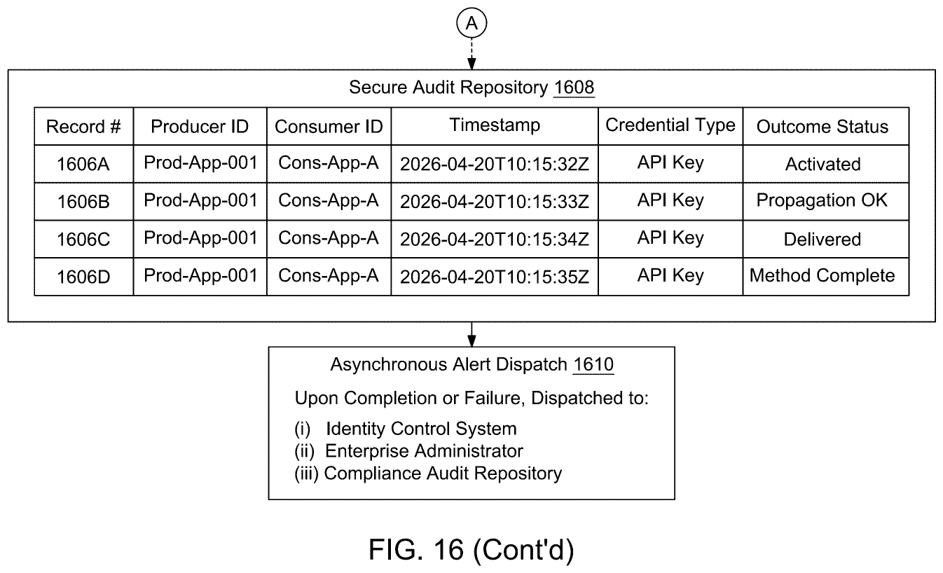

FIG. 16 illustrates a credential lifecycle audit view 1600 depicting an autonomous span of agent operation, a credential lifecycle timeline of events occurring within the autonomous span, audit records generated for the events, a secure audit repository that persists the audit records, and an asynchronous alert dispatch that delivers notifications to subscribing recipients upon completion or failure of the workflow, in accordance with certain embodiments of the present disclosure. The credential lifecycle audit view 1600, also referred to as the view 1600, is depicted across two sheets connected through continuity marker A and depicts the auditable evidentiary trail produced by the agent during execution of a credential generation and propagation workflow.

The view 1600 includes an autonomy span 1602, a credential lifecycle timeline 1604, audit records 1606A, 1606B, 1606C, and 1606D, a secure audit repository 1608, and an asynchronous alert dispatch 1610. The autonomy span 1602 represents a temporal interval during which the agent operates autonomously following receipt of a credential generation trigger and prior to dispatch of the asynchronous alerts at the conclusion of the workflow. The credential lifecycle timeline 1604 represents a timeline along which discrete events of the credential generation and propagation workflow are anchored at successive timestamps.

The credential lifecycle timeline 1604 includes a sequence of events E1 through E7. Event E1 represents receipt of the credential generation trigger by the agent from the identity control system. Event E2 represents capture of a pixel-level rendering of a graphical user interface of a producer application by the credential generation agent. Event E3 represents identification of credential interface elements rendered within the pixel-level rendering through application of a trained autoencoder. Event E4 represents activation of the identified credential interface elements at the producer application and generation of a newly-created credential by the producer application following the activation. Event E5 represents extraction of the newly-created credential from the graphical user interface of the producer application and propagation of the newly-created credential toward an existing graphical user interface of a consumer application. Event E6 represents delivery of the newly-created credential to the consumer application through injection into the existing graphical user interface or through retrieval from a credential vault. Event E7 represents generation of a final audit record and dispatch of the asynchronous alerts to subscribing recipients at the conclusion of the workflow.

The audit records 1606A, 1606B, 1606C, and 1606D are generated by the security and access mediator of FIG. 4 and FIG. 5 in correspondence with events E4, E5, E6, and E7, respectively, and capture tamper-evident evidentiary records of the operative steps performed by the agent within the autonomy span 1602. The audit record 1606A is generated upon completion of event E4 and includes a producer identifier of “Prod-App-001,” a consumer identifier of “Cons-App-A,” a timestamp of “2026-04-20T10: 15:32Z,” a credential type of “API Key,” and an outcome status of “Activated.” The audit record 1606B is generated upon completion of event E5 and includes a producer identifier of “Prod-App-001,” a consumer identifier of “Cons-App-A,” a timestamp of “2026-04-20T10: 15:33Z,” a credential type of “API Key,” and an outcome status of “Propagation OK.” The audit record 1606C is generated upon completion of event E6 and includes a producer identifier of “Prod-App-001,” a consumer identifier of “Cons-App-A,” a timestamp of “2026-04-20T10: 15:34Z,” a credential type of “API Key,” and an outcome status of “Delivered.” The audit record 1606D is generated upon completion of event E7 and includes a producer identifier of “Prod-App-001,” a consumer identifier of “Cons-App-A,” a timestamp of “2026-04-20T10: 15:35Z,” a credential type of “API Key,” and an outcome status of “Method Complete.” The exemplary identifiers, timestamps, credential types, and outcome statuses populated within the audit records 1606A, 1606B, 1606C, and 1606D are illustrative values and do not limit the values that may be populated within audit records during operation of the workflow.

The secure audit repository 1608 is a tamper-evident persistent storage facility that receives the audit records 1606A, 1606B, 1606C, and 1606D from the security and access mediator of FIG. 4 and FIG. 5 and stores the audit records in a tabular schema. The tabular schema includes a record number field, a producer identifier field, a consumer identifier field, a timestamp field, a credential type field, and an outcome status field. The secure audit repository 1608 may be implemented as an append-only ledger, a write-once-read-many storage medium, a cryptographically chained log file, a distributed ledger anchored to an immutable timestamping service, or a relational database augmented with cryptographic integrity controls. A representative table of the secure audit repository 1608 with the four exemplary audit records is provided in the specification.

The asynchronous alert dispatch 1610 is configured to dispatch notifications upon completion or failure of the workflow to a plurality of subscribing recipients. The subscribing recipients include the identity control system as a first recipient, an enterprise administrator as a second recipient, and a compliance audit repository as a third recipient. The asynchronous alert dispatch 1610 corresponds to the notification and alert manager 418 of FIG. 4 and the notification and alert manager 520 of FIG. 5 and may deliver the notifications through electronic mail, instant messaging platforms, webhook callbacks to upstream orchestration systems, or syslog feeds to enterprise monitoring infrastructure.

FIG. 16 further depicts the operative flow of the view 1600. Within the autonomy span 1602, the agent receives the credential generation trigger at event E1, captures the pixel-level rendering at event E2, identifies the credential interface elements at event E3, activates the credential interface elements and elicits generation of the newly-created credential at event E4, extracts and propagates the newly-created credential at event E5, and delivers the newly-created credential to the consumer application at event E6. The audit records 1606A, 1606B, 1606C, and 1606D are generated upon completion of events E4 through E7, respectively, and are persisted into the secure audit repository 1608 through continuity marker A. At event E7, the asynchronous alert dispatch 1610 transmits the notifications to the identity control system, the enterprise administrator, and the compliance audit repository. The view 1600 thereby provides an end-to-end evidentiary record of the credential generation and propagation workflow performed autonomously by the agent within the autonomy span 1602, with each operative step associated with a corresponding audit record and the sequence terminating in dispatch of the asynchronous alerts to the subscribing recipients.

### Computing System

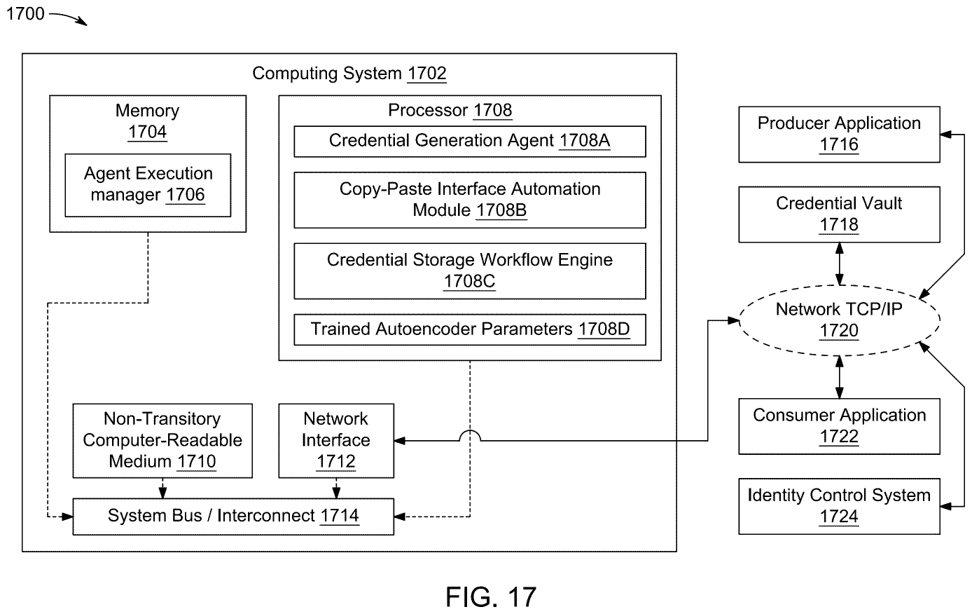

FIG. 17 illustrates a hardware apparatus 1700 of a computing system on which the agent of the foregoing figures is implemented, in accordance with certain embodiments of the present disclosure. The hardware apparatus view 1700, also referred to as the apparatus 1700, depicts the hardware-and-instructions embodiment of the agent that performs the credential generation and propagation workflow described in connection with FIG. 4 through FIG. 13. The apparatus 1700 includes a computing system 1702 communicatively coupled to a producer application 1716, a credential vault 1718, a consumer application 1722, and an identity control system 1724 over a network 1720 implementing a Transmission Control Protocol/Internet Protocol (TCP/IP) suite.

The computing system 1702 includes a memory 1704, an agent execution manager 1706, a processor 1708, a non-transitory computer-readable medium 1710, a network interface 1712, and a system bus or interconnect 1714. The processor 1708 hosts a plurality of instruction-implemented submodules including a credential generation agent 1708A, a copy-paste interface automation module 1708B, a credential storage workflow engine 1708C, and trained autoencoder parameters 1708D. The system bus or interconnect 1714 communicatively couples the memory 1704, the processor 1708, the non-transitory computer-readable medium 1710, and the network interface 1712 within the computing system 1702.

The memory 1704 is configured to store program instructions and runtime state of the agent during execution of the credential generation and propagation workflow. The memory 1704 may be implemented using a combination of volatile and non-volatile storage, including random access memory (RAM), static random access memory (SRAM), dynamic random access memory (DRAM), read-only memory (ROM), electrically erasable programmable read-only memory (EEPROM), flash memory, and on-chip caches. The memory 1704 holds the agent execution manager 1706, with the agent execution manager 1706 corresponding to the agent execution manager 414 of FIG. 4 and the agent execution manager 506 of FIG. 5. The agent execution manager 1706 is realized as program instructions stored within the memory 1704 and executed by the processor 1708, or as a dedicated coprocessor element of the computing system 1702, and is configured to coordinate the orchestration functions described in connection with FIG. 5 and FIG. 15.

The processor 1708 includes processing circuitry that executes the program instructions of the agent. The processing circuitry of the processor 1708 includes a central processing unit (CPU), a graphics processing unit (GPU), a tensor processing unit (TPU), a microprocessor, a digital signal processor (DSP), a field-programmable gate array (FPGA), an application-specific integrated circuit (ASIC), a system-on-chip (SoC) architecture, or any combination of the foregoing. The processor 1708 hosts the credential generation agent 1708A, the copy-paste interface automation module 1708B, the credential storage workflow engine 1708C, and the trained autoencoder parameters 1708D. The credential generation agent 1708A corresponds to the credential generation agent 406 of FIG. 4 and the credential generation agent 508 of FIG. 5 and is configured to perform visual identification and activation of credential interface elements rendered within a graphical user interface of the producer application 1716. The copy-paste interface automation module 1708B corresponds to the copy-paste interface automation module 408 of FIG. 4 and the copy-paste interface automation module 510 of FIG. 5 and is configured to extract a newly-created credential from the graphical user interface of the producer application 1716 and inject the newly-created credential into an existing graphical user interface of the consumer application 1722. The credential storage workflow engine 1708C corresponds to the credential storage workflow engine 412 of FIG. 4 and the credential storage workflow engine 516 of FIG. 5 and is configured to manage secure storage of the newly-created credential within the credential vault 1718. The trained autoencoder parameters 1708D correspond to model weights and configuration parameters that govern operation of the trained autoencoder of the credential generation agent 1708A, and are loaded by the processor 1708 from the non-transitory computer-readable medium 1710 during initialization of the agent.

The non-transitory computer-readable medium 1710 stores the program instructions which, when executed by the processor 1708, cause the computing system 1702 to perform the credential generation and propagation workflow described in connection with FIG. 4 through FIG. 13. The non-transitory computer-readable medium 1710 may be implemented using a hard-disk drive (HDD), a solid-state drive (SSD), an optical disk, a flash memory device, magnetic tape, or any combination of the foregoing. The network interface 1712 enables communication between the computing system 1702 and the producer application 1716, the credential vault 1718, the consumer application 1722, and the identity control system 1724 over the network 1720. The network interface 1712 supports wired connections including Ethernet, fiber-optic interfaces, digital subscriber line (DSL), and coaxial cable, and wireless connections including Wi-Fi (IEEE 802.11), BLUETOOTH, ZigBee, satellite communications, and cellular standards including 4G, LTE, and 5G. The system bus or interconnect 1714 provides a high-bandwidth communication fabric within the computing system 1702 and is implemented using a peripheral component interconnect express (PCIe) bus, a compute express link (CXL) interconnect, an advanced extensible interface (AXI) bus, a coherent interconnect, or another high-bandwidth communication fabric.

The producer application 1716 corresponds to the producer application 422 of FIG. 4 and represents an application that supports generation of new credentials through interaction with the graphical user interface of the producer application 1716. The credential vault 1718 corresponds to the credential vault 420 of FIG. 4 and the credential vault 1304 of FIG. 13 and represents the centralized secure storage repository for enterprise credentials. The consumer application 1722 corresponds to the consumer application 426 of FIG. 4 and represents a target system that consumes the newly-created credential through the existing graphical user interface of the consumer application 1722 or through retrieval from the credential vault 1718. The identity control system 1724 corresponds to the identity control system 402 of FIG. 4 and the identity control system 502 of FIG. 5 and represents the policy orchestration engine that emits credential generation triggers to the agent. The network 1720 implementing the TCP/IP suite communicatively couples the computing system 1702 with the producer application 1716, the credential vault 1718, the consumer application 1722, and the identity control system 1724, and may include any combination of wired and wireless network technologies including local area networks (LAN), wide area networks (WAN), metropolitan area networks (MAN), virtual private networks (VPN), and the Internet.

FIG. 17 further depicts the operative flow of the apparatus 1700. The processor 1708 loads the program instructions from the non-transitory computer-readable medium 1710 into the memory 1704 through the system bus or interconnect 1714, the processor 1708 executes the program instructions of the credential generation agent 1708A, the copy-paste interface automation module 1708B, the credential storage workflow engine 1708C, and the agent execution manager 1706, and the processor 1708 loads the trained autoencoder parameters 1708D for application to a pixel-level rendering of the graphical user interface of the producer application 1716. The network interface 1712 receives the credential generation trigger from the identity control system 1724 over the network 1720, the credential generation agent 1708A captures the pixel-level rendering of the graphical user interface of the producer application 1716, the copy-paste interface automation module 1708B injects the newly-created credential into the existing graphical user interface of the consumer application 1722, and the credential storage workflow engine 1708C stores the newly-created credential in the credential vault 1718 over the network 1720. The apparatus 1700 thereby provides a hardware-and-instructions embodiment of the agent on which the credential generation and propagation workflow described in connection with FIG. 4 through FIG. 20 is implemented.

### Trigger Ingestion Sub-Architecture

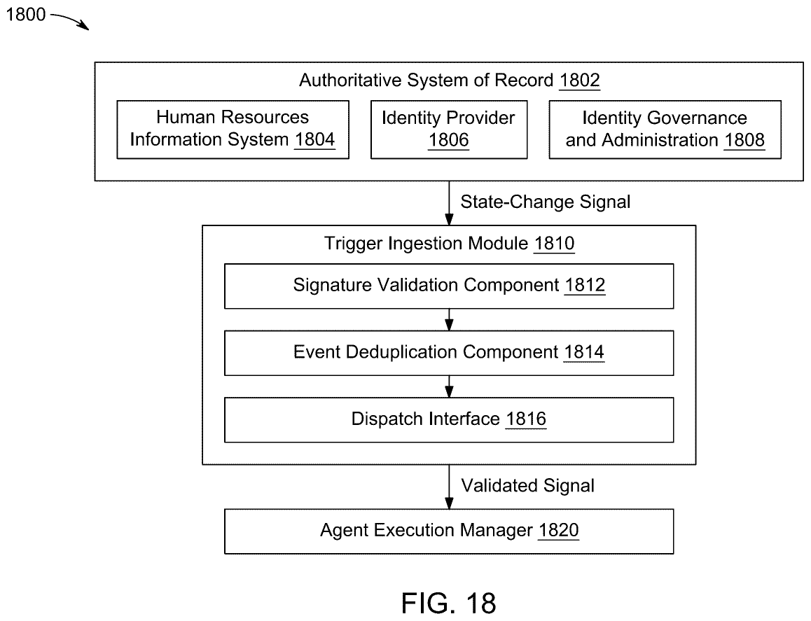

FIG. 18 illustrates a trigger ingestion sub-architecture 1800 for receiving and processing identity lifecycle state-change signals, in accordance with certain embodiments of the present disclosure.

The trigger ingestion sub-architecture 1800, also referred to as the sub-architecture 1800, provides an event-driven initiation layer through which authoritative systems of record initiate downstream execution by an agent execution manager 1820. The trigger ingestion sub-architecture 1800 may operate in cooperation with the identity lifecycle workflows described above and may receive one or more state-change signals that initiate provisioning, modification, deprovisioning, or other identity lifecycle execution at one or more downstream applications.

As illustrated, the trigger ingestion sub-architecture 1800 includes an authoritative system of record 1802, a trigger ingestion module 1810, and the agent execution manager 1820. The authoritative system of record 1802 may include a human resources information system 1804, an identity provider 1806, an identity governance and administration platform 1808, or another enterprise system from which authoritative identity-state changes may be obtained. The human resources information system 1804 may maintain employment status, start date, termination date, department, manager, location, contractor status, partner status, or other human-resources attributes. The identity provider 1806 may maintain authentication state, federation state, directory attributes, group memberships, or application assignments. The identity governance and administration platform 1808 may maintain access policies, certification results, entitlement definitions, access approvals, separation-of-duty constraints, or other governance-related identity records.

The authoritative system of record 1802 may emit a state-change signal indicative of a state change to a user identity. The state-change signal may indicate that a user has joined the enterprise, moved to a different role or department, left the enterprise, received a new entitlement, lost an entitlement, completed an access review, failed an access review, or otherwise experienced a change in identity state. In some examples, the state-change signal may take any suitable form, including, but not limited to, a webhook payload, a published event message, a queue entry, a polled record difference, a directory change notification, a database change-data-capture event, an identity governance task, an access request approval, or the like. The state-change signal may further include a user identifier, event type, source system identifier, event timestamp, prior identity attributes, target identity attributes, policy references, application identifiers, or other metadata associated with the state change.

The trigger ingestion module 1810 may receive the state-change signal and may validate, deduplicate, and dispatch the state-change signal for downstream processing. In some examples, the trigger ingestion module 1810 may include a signature validation component 1812, an event deduplication component 1814, and a dispatch interface 1816.

The signature validation component 1812 may be configured to validate authenticity, integrity, and source authorization of the state-change signal. In some examples, the signature validation component 1812 may verify any suitable cryptographic credential associated with the state-change signal, including, but not limited to, a hash-based message authentication code, a mutual transport layer security credential, an OAuth token, a public-key signature, a signed webhook secret, a certificate chain, or the like. Where the state-change signal fails validation, the trigger ingestion module 1810 may reject the state-change signal, store an audit record of the rejection, emit an alert, or request retransmission from the authoritative system of record 1802.

The event deduplication component 1814 may be configured to determine whether the state-change signal has previously been processed. In some examples, the event deduplication component 1814 may compare an event identifier, correlation identifier, timestamp, user identifier, source system identifier, or content hash of the received state-change signal against a persisted record of previously processed state-change signals. Where the event deduplication component 1814 determines that the state-change signal is duplicative, the trigger ingestion module 1810 may suppress downstream processing, update an audit record, or return an acknowledgment to the authoritative system of record 1802. Where the event deduplication component 1814 determines that the state-change signal has not previously been processed, the trigger ingestion module 1810 may mark the state-change signal as eligible for dispatch.

The dispatch interface 1816 may be configured to route a validated signal to the agent execution manager 1820. The validated signal may convey the contents of the state-change signal together with any metadata produced by the signature validation component 1812 and the event deduplication component 1814. In some examples, the dispatch interface 1816 may normalize event formats received from different authoritative systems of record 1802 into a common lifecycle event schema.

The agent execution manager 1820 may receive the validated signal and may initiate one or more identity lifecycle workflows responsive to the validated signal. In some examples, the agent execution manager 1820 may classify the validated signal as a joiner event, mover event, leaver event, credential event, entitlement event, group membership event, or other lifecycle event, decompose the validated signal into one or more atomic identity lifecycle tasks, invoke a policy interpretation pipeline, dispatch the atomic identity lifecycle tasks to one or more downstream agents, monitor execution of the atomic identity lifecycle tasks, and generate completion or failure notifications. The agent execution manager 1820 may operate in cooperation with the workflows described above in connection with FIG. 10 through FIG. 12 so that the validated signal ultimately causes graphical user interface interactions to be performed at one or more downstream applications.

The trigger ingestion sub-architecture 1800 thereby provides an event-driven entry point for identity lifecycle automation. Rather than requiring an administrator to manually initiate each downstream provisioning, role modification, or deprovisioning operation, the trigger ingestion sub-architecture 1800 enables authoritative state changes generated by enterprise systems of record to automatically initiate visual-interface-based execution by the agent execution manager 1820. While the illustrated trigger ingestion sub-architecture 1800 includes a particular arrangement of validation, deduplication, and dispatch operations, the order and number of operations is not limited to the specific arrangement shown, and additional or fewer operations may be utilized. Many variations are possible.

### Policy Interpretation Pipeline

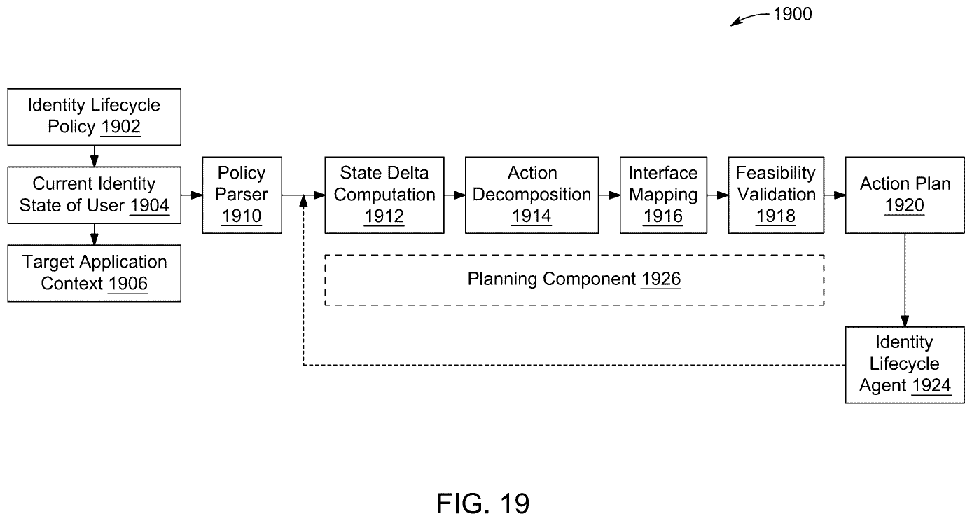

FIG. 19 illustrates a policy interpretation pipeline 1900 for translating identity lifecycle policy into graphical user interface actions, in accordance with certain embodiments of the present disclosure.

The policy interpretation pipeline 1900, also referred to as the pipeline 1900, receives identity-state and policy information, computes a desired change in identity state, decomposes the desired change into executable actions, maps the executable actions to interface elements of a target application, and produces an action plan for execution by an identity lifecycle agent 1924. The policy interpretation pipeline 1900 may correspond to a component of the identity lifecycle agent 1924 or may operate in cooperation with the identity lifecycle agent 1924 to translate identity lifecycle policy into one or more atomic interface activations at a target application.

As illustrated, the policy interpretation pipeline 1900 includes an identity lifecycle policy input 1902, a current identity state of user input 1904, a target application context input 1906, a policy parser 1910, a state delta computation component 1912, an action decomposition component 1914, an interface mapping component 1916, a feasibility validation component 1918, an action plan 1920, the identity lifecycle agent 1924, and a planning component 1926.

The identity lifecycle policy input 1902 may include one or more policies governing the desired identity state of a user. In some examples, the identity lifecycle policy input 1902 may include a role-based access control policy, an attribute-based access control policy, a group membership rule, an entitlement policy, a license-assignment policy, a separation-of-duty policy, a least-privilege policy, a termination policy, an onboarding policy, an access recertification result, or another identity-governance rule. The identity lifecycle policy input 1902 may be expressed as structured data, a declarative policy language, a configuration template, a natural-language instruction, an access request approval, a governance decision, or another policy representation.

The current identity state of user input 1904 may include a representation of the present state of the user identity prior to application of the identity lifecycle policy. In some examples, the current identity state of user input 1904 may include a current role, a current department, a current manager, a current location, current application access, current group memberships, current licenses, current entitlements, a current account status, a current privileged access scope, or other identity attributes.

The target application context input 1906 may include information about the application or applications to which the identity lifecycle policy is to be applied. In some examples, the target application context input 1906 may include an application identifier, an application type, an interface schema, a known graphical user interface layout, available controls, a user administration path, a navigation sequence, selector values, field labels, accessibility metadata, prior visual observations, or learned interface representations. The target application context input 1906 may further indicate whether the target application is a connected application supporting standardized protocols or a disconnected application requiring graphical user interface automation.

The policy parser 1910 may be configured to parse the identity lifecycle policy input 1902 into one or more parsed policy clauses. The parsed policy clauses may identify a target role, a department, a group, an entitlement, a license, a user status, an access level, an expiration period, an approval condition, or another desired identity attribute. Where the identity lifecycle policy input 1902 includes natural-language or semi-structured content, the policy parser 1910 may use a large language model, a rules engine, an ontology, a template matcher, or another semantic interpretation mechanism to identify operative policy terms.

The state delta computation component 1912 may be configured to compute a state delta between the current identity state of user input 1904 and a target identity state implied by the parsed policy clauses of the policy parser 1910. The state delta identifies one or more differences to be resolved to bring the user identity into compliance with the identity lifecycle policy. For example, where the current identity state indicates that the user is assigned to a sales role and the identity lifecycle policy input 1902 indicates that the user should be assigned to a marketing role, the state delta computation component 1912 may determine that the user role must be changed, one or more sales-related groups must be removed, and one or more marketing-related groups must be added. For a leaver event, the state delta may indicate that a user account must be disabled, sessions terminated, roles removed, licenses reclaimed, and application access revoked. For a joiner event, the state delta may indicate that a user account must be created and initialized with one or more roles, groups, and entitlements.

The action decomposition component 1914 may be configured to decompose the state delta into a sequence of one or more atomic identity lifecycle actions. Each atomic identity lifecycle action may represent a discrete operation to be executed against a graphical user interface of a target application. Atomic identity lifecycle actions may include searching for a user account, opening a user profile, selecting a role selector, choosing a target role value, adding a group membership, removing a group membership, checking or unchecking an entitlement control, opening a status selector, selecting a disabled status, activating a create-user control, activating a deactivate-user control, confirming a dialog, or activating a save, submit, apply, or commit control.

The interface mapping component 1916 may be configured to map the atomic identity lifecycle actions to interface elements of the target application. In some examples, the interface mapping component 1916 may map an atomic identity lifecycle action to a button, a drop-down selector, a checkbox, a radio button, a text input field, a search field, a navigation tab, a menu item, a toggle, a dialog control, a table row, a hyperlink, or another graphical user interface element. The interface mapping component 1916 may use visual feature representations produced by a trained machine learning model, semantic labels extracted from the graphical user interface, optical character recognition output, accessibility metadata, historical interaction traces, known application templates, or a combination thereof.

The feasibility validation component 1918 may be configured to validate that the mapped interface elements are present, accessible, and operable in the target application context. In some examples, the feasibility validation component 1918 may verify that a mapped interface element is visible, enabled, reachable through a current navigation state, consistent with expected labels, consistent with an expected control type, and authorized for activation under an applicable policy. Where the feasibility validation component 1918 determines that a mapped interface element is unavailable or infeasible, the policy interpretation pipeline 1900 may cause re-planning of the affected portion of the action sequence, request human review, select an alternative interface path, or mark the target application as failed for purposes of a cross-application transaction.

The action plan 1920 may represent the output of the policy interpretation pipeline 1900. In some examples, the action plan 1920 may include an ordered sequence of action records, each action record identifying an action verb, a target interface element class, a target value, a navigation context, a validation condition, a retry rule, and a post-action verification condition. The action plan 1920 may further include rollback instructions, compensating actions, audit metadata, application identifiers, timing constraints, or policy identifiers. The action plan 1920 may be provided to the identity lifecycle agent 1924 for execution against the graphical user interface of the target application.

The identity lifecycle agent 1924 may execute the action plan 1920 by navigating the graphical user interface of the target application, identifying the mapped interface elements, activating the mapped interface elements, entering values where appropriate, and verifying post-activation state. The identity lifecycle agent 1924 may execute the action plan 1920 using pointer events, keyboard events, synthetic touch events, accessibility actions, clipboard operations, screen capture, optical character recognition, trained visual feature extraction, semantic reasoning, or any combination thereof.

The planning component 1926 may implement or coordinate one or more stages of the pipeline 1900, including the policy parser 1910, the state delta computation component 1912, the action decomposition component 1914, the interface mapping component 1916, and the feasibility validation component 1918. In some examples, the planning component 1926 may include a large language model, a rules engine, a state machine, a decision tree, a workflow engine, a template library, a policy engine, a retrieval-augmented reasoning system, a graphical user interface model, or a combination thereof.

The policy interpretation pipeline 1900 thereby provides a semantic translation layer between abstract organizational identity policies and concrete graphical user interface actions. The policy interpretation pipeline 1900 may translate an enterprise policy, such as assigning a user to a department, creating a user account for onboarding, modifying a role after a transfer, or revoking access following termination, into one or more concrete graphical user interface interactions at a target application. While certain stages of the policy interpretation pipeline 1900 are illustrated, the order and number of stages is not limited to the specific arrangement shown, and additional or fewer stages may be utilized. Many variations are possible.

### Cross-Application Identity Lifecycle Propagation Architecture

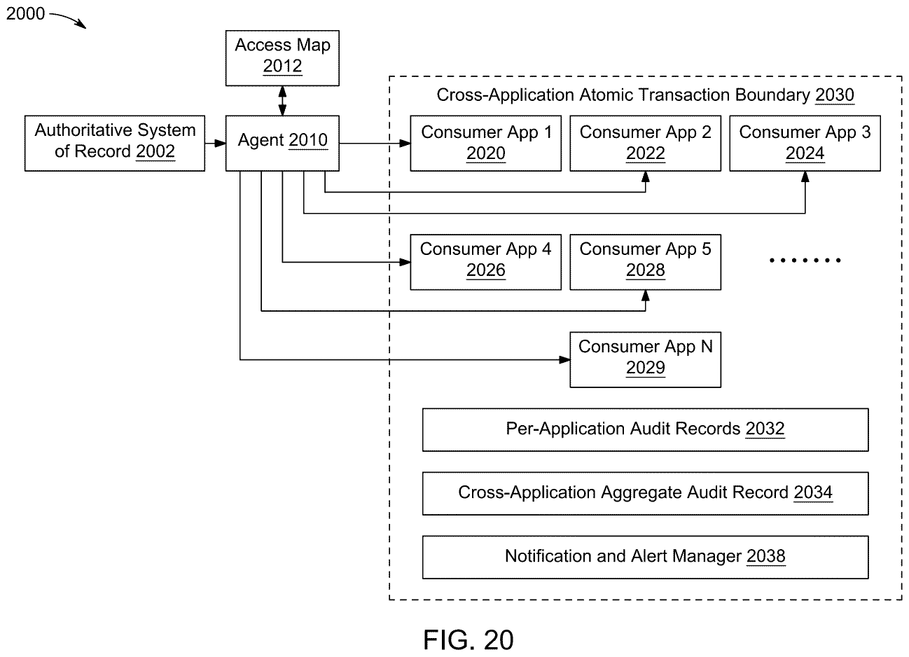

FIG. 20 illustrates a cross-application identity lifecycle propagation architecture 2000, in accordance with certain embodiments of the present disclosure.

The cross-application identity lifecycle propagation architecture 2000, also referred to as the architecture 2000, depicts propagation of a single identity lifecycle event from an authoritative system of record 2002 to a plurality of downstream consumer applications under a cross-application atomic transaction boundary 2030. The architecture 2000 may be used for joiner events, mover events, leaver events, access recertification events, entitlement modification events, credential rotation events, or other lifecycle events that affect more than one application.

As illustrated, the cross-application identity lifecycle propagation architecture 2000 includes the authoritative system of record 2002, an agent 2010, an access map 2012, a plurality of consumer applications including consumer app 1 2020, consumer app 2 2022, consumer app 3 2024, consumer app 4 2026, consumer app 5 2028, and consumer app N 2029, the cross-application atomic transaction boundary 2030, per-application audit records 2032, a cross-application aggregate audit record 2034, and a notification and alert manager 2038. The authoritative system of record 2002 may correspond to the authoritative system of record 1802 described above with reference to FIG. 18. The agent 2010 may correspond to the identity lifecycle agent 1924 described above with reference to FIG. 19 and to one or more of the agent implementations described above with reference to FIG. 10 through FIG. 12.

The authoritative system of record 2002 may emit a state-change signal associated with a user identity. The agent 2010 may receive the state-change signal either directly from the authoritative system of record 2002 or through the trigger ingestion sub-architecture described above with reference to FIG. 18. The agent 2010 may validate the state-change signal, normalize the state-change signal into a common lifecycle event schema, invoke the policy interpretation pipeline described above with reference to FIG. 19, and determine a set of downstream consumer applications to which the lifecycle event is to be propagated.

The access map 2012 may identify applications in which the user holds access, applications to which the user should be provisioned, applications from which the user should be deprovisioned, or applications in which the user's role, group membership, license, or entitlement should be modified. In some examples, the access map 2012 may be generated from identity-provider federation records, directory group memberships, access-governance records, application inventory data, credential-vault entries, audit logs, manual access certifications, application-discovery scans, or graphical user interface searches performed by the agent 2010. In some examples, the access map 2012 may be dynamically computed for each lifecycle event based on a user identifier, an event type, a current identity state, a target identity state, and applicable access policies.

The plurality of consumer applications 2020, 2022, 2024, 2026, 2028, and 2029 represent downstream applications affected by the lifecycle event. The plurality of consumer applications may include connected applications that support standardized identity protocols and disconnected applications that require graphical user interface automation. Examples of consumer applications may include customer relationship management systems, collaboration platforms, enterprise resource planning systems, financial systems, human capital management systems, developer platforms, ticketing systems, data warehouses, security tools, partner portals, on-premises administrative consoles, internally developed applications, and legacy enterprise applications. The number of consumer applications shown is exemplary, and any number of consumer applications may be included.

The cross-application atomic transaction boundary 2030 may represent a logical transaction boundary within which the agent 2010 executes the lifecycle event across the plurality of consumer applications. In some examples, the cross-application atomic transaction boundary 2030 may require that the lifecycle event be committed only if each required application-level action succeeds. Where the agent 2010 successfully completes the required actions across the affected consumer applications, the agent 2010 may commit the cross-application lifecycle event and generate audit records indicating successful completion. Where one or more required actions fail, the agent 2010 may initiate rollback, retry, compensating action, escalation, or partial-failure handling according to a configured policy. In some examples, the compensating action may include re-enabling a user account, restoring a prior role assignment, reassigning a removed group membership, or another action that restores a prior identity state.

In some examples, the agent 2010 may dispatch application-level lifecycle actions to the consumer applications 2020, 2022, 2024, 2026, 2028, and 2029 in parallel. In other examples, the agent 2010 may dispatch the application-level lifecycle actions in sequence. In still other examples, the agent 2010 may use a hybrid dispatch order in which certain consumer applications are processed in parallel while other consumer applications are processed sequentially based on dependency relationships, risk level, application criticality, availability, credential dependency, or policy constraints. For example, in a leaver event, high-risk privileged-access applications may be processed before lower-risk collaboration applications. In a joiner event, identity-provider or directory provisioning may be completed before dependent business applications are provisioned.

When an application-level lifecycle action is performed against a consumer application, the agent 2010 may use the visual-interface automation techniques described above in connection with FIG. 10 through FIG. 12. For example, for a leaver event, the agent 2010 may navigate to a user administration panel of a disconnected application, search for the user, activate a disable or suspend control, confirm the revocation, and verify the resulting disabled state. For a mover event, the agent 2010 may locate the user profile, modify a role or group selector, activate a save or apply control, and verify the modified state. For a joiner event, the agent 2010 may open a create-user interface, populate one or more required fields, activate a create-user control, and verify creation of the account. The same lifecycle event may therefore be propagated across both connected and disconnected applications without requiring a dedicated application-specific connector for each consumer application.

The per-application audit records 2032 may represent audit records generated for individual application-level lifecycle actions. Each per-application audit record may identify the user, the target consumer application, the lifecycle event type, the action performed, a timestamp, a pre-action state, a post-action state, an outcome status, an error condition, a retry count, a rollback status, or an operator intervention status. The per-application audit records 2032 may be generated in tamper-evident form using cryptographic chaining, write-once-read-many storage, append-only logs, hash-linked records, immutable timestamping, or another integrity-preserving mechanism.

The cross-application aggregate audit record 2034 may correlate the per-application audit records 2032 into a single audit record representing the lifecycle event as a whole. In some examples, the cross-application aggregate audit record 2034 may include a correlation identifier, an event identifier, a source system identifier, a user identifier, a lifecycle event type, a list of affected applications, a collective outcome status, a commit or rollback status, a transaction start time, a transaction end time, one or more policy identifiers, or exception information. The cross-application aggregate audit record 2034 may enable an administrator, auditor, compliance system, or security operations system to verify whether the lifecycle event was consistently applied across the affected application portfolio.

The notification and alert manager 2038 may be configured to emit notifications associated with the cross-application lifecycle event. In some examples, the notification and alert manager 2038 may transmit completion notifications, failure notifications, rollback notifications, retry notifications, escalation notifications, or compliance notifications to the authoritative system of record 2002, enterprise administrators, application owners, compliance officers, security operations systems, ticketing systems, identity-governance platforms, or audit repositories. Notifications may be transmitted by electronic mail, a message bus, a webhook callback, a syslog feed, a monitoring integration, a ticket-creation system, a collaboration-platform message, or another enterprise notification channel.

The cross-application identity lifecycle propagation architecture 2000 thereby provides a coordinated execution layer for event-driven identity lifecycle automation across a heterogeneous application portfolio. By combining an authoritative state-change signal, the access map 2012, graphical-user-interface action planning, application-level execution, transaction-level commit or rollback logic, and aggregate audit generation, the architecture 2000 enables consistent identity lifecycle propagation across connected and disconnected applications. While the illustrated architecture 2000 includes a particular arrangement of components, the arrangement is exemplary and other or additional variations may be utilized. Many variations are possible.

### Artificial Intelligence System Implementation

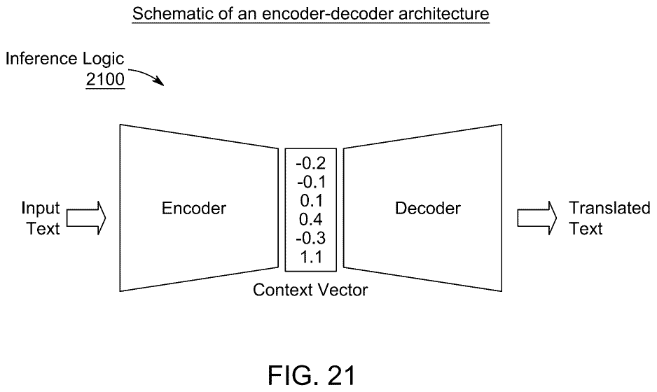

The agent described in conjunction with FIG. 4 through FIG. 20 comprises one or more subsystems based on artificial intelligence. Implementation of the trained machine learning model and the subsystems supporting the perception, classification, and activation operations of the agent is illustrated by FIG. 15 through FIG. 24, which depict, by way of example and not by way of limitation, a plurality of machine learning architectures suitable for use in producing the visual feature representations and classifying the visual feature representations to identify the credential interface elements. The architectures illustrated in FIG. 21 through FIG. 30 may be employed alone or in combination with the trained autoencoder described in conjunction with FIG. 7 to operate on the pixel-level rendering of the graphical user interface of the producer application. Inference logic 2100 referenced throughout FIG. 21 through FIG. 30 designates the computational logic by which the trained machine learning model performs inference on input visual content, and is implemented within the credential generation agent of the agent.

Some implementations of the technology disclosed relate to using a transformer model to provide an artificial intelligence system. In particular, the technology disclosed contemplates a parallel input, parallel output (PIPO) artificial intelligence system based on the transformer architecture. The transformer model relies on a self-attention mechanism to compute a series of context-informed vector-space representations of elements in an input sequence and an output sequence, which are then used to predict distributions over subsequent elements as the model predicts the output sequence element-by-element. This mechanism is straightforward to parallelize, and as each input's representation is also directly informed by all other inputs' representations, the transformer architecture results in an effectively global receptive field across the whole input sequence. This stands in contrast to convolutional architectures, which typically have a more limited receptive field.

In one implementation, the disclosed AI system is a multilayer perceptron (MLP). In another implementation, the disclosed AI system is a feedforward neural network. In yet another implementation, the disclosed AI system is a fully connected neural network. In a further implementation, the disclosed AI system is a fully convolution neural network. In a yet further implementation, the disclosed AI system is a semantic segmentation neural network. In a yet another further implementation, the disclosed AI system is a generative adversarial network (GAN) (e.g., CycleGAN, StyleGAN, pixelRNN, text-2-image, DiscoGAN, IsGAN). In a yet another implementation, the disclosed AI system includes self-attention mechanisms like Transformer, Vision Transformer (ViT), Bidirectional Transformer (BERT), Detection Transformer (DETR), Deformable DETR, UP-DETR, DeiT, Swin, GPT, iGPT, GPT-2, GPT-3, various ChatGPT versions, various LLaMA versions, BERT, SpanBERT, ROBERTa, XLNet, ELECTRA, UniLM, BART, T5, ERNIE (THU), KnowBERT, DeiT-Ti, DeiT-S, DeiT-B, T2T-ViT-14, T2T-ViT-19, T2T-ViT-24, PVT-Small, PVT-Medium, PVT-Large, TNT-S, TNT-B, CPVT-S, CPVT-S-GAP, CPVT-B, Swin-T, Swin-S, Swin-B, Twins-SVT-S, Twins-SVT-B, Twins-SVT-L, Shuffle-T, Shuffle-S, Shuffle-B, XCiT-S12/16, CMT-S, CMT-B, VOLO-D1, VOLO-D2, VOLO-D3, VOLO-D4, MoCo v3, ACT, TSP, Max-DeepLab, VisTR, SETR, Hand-Transformer, HOT-Net, METRO, Image Transformer, Taming transformer, TransGAN, IPT, TTSR, STTN, Masked Transformer, CLIP, DALL-E, Cogview, UniT, ASH, TinyBert, FullyQT, ConvBert, FCOS, Faster R-CNN+FPN, DETR-DC5, TSP-FCOS, TSP-RCNN, ACT+MKDD (L=32), ACT+MKDD (L=16), SMCA, Efficient DETR, UP-DETR, UP-DETR, ViTB/16-FRCNN, ViT-B/16-FRCNN, PVT-Small+RetinaNet, Swin-T+RetinaNet, Swin-T+ATSS, PVT-Small+DETR, TNT-S+DETR, YOLOS-Ti, YOLOS-S, and YOLOS-B.

In one implementation, the disclosed AI system is a convolution neural network (CNN) with a plurality of convolution layers. In another implementation, the disclosed AI system is a recurrent neural network (RNN) such as a long short-term memory network (LSTM), bi-directional LSTM (Bi-LSTM), or a gated recurrent unit (GRU). In yet another implementation, the disclosed AI system includes both a CNN and an RNN.

In yet other implementations, the disclosed AI system can use 1D convolutions, 2D convolutions, 3D convolutions, 4D convolutions, 5D convolutions, dilated or atrous convolutions, transpose convolutions, depthwise separable convolutions, pointwise convolutions, 1×1 convolutions, group convolutions, flattened convolutions, spatial and cross-channel convolutions, shuffled grouped convolutions, spatial separable convolutions, and deconvolutions. The disclosed AI system can use one or more loss functions such as logistic regression/log loss, multi-class cross-entropy/softmax loss, binary cross-entropy loss, mean-squared error loss, L1 loss, L2 loss, smooth L1 loss, and Huber loss. The disclosed AI system can use any parallelism, efficiency, and compression schemes such TFRecords, compressed encoding (e.g., PNG), sharding, parallel calls for map transformation, batching, prefetching, model parallelism, data parallelism, and synchronous/asynchronous stochastic gradient descent (SGD). The disclosed AI system can include upsampling layers, downsampling layers, recurrent connections, gates and gated memory units (like an LSTM or GRU), residual blocks, residual connections, highway connections, skip connections, peephole connections, activation functions (e.g., non-linear transformation functions like rectifying linear unit (ReLU), leaky ReLU, exponential liner unit (ELU), sigmoid and hyperbolic tangent (tanh)), batch normalization layers, regularization layers, dropout, pooling layers (e.g., max or average pooling), global average pooling layers, and attention mechanisms.

The disclosed AI system can be a linear regression model, a logistic regression model, an Elastic Net model, a support vector machine (SVM), a random forest (RF), a decision tree, and a boosted decision tree (e.g., XGBoost), or some other tree-based logic (e.g., metric trees, kd-trees, R-trees, universal B-trees, X-trees, ball trees, locality sensitive hashes, and inverted indexes). The disclosed AI system can be an ensemble of multiple models, in some implementations.

In some implementations, the disclosed AI system can be trained using backpropagation-based gradient update techniques. Example gradient descent techniques that can be used for training the disclosed AI system include stochastic gradient descent, batch gradient descent, and mini-batch gradient descent. Some examples of gradient descent optimization algorithms that can be used to train the disclosed AI system are Momentum, Nesterov accelerated gradient, Adagrad, Adadelta, RMSprop, Adam, AdaMax, Nadam, and AMSGrad.

### Transformer Logic

Machine learning is the use and development of computer systems that can learn and adapt without following explicit instructions, by using algorithms and statistical models to analyze and draw inferences from patterns in data. Some of the state-of-the-art models use Transformers, a more powerful and faster model than neural networks alone. Transformers originate from the field of natural language processing (NLP), but can be used in computer vision and many other fields. Neural networks process input in series and weight relationships by distance in the series. Transformers can process input in parallel and do not necessarily weigh by distance. For example, in natural language processing, neural networks process a sentence from beginning to end with the weights of words close to each other being higher than those further apart. This leaves the end of the sentence very disconnected from the beginning causing an effect called the vanishing gradient problem. Transformers look at each word in parallel and determine weights for the relationships to each of the other words in the sentence. These relationships are called hidden states because they are later condensed for use into one vector called the context vector. Transformers can be used in addition to neural networks. This architecture is described here.

### Encoder-Decoder Architecture

FIG. 21 is a schematic representation of an encoder-decoder architecture. This architecture is often used for NLP and has two main building blocks. The first building block is the encoder that encodes an input into a fixed-size vector. In the system we describe here, the encoder is based on a recurrent neural network (RNN). At each time step, t, a hidden state of time step, t−1, is combined with the input value at time step t to compute the hidden state at timestep t. The hidden state at the last time step, encoded in a context vector, contains relationships encoded at all previous time steps. For NLP, each step corresponds to a word. Then the context vector contains information about the grammar and the sentence structure. The context vector can be considered a low-dimensional representation of the entire input space. For NLP, the input space is a sentence, and a training set consists of many sentences.

The context vector is then passed to the second building block, the decoder. For translation, the decoder has been trained on a second language. Conditioned on the input context vector, the decoder generates an output sequence. At each time step, t, the decoder is fed the hidden state of time step, t−1, and the output generated at time step, t−1. The first hidden state in the decoder is the context vector, generated by the encoder. The context vector is used by the decoder to perform the translation.

The whole model is optimized end-to-end by using backpropagation, a method of training a neural network in which the initial system output is compared to the desired output and the system is adjusted until the difference is minimized. In backpropagation, the encoder is trained to extract the right information from the input sequence, the decoder is trained to capture the grammar and vocabulary of the output language. This results in a fluent model that uses context and generalizes well. When training an encoder-decoder model, the real output sequence is used to train the model to prevent mistakes from stacking. When testing the model, the previously predicted output value is used to predict the next one.

When performing a translation task using the encoder-decoder architecture, all information about the input sequence is forced into one vector, the context vector. Information connecting the beginning of the sentence with the end is lost, the vanishing gradient problem. Also, different parts of the input sequence are important for different parts of the output sequence, information that cannot be learned using only RNNs in an encoder-decoder architecture.

### Attention Mechanism

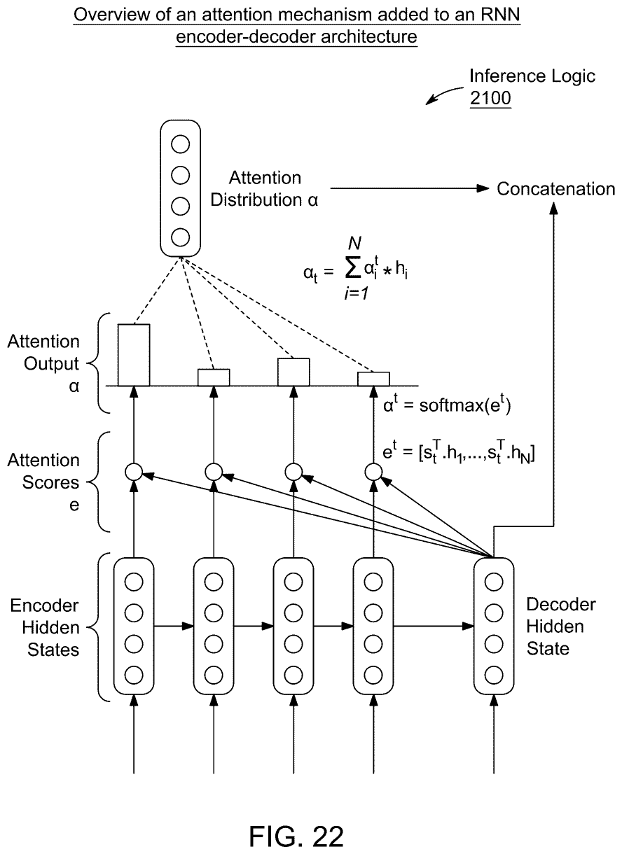

Attention mechanisms distinguish Transformers from other machine learning models. The attention mechanism provides a solution for the vanishing gradient problem. FIG. 22 shows an overview of an attention mechanism added onto an RNN encoder-decoder architecture. At every step, the decoder is given an attention score, e, for each encoder hidden state. In other words, the decoder is given weights for each relationship between words in a sentence. The decoder uses the attention score concatenated with the context vector during decoding. The output of the decoder at time step t is based on all encoder hidden states and the attention outputs. The attention output captures the relevant context for time step t from the original sentence. Thus, words at the end of a sentence may now have a strong relationship with words at the beginning of the sentence. In the sentence “The quick brown fox, upon arriving at the doghouse, jumped over the lazy dog,” fox and dog can be closely related despite being far apart in this complex sentence.

To weight encoder hidden states, a dot product between the decoder hidden state of the current time step, and all encoder hidden states, is calculated. This results in an attention score for every encoder hidden state. The attention scores are higher for those encoder hidden states that are similar to the decoder hidden state of the current time step. Higher values for the dot product indicate the vectors are pointing more closely in the same direction. The attention scores are converted to fractions that sum to one using the SoftMax function.

The SoftMax scores provide an attention distribution. The x-axis of the distribution is position in a sentence. The y-axis is attention weight. The scores show which encoder hidden states are most closely related. The SoftMax scores specify which encoder hidden states are the most relevant for the decoder hidden state of the current time step.

The elements of the attention distribution are used as weights to calculate a weighted sum over the different encoder hidden states. The outcome of the weighted sum is called the attention output. The attention output is used to predict the output, often in combination (concatenation) with the decoder hidden states. Thus, both information about the inputs, as well as the already generated outputs, can be used to predict the next outputs.

By making it possible to focus on specific parts of the input in every decoder step, the attention mechanism solves the vanishing gradient problem. By using attention, information flows more directly to the decoder. It does not pass through many hidden states. Interpreting the attention step can give insights into the data. Attention can be thought of as a soft alignment. The words in the input sequence with a high attention score align with the current target word. Attention describes long-range dependencies better than RNN alone. This enables analysis of longer, more complex sentences.

The attention mechanism can be generalized as: given a set of vector values and a vector query, attention is a technique to compute a weighted sum of the vector values, dependent on the vector query. The vector values are the encoder hidden states, and the vector query is the decoder hidden state at the current time step.

The weighted sum can be considered a selective summary of the information present in the vector values. The vector query determines on which of the vector values to focus. Thus, a fixed-size representation of the vector values can be created, in dependence upon the vector query.

The attention scores can be calculated by the dot product, or by weighing the different values (multiplicative attention).

### Embeddings

For most machine learning models, the input to the model needs to be numerical. The input to a translation model is a sentence, and words are not numerical. multiple methods exist for the conversion of words into numerical vectors. These numerical vectors are called the embeddings of the words. Embeddings can be used to convert any type of symbolic representation into a numerical one.

Embeddings can be created by using one-hot encoding. The one-hot vector representing the symbols has the same length as the total number of possible different symbols. Each position in the one-hot vector corresponds to a specific symbol. For example, when converting colors to a numerical vector, the length of the one-hot vector would be the total number of different colors present in the dataset. For each input, the location corresponding to the color of that value is one, whereas all the other locations are valued at zero. This works well for working with images. For NLP, this becomes problematic, because the number of words in a language is very large. This results in enormous models and the need for a lot of computational power. Furthermore, no specific information is captured with one-hot encoding. From the numerical representation, it is not clear that orange and red are more similar than orange and green. For this reason, other methods exist.

A second way of creating embeddings is by creating feature vectors. Every symbol has its specific vector representation, based on features. With colors, a vector of three elements could be used, where the elements represent the amount of yellow, red, and/or blue needed to create the color. Thus, all colors can be represented by only using a vector of three elements. Also, similar colors have similar representation vectors.

For NLP, embeddings based on context, as opposed to words, are small and can be trained. The reasoning behind this concept is that words with similar meanings occur in similar contexts. Different methods take the context of words into account. Some methods, like GloVe, base their context embedding on co-occurrence statistics from corpora (large texts) such as Wikipedia. Words with similar co-occurrence statistics have similar word embeddings. Other methods use neural networks to train the embeddings. For example, they train their embeddings to predict the word based on the context (Common Bag of Words), and/or to predict the context based on the word (Skip-Gram). Training these contextual embeddings is time intensive. For this reason, pre-trained libraries exist. Other deep learning methods can be used to create embeddings. For example, the latent space of a variational autoencoder (VAE) can be used as the embedding of the input. Another method is to use 1D convolutions to create embeddings. This causes a sparse, high-dimensional input space to be converted to a denser, low-dimensional feature space.

### Self-Attention: Queries (Q), Keys (K), Values (V)

Transformer models are based on the principle of self-attention. Self-attention allows each element of the input sequence to look at all other elements in the input sequence and search for clues that can help it to create a more meaningful encoding. It is a way to look at which other sequence elements are relevant for the current element. The Transformer can grab context from both before and after the currently processed element.

When performing self-attention, three vectors need to be created for each element of the encoder input: the query vector (Q), the key vector (K), and the value vector (V). These vectors are created by performing matrix multiplications between the input embedding vectors using three unique weight matrices.

After this, self-attention scores are calculated. When calculating self-attention scores for a given element, the dot products between the query vector of this element and the key vectors of all other input elements are calculated. To make the model mathematically more stable, these self-attention scores are divided by the root of the size of the vectors. This has the effect of reducing the importance of the scalar thus emphasizing the importance of the direction of the vector. Just as before, these scores are normalized with a SoftMax layer. This attention distribution is then used to calculate a weighted sum of the value vectors, resulting in a vector z for every input element. In the attention principle explained above, the vector to calculate attention scores and to perform the weighted sum was the same, in self-attention two different vectors are created and used. As the self-attention needs to be calculated for all elements (thus a query for every element), one formula can be created to calculate a Z matrix. The rows of this Z matrix are the z vectors for every sequence input element, giving the matrix a size length sequence dimension QKV.

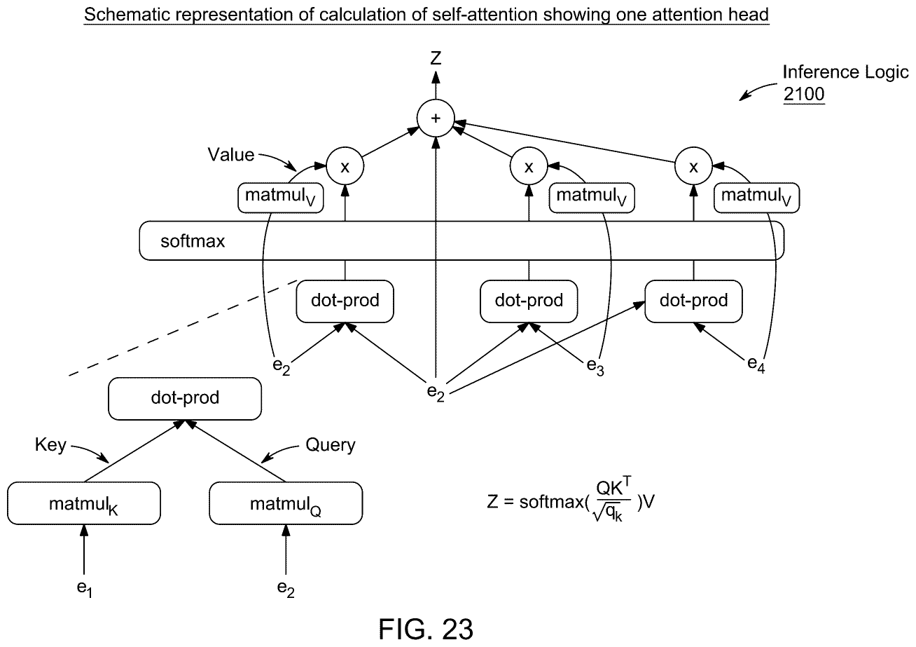

Multi-headed attention is executed in the Transformer. FIG. 23 is a schematic representation of the calculation of self-attention showing one attention head. For every attention head, different weight matrices are trained to calculate Q, K, and V. Every attention head outputs a matrix Z. Different attention heads can capture different types of information. The different Z matrices of the different attention heads are concatenated. This matrix can become large when multiple attention heads are used. To reduce dimensionality, an extra weight matrix W is trained to condense the different attention heads into a matrix with the same size as one Z matrix. This way, the amount of data given to the next step does not enlarge every time self-attention is performed.

When performing self-attention, information about the order of the different elements within the sequence is lost. To address this problem, positional encodings are added to the embedding vectors. Every position has its unique positional encoding vector. These vectors follow a specific pattern, which the Transformer model can learn to recognize. This way, the model can consider distances between the different elements.

As discussed above, in the core of self-attention are three objects: queries (Q), keys (K), and values (V). Each of these objects has an inner semantic meaning of their purpose. One can think of these as analogous to databases. We have a user-defined query of what the user wants to know. Then we have the relations in the database, i.e., the values which are the weights. More advanced database management systems create some apt representation of its relations to retrieve values more efficiently from the relations. This can be achieved by using indexes, which represent information about what is stored in the database. In the context of attention, indexes can be thought of as keys. So instead of running the query against values directly, the query is first executed on the indexes to retrieve where the relevant values or weights are stored. Lastly, these weights are run against the original values to retrieve data that is most relevant to the initial query.

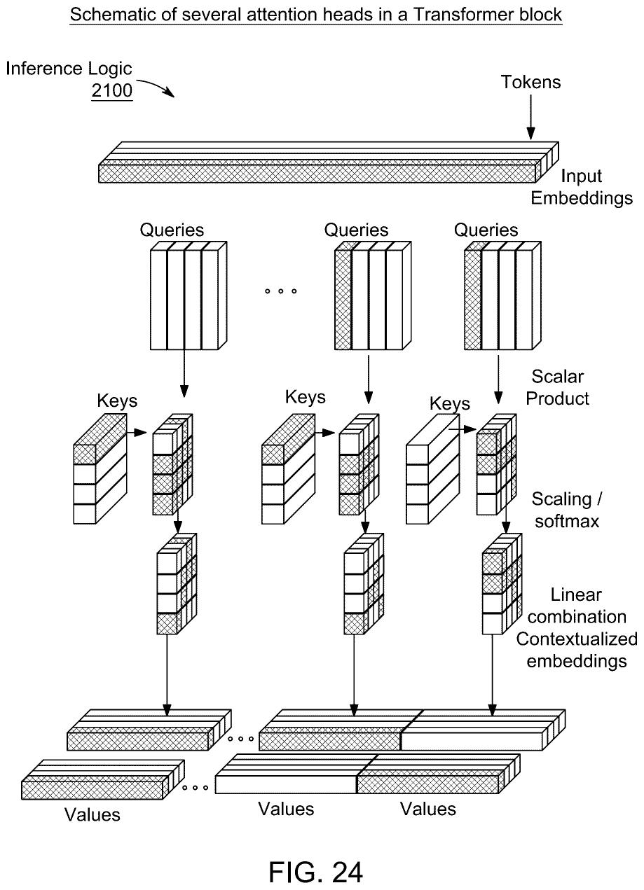

FIG. 24 depicts several attention heads in a Transformer block. We can see that the outputs of queries and keys dot products in different attention heads are differently colored. This depicts the capability of the multi-head attention to focus on different aspects of the input and aggregate the obtained information by multiplying the input with different attention weights.

Examples of attention calculation include scaled dot-product attention and additive attention. There are several reasons why scaled dot-product attention is used in the Transformers. Firstly, the scaled dot-product attention is relatively fast to compute, since its main parts are matrix operations that can be run on modern hardware accelerators. Secondly, it performs similarly well for smaller dimensions of the K matrix, dk, as the additive attention. For larger dk, the scaled dot-product attention performs a bit worse because dot products can cause the vanishing gradient problem. This is compensated via the scaling factor, which is defined as \sqrt{dk}.

As discussed above, the attention function takes as input three objects: key, value, and query. In the context of Transformers, these objects are matrices of shapes (n, d), where n is the number of elements in the input sequence and d is the hidden representation of each element (also called the hidden vector). Attention is then computed as:

$$Attention ( Q , K , V ) = SoftMax ( \frac{{QK}^{T}}{\sqrt{dk}} ) V$$

where Q, K, V are computed as:

X·W_{Q},X·W_{K},X·W_{V}
X is the input matrix and W_{Q}, W_{K}, W_{V} are learned weights to project the input matrix into the representations. The dot products appearing in the attention function are exploited for their geometrical interpretation where higher values of their results mean that the inputs are more similar, i.e., pointing in the geometrical space in the same direction. Since the attention function now works with matrices, the dot product becomes matrix multiplication. The SoftMax function is used to normalize the attention weights into the value of 1 prior to being multiplied by the values matrix. The resulting matrix is used either as input into another layer of attention or becomes the output of the Transformer.

### Multi-Head Attention

Transformers become even more powerful when multi-head attention is used. Queries, keys, and values are computed the same way as above, though they are now projected into h different representations of smaller dimensions using a set of h learned weights. Each representation is passed into a different scaled dot-product attention block called a head. The head then computes its output using the same procedure as described above.

Formally, the multi-head attention is defined as:

$$MultiHeadAttention ( Q , K , V ) = [ {head}_{1} , … , {head}_{h} ] {W}_{0} where$$

$${head}_{i} = Attention ( {QW}_{i}^{Q} , {KW}_{i}^{K} , {VW}_{i}^{V} )$$

The outputs of all heads are concatenated together and projected again using the learned weights matrix W₀ to match the dimensions expected by the next block of heads or the output of the Transformer. Using the multi-head attention instead of the simpler scaled dot-product attention enables Transformers to jointly attend to information from different representation subspaces at different positions.

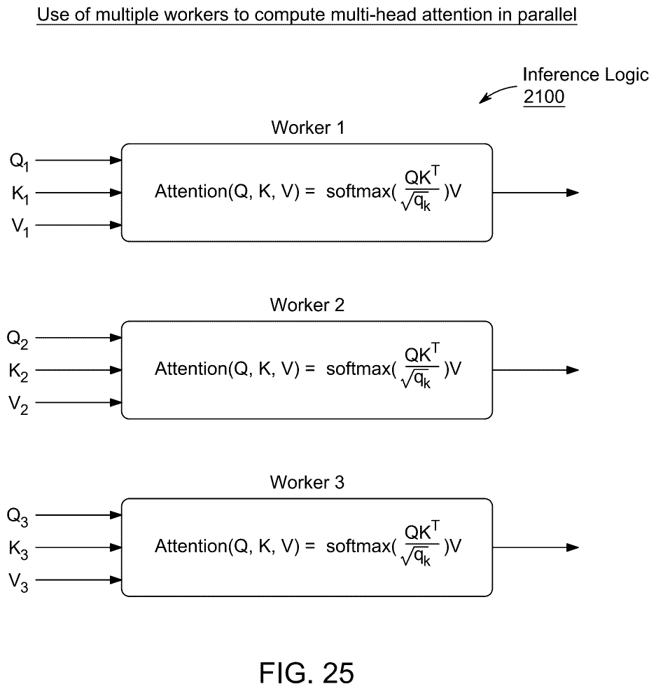

As shown in FIG. 25, one can use multiple workers to compute the multi-head attention in parallel, as the respective heads compute their outputs independently of one another. Parallel processing is one of the advantages of Transformers over RNNs.

Assuming the naive matrix multiplication algorithm which has a complexity of:

a·b·c

For matrices of shape (a, b) and (c, d), to obtain values Q, K, V, we need to compute the operations:

X·W_{Q},X·W_{K},X·WV

The matrix X is of shape (n, d) where n is the number of patches and d is the hidden vector dimension. The weights W_{Q}, W_{K}, W_{V} are all of shape (d, d). Omitting the constant factor 3, the resulting complexity is:

n·d²

We can proceed to the estimation of the complexity of the attention function itself, i.e., of

$$SoftMax ( \frac{{QK}^{T}}{\sqrt{dk}} ) V .$$

The matrices Q and K are both of shape (n, d). The transposition operation does not influence the asymptotic complexity of computing the dot product of matrices of shapes (n, d)·(d, n), therefore its complexity is:

n²·d

Scaling by a constant factor of \sqrt{dk}, where dk is the dimension of the keys vector, as well as applying the SoftMax function, both have the complexity of a·b for a matrix of shape (a, b), hence they do not influence the asymptotic complexity. Lastly the dot product

$$SoftMax ( \frac{{QK}^{T}}{\sqrt{dk}} ) .$$

V is between matrices of shapes (n, n) and (n, d) and so its complexity is:

n²·d

The final asymptotic complexity of scaled dot-product attention is obtained by summing the complexities of computing Q, K, V, and of the following attention function:

n·d²+n²·d.

The asymptotic complexity of multi-head attention is the same since the original input matrix X is projected into h matrices of shapes

$$( n , \frac{d}{h} ) ,$$

where h is the number of heads.

From the point of view of asymptotic complexity, h is constant, therefore we would arrive at the same estimate of asymptotic complexity using a similar approach as for the scaled dot-product attention.

Transformer models often have the encoder-decoder architecture, although this is not necessarily the case. The encoder is built out of different encoder layers which are all constructed in the same way. The positional encodings are added to the embedding vectors. Afterward, self-attention is performed.

### Encoder Block of Transformer

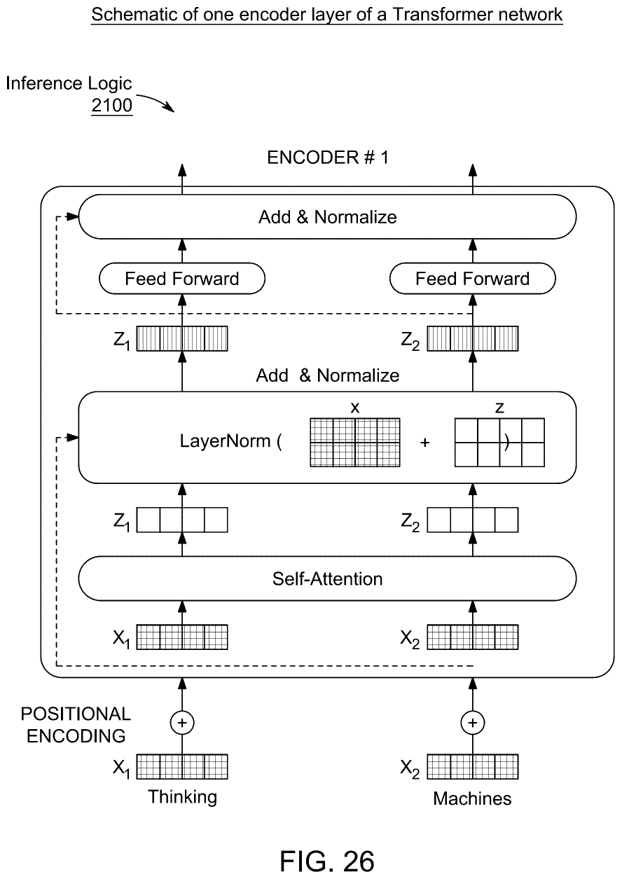

FIG. 26 portrays one encoder layer of a Transformer network. Every self-attention layer is surrounded by a residual connection, summing up the output and input of the self-attention. This sum is normalized, and the normalized vectors are fed to a feed-forward layer. Every z vector is fed separately to this feed-forward layer. The feed-forward layer is wrapped in a residual connection and the outcome is normalized too. Often, numerous encoder layers are piled to form the encoder. The output of the encoder is a fixed-size vector for every element of the input sequence.

Just like the encoder, the decoder is built from different decoder layers. In the decoder, a modified version of self-attention takes place. The query vector is only compared to the keys of previous output sequence elements. The elements further in the sequence are not known yet, as they still must be predicted. No information about these output elements may be used.

### Encoder-Decoder Blocks of Transformer

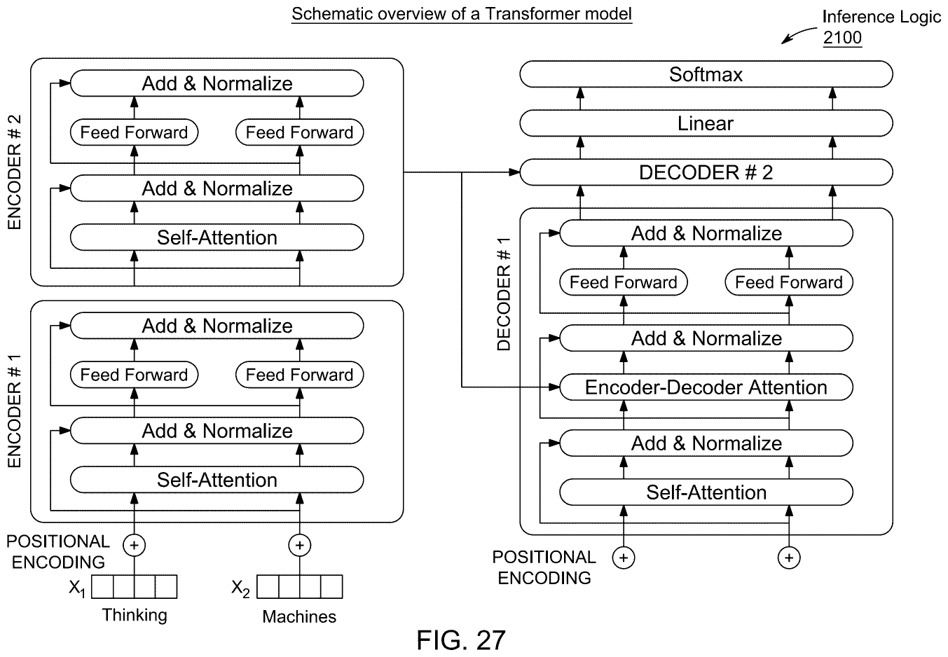

FIG. 27 shows a schematic overview of a Transformer model. Next to a self-attention layer, a layer of encoder-decoder attention is present in the decoder, in which the decoder can examine the last Z vectors of the encoder, providing fluent information transmission. The ultimate decoder layer is a feed-forward layer. All layers are packed in a residual connection. This allows the decoder to examine all previously predicted outputs and all encoded input vectors to predict the next output. Thus, information from the encoder is provided to the decoder, which could improve the predictive capacity. The output vectors of the last decoder layer need to be processed to form the output of the entire system. This is done by a combination of a feed-forward layer and a SoftMax function. The output corresponding to the highest probability is the predicted output value for a subject time step.

For some tasks other than translation, only an encoder is needed. This is true for both document classification and name entity recognition. In these cases, the encoded input vectors are the input of the feed-forward layer and the SoftMax layer. Transformer models have been extensively applied in different NLP fields, such as translation, document summarization, speech recognition, and named entity recognition. These models have applications in the field of biology as well for predicting protein structure and function and labeling DNA sequences.

### Vision Transformer

There are extensive applications of transformers in vision including popular recognition tasks (e.g., image classification, object detection, action recognition, and segmentation), generative modeling, multi-modal tasks (e.g., visual-question answering, visual reasoning, and visual grounding), video processing (e.g., activity recognition, video forecasting), low-level vision (e.g., image super-resolution, image enhancement, and colorization) and 3D analysis (e.g., point cloud classification and segmentation).

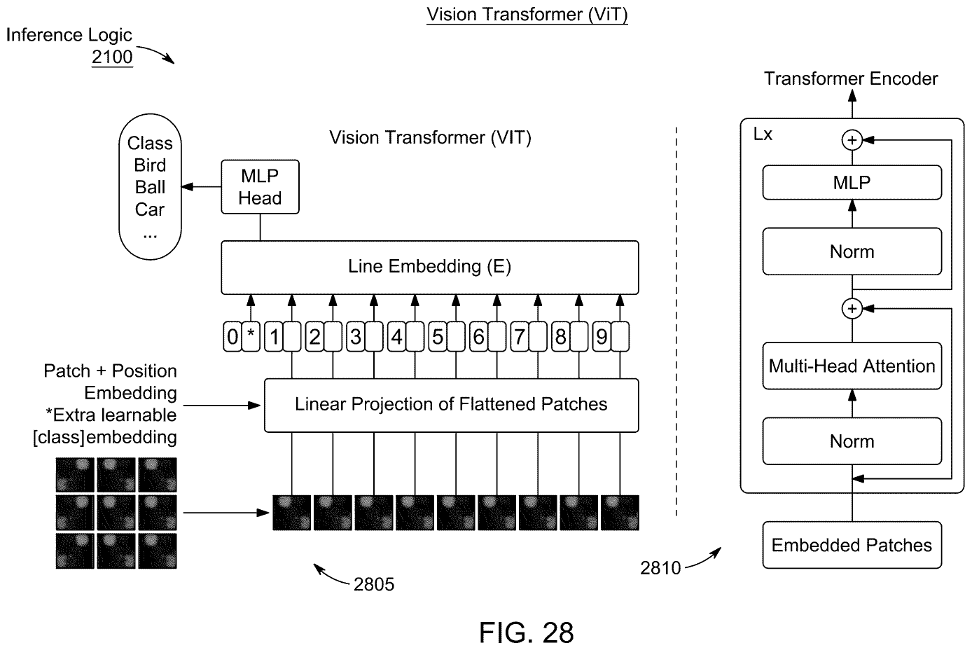

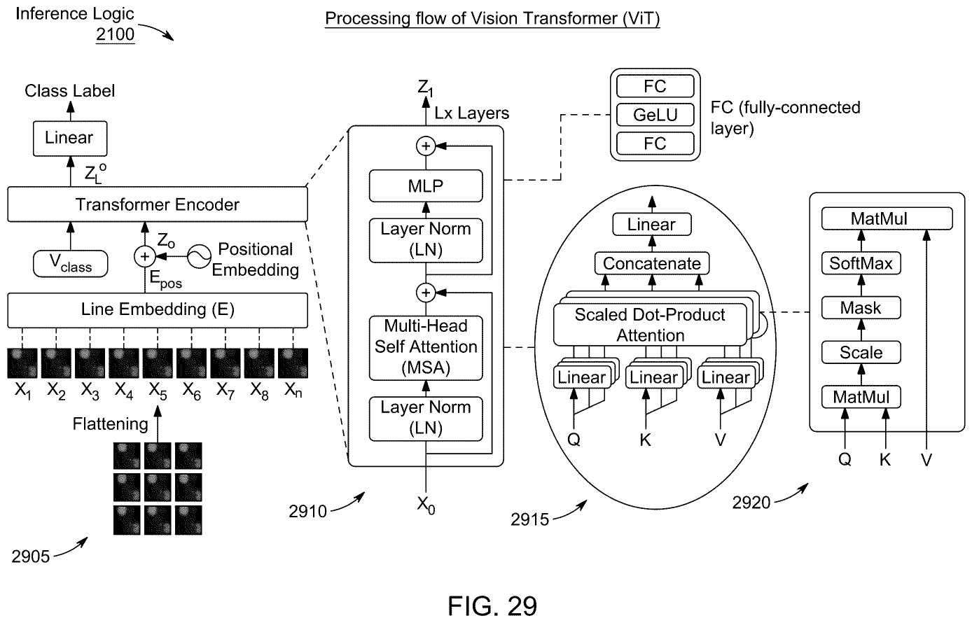

Transformers were originally developed for NLP and worked with sequences of words. In image classification, we often have a single input image in which the pixels are in a sequence. To reduce the computation required, Vision Transformers (ViTs) cut the input image into a set of fixed-sized patches of pixels. The patches are often 16×16 pixels. They are treated much like words in NLP Transformers. ViTs are depicted in FIG. 28 (2805, 2810), FIG. 29 (2905, 2910, 2915, 2920). Unfortunately, important positional information is lost because image sets are position-invariant. This problem is solved by adding a learned positional encoding into the image patches.

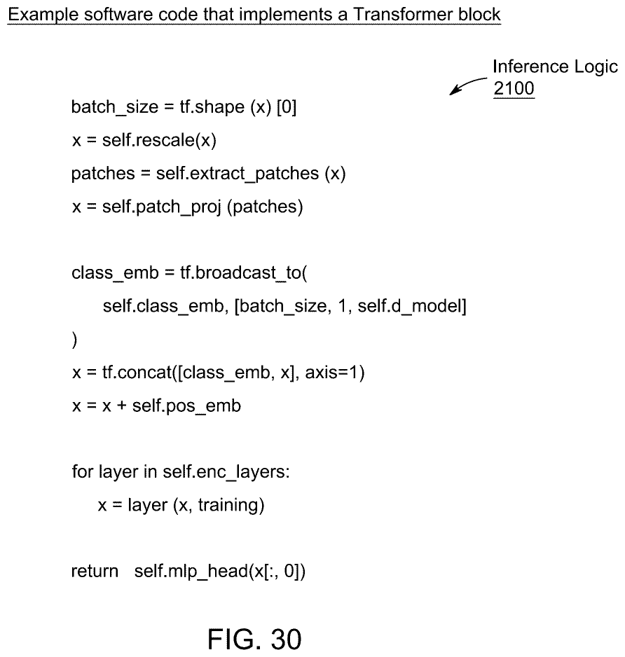

The computations of the ViT architecture can be summarized as follows. The first layer of a ViT extracts a fixed number of patches from an input image (2905). The patches are then projected to linear embeddings. A special class token vector is added to the sequence of embedding vectors to include all representative information of all tokens through the multi-layer encoding procedure. The class vector is unique to each image. Vectors containing positional information are combined with the embeddings and the class token. The sequence of embedding vectors is passed into the Transformer blocks. The class token vector is extracted from the output of the last Transformer block and is passed into a multilayer perceptron (MLP) head whose output is the final classification. The perceptron takes the normalized input and places the output in categories. It classifies the images. This procedure directly translates into the Python Keras code shown in FIG. 30.

When the input image is split into patches, a fixed patch size is specified before instantiating a ViT. Given the quadratic complexity of attention, patch size has a large effect on the length of training and inference time. A single Transformer block comprises several layers. The first layer implements Layer Normalization, followed by the multi-head attention that is configured for the performance of ViTs. In the depiction of a Transformer block in 2810, we can see two arrows. These are residual skip connections. Including skip connection data can simplify the output and improve the results. The output of the multi-head attention is followed again by Layer Normalization. And finally, the output layer is an MLP (Multi-Layer Perceptron) with the GELU (Gaussian Error Linear Unit) activation function.

ViTs can be pretrained and fine-tuned. Pretraining is generally done on a large dataset. Fine-tuning is done on a domain specific dataset.

Domain-specific architectures, like convolutional neural networks (CNNs) or long short-term memory networks (LSTMs), have been derived from the usual architecture of MLPs and suffer from so-called inductive biases that predispose the networks towards a certain output. ViTs stepped in the opposite direction of CNNs and LSTMs and became more general architectures by eliminating inductive biases. A ViT can be seen as a generalization of MLPs because MLPs, after being trained, do not change their weights for different inputs. On the other hand, ViTs compute their attention weights at runtime based on the particular input.

### Computer System

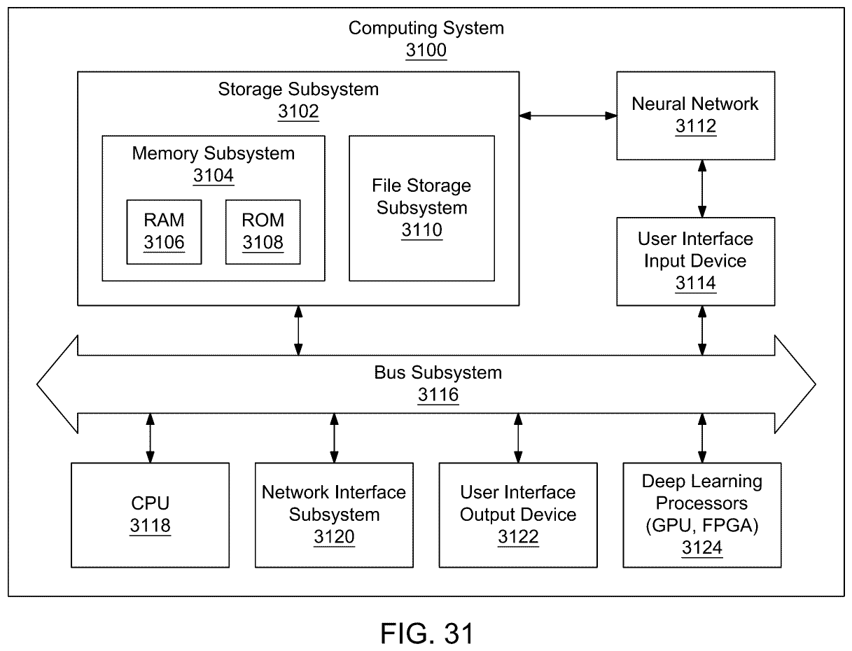

FIG. 31 shows an example computer system 3100 that can be used to implement the technology disclosed. The computer system 3100 is a representation of the system, as described in FIG. 4. The computer system 3100 includes at least one central processing unit (CPU) 3118 that communicates with a number of peripheral devices via bus subsystem 3116. These peripheral devices can include a storage subsystem 3102 including, for example, memory devices and a file storage subsystem 3110, user interface input devices 3114, user interface output devices 3122, and a network interface subsystem 3120. The input and output devices allow user interaction with computer system 3100. Network interface subsystem 3120 provides an interface to outside networks, including an interface to corresponding interface devices in other computer systems.

In one implementation, a neural network 3112 is communicably linked to the storage subsystem 3102 and the user interface input devices 3114.

User interface input devices 3114 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 3100.

User interface output devices 3122 can include a display subsystem, a printer, a fax machine, or non-visual displays such as audio output devices. The display subsystem can include an LED display, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 3100 to the user or to another machine or computer system.

Storage subsystem 3102 stores programming and data constructs that provide the functionality of some or all of the modules and methods described herein. These software modules are generally executed by deep learning processors 3124.

Deep learning processors 3124 can be graphics processing units (GPUs), field-programmable gate arrays (FPGAs), application-specific integrated circuits (ASICs), and/or coarse-grained reconfigurable architectures (CGRAs). Processors 3124 can be hosted by a deep learning cloud platform such as Google Cloud Platform™, Xilinx™, and Cirrascale™ Examples of processors 3124 include Google's Tensor Processing Unit (TPU)™, rackmount solutions like GX4 Rackmount Series™, GX6 Rackmount Series™, NVIDIA DGX-1™, Microsoft's Stratix V FPGA™, Graphcore's Intelligent Processor Unit (IPU)™, Qualcomm's Zeroth Platform™ with Snapdragon Processors™, NVIDIA's Volta™, NVIDIA's DRIVE PX™, NVIDIA's JETSON TX1/TX2 MODULE™, Intel's Nirvana™, Movidius VPU™ Fujitsu DPI™, ARM's DynamicIQ™, IBM TrueNorth™, Lambda GPU Server with Testa V100s™, and others.

Memory subsystem 3104 used in the storage subsystem 3102 can include a number of memories including a main random-access memory (RAM) 3106 for storage of instructions and data during program execution and a read only memory (ROM) 3108 in which fixed instructions are stored. A file storage subsystem 3110 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 3110 in the storage subsystem 3102, or in other machines accessible by the processor.

Bus subsystem 3116 provides a mechanism for letting the various components and subsystems of computer system 3100 communicate with each other as intended. Although bus subsystem 3116 is shown schematically as a single bus, alternative implementations of the bus subsystem can use multiple buses.

Computer system 3100 itself can be of varying types including a personal computer, a portable computer, a workstation, a computer terminal, a network computer, a television, a mainframe, a server farm, a widely distributed set of loosely networked computers, or any other data processing system or user device. Due to the ever-changing nature of computers and networks, the description of computer system 3100 depicted in FIG. 31 is intended only as a specific example for the purpose of illustrating the preferred implementations of the present technology disclosed. Many other configurations of computer system 3100 are possible having more or fewer components than the computer system depicted in FIG. 31.

In various implementations, a learning system is provided. In some implementations, a feature vector is provided to a learning system. Based on the input features, the learning system generates one or more outputs. In some implementations, the output of the learning system is a feature vector. In some implementations, the learning system comprises an SVM. In other implementations, the learning system comprises an artificial neural network. In some implementations, the learning system is pre-trained using training data. In some implementations training data is retrospective data. In some implementations, the retrospective data is stored in a data store. In some implementations, the learning system may be additionally trained through manual curation of previously generated outputs.

In some implementations, an object detection pipeline is a trained classifier. In some implementations, the trained classifier is a random decision forest. However, it will be appreciated that a variety of other classifiers are suitable for use according to the present disclosure, including linear classifiers, support vector machines (SVM), or neural networks such as recurrent neural networks (RNN).

Suitable artificial neural networks include but are not limited to a feedforward neural network, a radial basis function network, a self-organizing map, learning vector quantization, a recurrent neural network, a Hopfield network, a Boltzmann machine, an echo state network, long short term memory, a bi-directional recurrent neural network, a hierarchical recurrent neural network, a stochastic neural network, a modular neural network, an associative neural network, a deep neural network, a deep belief network, a convolutional neural networks, a convolutional deep belief network, a large memory storage and retrieval neural network, a deep Boltzmann machine, a deep stacking network, a tensor deep stacking network, a spike and slab restricted Boltzmann machine, a compound hierarchical-deep model, a deep coding network, a multilayer kernel machine, or a deep Q-network.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer system/server may be described in the general context of computer system-executable instructions, such as program modules, being executed by a computer system. Generally, program modules may include routines, programs, objects, components, logic, data structures, and so on that perform particular tasks or implement particular abstract data types. Computer system/server may be practiced in distributed computing environments where tasks are performed by remote processing devices that are linked through a communications network. In a distributed computing environment, program modules may be located in both local and remote computer system storage media including memory storage devices.

As shown in FIG. 31, computer system/server in computing node is shown in the form of a general-purpose computing device. The components of computer system/server may include, but are not limited to, one or more processors or processing units, a system memory, and a bus that couples various system components including system memory to processor.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server typically includes a variety of computer system readable media. Such media may be any available media that is accessible by computer system/server, and it includes both volatile and non-volatile media, removable and non-removable media.

System memory can include computer system readable media in the form of volatile memory, such as random access memory (RAM) and/or cache memory. Algorithm Computer system/server may further include other removable/non-removable, volatile/non-volatile computer system storage media. By way of example only, storage system can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, memory may include at least one program product having a set (e.g., at least one) of program modules that are configured to carry out the functions of embodiments of the disclosure.

Program/utility, having a set (at least one) of program modules, may be stored in memory by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of embodiments as described herein.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

The following detailed description is made with reference to the figures. Example implementations are described to illustrate the technology disclosed, not to limit its scope, which is defined by the claims. Those of ordinary skill in the art will recognize a variety of equivalent variations on the description that follows. Reference will now be made in detail to the exemplary implementations of the present disclosure, examples of which are illustrated in the accompanying drawings. Wherever possible, the same reference numbers will be used throughout the drawings to refer to the same or like parts.

The following discussion is presented to enable any person skilled in the art to make and use the technology disclosed and is provided in the context of a particular application and its requirements. Various modifications to the disclosed implementations will be readily apparent to those skilled in the art, and the general principles defined herein may be applied to other implementations and applications without departing from the spirit and scope of the technology disclosed. Thus, the technology disclosed is not intended to be limited to the implementations shown but is to be accorded the widest scope consistent with the principles and features disclosed herein.

The systems, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these devices, systems, or methods unless specifically designated as mandatory.

Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

The detailed description of various implementations will be better understood when read in conjunction with the appended drawings. To the extent that the figures illustrate diagrams of the functional blocks of the various implementations, the functional blocks are not necessarily indicative of the division between hardware circuitry. Thus, for example, one or more of the functional blocks (e.g., modules, processors, or memories) may be implemented in a single piece of hardware (e.g., a general-purpose signal processor or a block of random-access memory, hard disk, or the like) or multiple pieces of hardware. Similarly, the programs may be stand-alone programs, may be incorporated as subroutines in an operating system, may be functions in an installed software package, and the like. It should be understood that the various implementations are not limited to the arrangements and instrumentality shown in the drawings.

The processing engines and databases of the figures, designated as modules, can be implemented in hardware or software, and need not be divided up in precisely the same blocks as shown in the figures. Some of the modules can also be implemented on different processors, computers, or servers, or spread among a number of different processors, computers, or servers. In addition, it will be appreciated that some of the modules can be combined, operated in parallel or in a different sequence than that shown in the figures without affecting the functions achieved. The modules in the figures can also be thought of as flowchart steps in a method. A module also need not necessarily have all its code disposed contiguously in memory; some parts of the code can be separated from other parts of the code with code from other modules or other functions disposed in between.

The technology disclosed can be practiced as a system, method, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

One or more implementations and clauses of the technology disclosed, or elements thereof can be implemented in the form of a computer product, including a non-transitory computer readable storage medium with computer usable program code for performing the method steps indicated. Furthermore, one or more implementations and clauses of the technology disclosed, or elements thereof can be implemented in the form of an apparatus including a memory and at least one processor that is coupled to the memory and operative to perform exemplary method steps. Yet further, in another aspect, one or more implementations and clauses of the technology disclosed or elements thereof can be implemented in the form of means for carrying out one or more of the method steps described herein; the means can include (i) hardware module(s), (ii) software module(s) executing on one or more hardware processors, or (iii) a combination of hardware and software modules; any of (i)-(iii) implement the specific techniques set forth herein, and the software modules are stored in a computer readable storage medium (or multiple such media).

The clauses described in this section can be combined as features. In the interest of conciseness, the combinations of features are not individually enumerated and are not repeated with each base set of features. The reader will understand how features identified in the clauses described in this section can readily be combined with sets of base features identified as implementations in other sections of this application. These clauses are not meant to be mutually exclusive, exhaustive, or restrictive; and the technology disclosed is not limited to these clauses but rather encompasses all possible combinations, modifications, and variations within the scope of the claimed technology and its equivalents.

Other implementations of the clauses described in this section can include a non-transitory computer readable storage medium storing instructions executable by a processor to perform any of the clauses described in this section. Yet another implementation of the clauses described in this section can include a system including memory and one or more processors operable to execute instructions, stored in the memory, to perform any of the clauses described in this section.

### CLAUSES

1. A method performed by an agent for automating credential-related transactions, the method comprising:
   identifying, using a trained autoencoder of the agent, from visual content of a graphical user interface of a producer application, one or more credential interface elements that, upon activation, cause the producer application to output at least one credential for use by a consumer application other than the agent, wherein the trained autoencoder is configured to produce visual feature representations of interface elements rendered in the graphical user interface of the producer application and to classify the visual feature representations to identify the credential interface elements based on learned visual features extracted from pixel-level rendering of the graphical user interface;
   causing activation of the credential interface elements identified by the trained autoencoder to thereby obtain, from the producer application, at least one newly-created credential generated by the producer application in response to said activation, wherein the at least one newly-created credential is rendered within the graphical user interface of the producer application following said activation, and wherein the graphical user interface of the producer application provides an operational interface through which credential generation is effected exclusively through interaction with the graphical user interface of the producer application;
   copying, by a copy submodule of the agent, the at least one newly-created credential from the graphical user interface of the producer application by activating copy interface elements of the graphical user interface of the producer application;
   injecting, by a paste submodule of the agent, the at least one newly-created credential into an existing graphical user interface of the consumer application by activating paste interface elements of the existing graphical user interface of the consumer application; and storing, by a credential storage workflow engine of the agent, the at least one newly-created credential in a credential vault accessible by the consumer application, wherein the agent, the producer application, and the consumer application comprise distinct computing processes executing in respective process contexts.
2. The method of clause 1, wherein the trained autoencoder is further configured to classify interface elements of the graphical user interface of the producer application into (i) credential interface elements that change a state of the producer application upon activation and (ii) non-credential interface elements that provide contextual information in the graphical user interface.
3 The method of clause 1, wherein the identifying is performed in response to a credential generation instruction received from an identity control system, the credential generation instruction generated in response to at least one of an employee onboarding event, a role transition event, a contractor engagement event, and a credential rotation schedule event.
4. The method of clause 1, further comprising performing the identifying, the causing activation, the copying, the injecting, and the storing on a recurring schedule for credential rotation, the recurring schedule comprising at least one of a daily, weekly, monthly, or configurable-interval rotation cycle, wherein the recurring schedule replaces an existing credential associated with the consumer application with the at least one newly-created credential.
5. The method of clause 1, wherein the at least one newly-created credential comprises at least one of an application programming interface key, a password, an authentication token, an OAuth token, a session token, and an identity certificate.
6. The method of clause 1, wherein the producer application comprises at least one of an application programming interface key management console, a third-party partner platform, a token management interface, an internal administrative dashboard, and a cloud service provider console.
7. The method of clause 1, wherein the consumer application comprises at least one of a software-as-a-service application, an internal enterprise application, a financial system, a customer relationship management system, a cloud-native developer environment, and a field service application.
8. The method of clause 1, wherein the copy interface elements and the paste interface elements comprise at least one of input fields, buttons, drop-down selectors, and selection interfaces rendered within respective graphical user interfaces.
9. The method of clause 1, further comprising adapting, by the agent, to changes in the graphical user interface of the producer application by reapplying the trained autoencoder to a modified graphical user interface of the producer application, wherein reapplication of the trained autoencoder identifies repositioned credential interface elements, modified element labels, and updated interface layouts in the modified graphical user interface.
10. The method of clause 1, further comprising:
   receiving, by an agent execution manager of the agent, a credential generation instruction from an identity control system;
   decomposing, by the agent execution manager, the credential generation instruction into one or more atomic tasks comprising at least one of credential creation, credential update, credential removal, and credential rotation; and
   triggering, by the agent execution manager, a credential generation agent of the agent, a copy-paste interface automation module of the agent comprising the copy submodule and the paste submodule, and the credential storage workflow engine in parallel to execute the one or more atomic tasks.
11. The method of clause 1, wherein the credential vault is configured to provide at least one of encryption-at-rest of the at least one newly-created credential, role-based retrieval constraints governing access to the at least one newly-created credential by the consumer application, credential versioning and rotation, and time-to-live expiration of the at least one newly-created credential after a predefined time period.
12. The method of clause 1, further comprising generating, for each performance of the method, a tamper-evident audit record stored in a secure audit repository, the tamper-evident audit record comprising an identifier of the producer application, an identifier of the consumer application, a timestamp of the credential generation, a type of the at least one newly-created credential, and an outcome status of the method.
13. The method of clause 12, wherein the tamper-evident audit record is formatted for compliance reporting under at least one regulatory framework selected from the Sarbanes-Oxley Act, the Health Insurance Portability and Accountability Act, the General Data Protection Regulation, the Payment Card Industry Data Security Standard, and successor or equivalent regulatory frameworks.
14. The method of clause 1, wherein the identifying, the causing activation, the copying, the injecting, and the storing are performed autonomously by the agent between receipt of the credential generation instruction and delivery of the at least one newly-created credential to the consumer application.
15. The method of clause 1, further comprising validating, by a security and access mediator of the agent, enterprise access policies during the identifying, the causing activation, the copying, the injecting, and the storing, and aborting the method upon detection of a policy violation by the security and access mediator.
16. The method of clause 1, further comprising dispatching, by a notification and alert manager of the agent, asynchronous alerts upon completion or failure of the method, wherein the asynchronous alerts are transmitted to at least one of the identity control system, an enterprise administrator, and a compliance audit repository.
17. A system for automating credential generation and propagation, the system comprising:
   one or more processors; and
   one or more non-transitory computer-readable memories storing instructions that, when executed by the one or more processors, implement:
   a credential generation agent comprising a trained autoencoder configured to produce visual feature representations of interface elements rendered in a graphical user interface of a producer application and to classify the visual feature representations to identify one or more credential interface elements that, upon activation, cause the producer application to output a newly-created credential, the trained autoencoder operating on learned visual features extracted from pixel-level rendering of the graphical user interface, the credential generation agent being further configured to trigger activation of the credential interface elements such that the producer application generates the newly-created credential and renders the newly-created credential within the graphical user interface following said activation, wherein the graphical user interface of the producer application provides an operational interface through which credential generation is effected exclusively through interaction with the graphical user interface;
   a copy-paste interface automation module comprising a copy submodule configured to copy the newly-created credential from the graphical user interface of the producer application by activating copy interface elements of the graphical user interface of the producer application, and a paste submodule configured to inject the newly-created credential into an existing graphical user interface of a consumer application by activating paste interface elements of the existing graphical user interface of the consumer application; and
   a credential storage workflow engine configured to inject the newly-created credential into a credential vault accessible by the consumer application and to embed the newly-created credential into the existing graphical user interface of the consumer application, wherein the system, the producer application, and the consumer application comprise distinct computing processes executing in respective process contexts.
18. The system of clause 17, wherein the credential generation agent is further configured to adapt to changes in the graphical user interface of the producer application by reapplying the trained autoencoder to a modified graphical user interface of the producer application, wherein reapplication of the trained autoencoder identifies repositioned credential interface elements, modified element labels, and updated interface layouts in the modified graphical user interface.
19. The system of clause 17, wherein the instructions further implement an audit logging component configured to generate, for each execution of the credential generation agent, the copy-paste interface automation module, and the credential storage workflow engine that produces the newly-created credential and propagates the newly-created credential to the consumer application, a tamper-evident audit record stored in a secure audit repository, the tamper-evident audit record comprising an identifier of the producer application, an identifier of the consumer application, a timestamp of the credential generation, a type of the newly-created credential, and an outcome status.
20. A non-transitory computer-readable medium storing instructions that, when executed by at least one processor, cause the at least one processor to perform operations comprising:
   identifying, using a trained autoencoder, from visual content of a graphical user interface of a producer application, one or more credential interface elements that, upon activation, cause the producer application to output at least one newly-created credential for use by a consumer application that is distinct from a computing system executing the instructions, the trained autoencoder being configured to produce visual feature representations of interface elements and to classify the visual feature representations based on learned visual features extracted from pixel-level rendering of the graphical user interface of the producer application, and wherein the graphical user interface of the producer application provides an operational interface through which credential generation is effected exclusively through interaction with the graphical user interface;
   causing activation of the credential interface elements identified by the trained autoencoder to thereby obtain, from the producer application, the at least one newly-created credential generated by the producer application in response to said activation, wherein the at least one newly-created credential is rendered within the graphical user interface of the producer application following said activation;
   copying the at least one newly-created credential from the graphical user interface of the producer application by activating copy interface elements of the graphical user interface of the producer application;
   injecting the at least one newly-created credential into an existing graphical user interface of the consumer application by activating paste interface elements of the existing graphical user interface of the consumer application; and
   storing the at least one newly-created credential in a credential vault accessible by the consumer application, wherein the computing system executing the instructions, the producer application, and the consumer application comprise distinct computing processes executing in respective process contexts.
21. The method of clause 1, wherein activating the credential interface elements causes the producer application to create, in response to said activation, the at least one newly-created credential, and wherein the at least one newly-created credential is output by the producer application as a result of said activation.
22. The method of clause 1, further comprising:
   receiving, by an agent execution manager of the agent, a credential generation instruction from an identity control system;
   decomposing, by the agent execution manager, the credential generation instruction into one or more atomic tasks comprising at least one of credential creation, credential update, credential removal, and credential rotation; and
   triggering, by the agent execution manager, a credential generation agent of the agent, a copy-paste interface automation module of the agent comprising the copy submodule and the paste submodule, and the credential storage workflow engine in parallel to execute the one or more atomic tasks.
23. The method of clause 1, further comprising performing the identifying, the causing activation, the copying, the injecting, and the storing on a recurring schedule for credential rotation, the recurring schedule comprising at least one of a daily rotation cycle, a weekly rotation cycle, a monthly rotation cycle, and a configurable-interval rotation cycle, wherein the recurring schedule replaces an existing credential associated with the consumer application with the at least one newly-created credential obtained from the producer application.
24. The method of clause 1, wherein the at least one newly-created credential comprises at least one of an application programming interface key, a password, an authentication token, an OAuth token, a session token, and an identity certificate.
25. A method performed by an agent for automating credential-related transactions, the method comprising:
   identifying, using a trained autoencoder of the agent, from visual content of a graphical user interface of a producer application, one or more credential interface elements that, upon activation, cause the producer application to output at least one credential for use by a consumer application other than the agent, the trained autoencoder being configured to produce visual feature representations of interface elements rendered in the graphical user interface of the producer application and to classify the visual feature representations to identify the credential interface elements based on learned visual features extracted from pixel-level rendering of the graphical user interface;
   causing activation of the credential interface elements identified by the trained autoencoder to thereby obtain, from the producer application, the at least one credential generated by the producer application in response to said activation, wherein the at least one credential generated in response to said activation is rendered within the graphical user interface of the producer application following said activation; and
   providing the at least one credential to the consumer application for use by the consumer application, wherein the agent, the producer application, and the consumer application comprise distinct computing processes executing in respective process contexts, and wherein the providing comprises supplying the at least one credential to the consumer application through interaction with an existing graphical user interface of the consumer application.
26. The method of clause 25, wherein the graphical user interface of the producer application provides an operational interface through which credential generation is effected, and wherein the causing activation effects credential generation of the producer application exclusively through interaction with the graphical user interface of the producer application.
27. The method of clause 25, wherein the causing activation causes the producer application to create, in response to said activation, a newly-created credential that is output by the producer application as the at least one credential as a result of said activation.
28. The method of clause 25, wherein the trained autoencoder is further configured to classify interface elements of the graphical user interface of the producer application into (i) credential interface elements that change a state of the producer application upon activation and (ii) non-credential interface elements that provide contextual information in the graphical user interface.
29. The method of clause 25, wherein providing the at least one credential to the consumer application comprises:
   copying the at least one credential from the graphical user interface of the producer application by activating copy interface elements of the graphical user interface of the producer application; and
   injecting the at least one credential into the existing graphical user interface of the consumer application by activating paste interface elements of the existing graphical user interface of the consumer application.
30. The method of clause 25, further comprising injecting the at least one credential into a credential vault accessible by the consumer application, wherein the credential vault stores the at least one credential in encrypted form and provides retrieval of the at least one credential to the consumer application, and wherein the consumer application accesses the at least one credential from the credential vault via the existing graphical user interface of the consumer application.
31. The method of clause 25, wherein the agent comprises:
   a credential generation agent configured to detect the credential interface elements of the graphical user interface of the producer application using the trained autoencoder and to trigger activation of the credential interface elements;
   a copy-paste interface automation module comprising a copy submodule configured to copy the at least one credential from the graphical user interface of the producer application and a paste submodule configured to inject the at least one credential into the existing graphical user interface of the consumer application; and
   a credential storage workflow engine configured to inject the at least one credential into a credential vault and to embed the at least one credential into the existing graphical user interface of the consumer application.
32. The method of clause 31, wherein the credential generation agent is further configured to adapt to changes in the graphical user interface of the producer application by reapplying the trained autoencoder to a modified graphical user interface of the producer application, wherein reapplication of the trained autoencoder identifies repositioned credential interface elements, modified element labels, and updated interface layouts in the modified graphical user interface.
33. The method of clause 31, further comprising:
   receiving, by an agent execution manager of the agent, a credential generation instruction from an identity control system;
   decomposing, by the agent execution manager, the credential generation instruction into one or more atomic tasks comprising at least one of credential creation, credential update, credential removal, and credential rotation; and
   triggering, by the agent execution manager, the credential generation agent, the copy-paste interface automation module, and the credential storage workflow engine in parallel to execute the one or more atomic tasks.
34. The method of clause 25, wherein the causing activation is performed in response to a credential generation instruction received from an identity control system, the credential generation instruction generated in response to at least one of an employee onboarding event, a role transition event, a contractor engagement event, and a credential rotation schedule event.
35. The method of clause 25, further comprising performing the identifying, the causing activation, and the providing on a recurring schedule for credential rotation, the recurring schedule comprising at least one of a daily, weekly, monthly, or configurable-interval rotation cycle, wherein the recurring schedule replaces an existing credential associated with the consumer application with a newly-created credential obtained from the producer application.
36. The method of clause 25, wherein the at least one credential comprises at least one of an application programming interface key, a password, an authentication token, an OAuth token, a session token, and an identity certificate.
37. The method of clause 25, wherein the identifying, the causing activation, and the providing are performed autonomously by the agent between receipt of a credential generation instruction and delivery of the at least one credential to the consumer application.
38. The method of clause 25, further comprising generating, for each performance of the method, a tamper-evident audit record stored in a secure audit repository, the tamper-evident audit record comprising an identifier of the producer application, an identifier of the consumer application, a timestamp of the credential generation, a type of the at least one credential generated, and an outcome status of the credential generation.
39. The method of clause 25, wherein the producer application and the consumer application comprise heterogeneous applications having different authentication protocols, credential formats, or interface layouts, and wherein the causing activation and the providing operate across the producer application and the consumer application exclusively through interaction with the graphical user interface of the producer application and the existing graphical user interface of the consumer application, respectively.
40. The method of clause 30, wherein the credential vault is configured to provide at least one of encryption-at-rest of the at least one credential, role-based retrieval constraints governing access to the at least one credential by the consumer application, credential versioning and rotation, and time-to-live expiration of the at least one credential after a predefined time period.
41. A system for automating credential generation and propagation, the system comprising:
   one or more processors; and
   one or more non-transitory computer-readable memories storing instructions that, when executed by the one or more processors, implement:
   a credential generation agent comprising a trained autoencoder configured to identify, from visual content of a graphical user interface of a producer application, one or more credential interface elements that, upon activation, cause the producer application to output at least one credential for use by a consumer application other than the system, the trained autoencoder being configured to produce visual feature representations of interface elements and to classify the visual feature representations to identify the credential interface elements based on learned visual features extracted from pixel-level rendering of the graphical user interface, the credential generation agent being further configured to cause activation of the credential interface elements identified by the trained autoencoder such that the producer application generates the at least one credential in response to said activation and renders the at least one credential within the graphical user interface of the producer application following said activation; and
   a credential propagation system configured to provide the at least one credential to the consumer application, wherein the system, the producer application, and the consumer application comprise distinct computing processes executing in respective process contexts, and wherein the credential propagation system is configured to supply the at least one credential to the consumer application through interaction with an existing graphical user interface of the consumer application.
42. The system of clause 41, wherein the credential propagation system comprises:
   a copy-paste interface automation module comprising a copy submodule configured to copy the at least one credential from the graphical user interface of the producer application and a paste submodule configured to inject the at least one credential into the existing graphical user interface of the consumer application; and
   a credential storage workflow engine configured to inject the at least one credential into a credential vault and to embed the at least one credential into the existing graphical user interface of the consumer application.
43. The system of clause 41, wherein the instructions further implement an audit logging component configured to generate, for each execution of the credential generation agent and the credential propagation system that produces the at least one credential and supplies the at least one credential to the consumer application, a tamper-evident audit record stored in a secure audit repository, the tamper-evident audit record comprising an identifier of the producer application, an identifier of the consumer application, a timestamp of the credential generation, a type of the at least one credential generated, and an outcome status of the credential generation.
44. A non-transitory computer-readable medium storing instructions that, when executed by at least one processor, cause the at least one processor to perform operations comprising:
   identifying, using a trained autoencoder, from visual content of a graphical user interface of a producer application, one or more credential interface elements that, upon activation, cause the producer application to output at least one credential for use by a consumer application that is distinct from a computing system executing the instructions, the trained autoencoder being configured to produce visual feature representations of interface elements and to classify the visual feature representations to identify the credential interface elements based on learned visual features extracted from pixel-level rendering of the graphical user interface of the producer application;
   causing activation of the credential interface elements identified by the trained autoencoder to thereby obtain, from the producer application, the at least one credential generated by the producer application in response to said activation, wherein the at least one credential generated in response to said activation is rendered within the graphical user interface of the producer application following said activation; and
   providing the at least one credential to the consumer application for use by the consumer application, wherein the computing system executing the instructions, the producer application, and the consumer application comprise distinct computing processes executing in respective process contexts, and wherein the providing comprises supplying the at least one credential to the consumer application through interaction with an existing graphical user interface of the consumer application.
45. A method performed by an agent for automating credential-related transactions, the method comprising:
   identifying, using a trained machine learning model of the agent, from visual content of a graphical user interface of a producer application, one or more credential interface elements that, upon activation, cause the producer application to output at least one credential for use by a consumer application other than the agent, the identifying being based on learned visual features extracted by the trained machine learning model from pixel-level rendering of the graphical user interface of the producer application;
   causing activation of the credential interface elements identified by the trained machine learning model to thereby obtain, from the producer application, the at least one credential generated by the producer application in response to said activation, wherein the at least one credential generated in response to said activation is rendered within the graphical user interface of the producer application following said activation; and
   providing the at least one credential to the consumer application for use by the consumer application, wherein the agent, the producer application, and the consumer application comprise distinct computing processes executing in respective process contexts, and wherein the providing comprises supplying the at least one credential to the consumer application through interaction with an existing graphical user interface of the consumer application.
46. The method of clause 45, wherein the trained machine learning model comprises a trained autoencoder configured to produce visual feature representations of interface elements rendered in the graphical user interface of the producer application and to classify the visual feature representations to identify the credential interface elements.
47. The method of clause 45, wherein the graphical user interface of the producer application provides an operational interface through which credential generation is effected, and wherein the causing activation effects credential generation of the producer application exclusively through interaction with the graphical user interface of the producer application.
48. The method of clause 45, wherein the causing activation causes the producer application to create, in response to said activation, a newly-created credential that is output by the producer application as the at least one credential as a result of said activation.
49. The method of clause 46, wherein the trained autoencoder is further configured to classify interface elements of the graphical user interface of the producer application into (i) credential interface elements that change a state of the producer application upon activation and (ii) non-credential interface elements that provide contextual information in the graphical user interface.
50. The method of clause 45, wherein providing the at least one credential to the consumer application comprises:
   copying the at least one credential from the graphical user interface of the producer application by activating copy interface elements of the graphical user interface of the producer application; and
   injecting the at least one credential into the existing graphical user interface of the consumer application by activating paste interface elements of the existing graphical user interface of the consumer application.
51. The method of clause 45, further comprising injecting the at least one credential into a credential vault accessible by the consumer application, wherein the credential vault stores the at least one credential in encrypted form and provides retrieval of the at least one credential to the consumer application, and wherein the consumer application accesses the at least one credential from the credential vault via the existing graphical user interface of the consumer application.
52. The method of clause 45, wherein the agent comprises:
   a credential generation agent configured to detect the credential interface elements of the graphical user interface of the producer application using the trained machine learning model and to trigger activation of the credential interface elements;
   a copy-paste interface automation module comprising a copy submodule configured to copy the at least one credential from the graphical user interface of the producer application and a paste submodule configured to inject the at least one credential into the existing graphical user interface of the consumer application; and
   a credential storage workflow engine configured to inject the at least one credential into a credential vault and to embed the at least one credential into the existing graphical user interface of the consumer application.
53. The method of clause 52, wherein the credential generation agent is further configured to adapt to changes in the graphical user interface of the producer application by reapplying the trained machine learning model to a modified graphical user interface of the producer application, wherein reapplication of the trained machine learning model identifies repositioned credential interface elements, modified element labels, and updated interface layouts in the modified graphical user interface.
54. The method of clause 52, further comprising:
   receiving, by an agent execution manager of the agent, a credential generation instruction from an identity control system;
   decomposing, by the agent execution manager, the credential generation instruction into one or more atomic tasks comprising at least one of credential creation, credential update, credential removal, and credential rotation; and
   triggering, by the agent execution manager, the credential generation agent, the copy-paste interface automation module, and the credential storage workflow engine in parallel to execute the one or more atomic tasks.
55. The method of clause 45, wherein the causing activation is performed in response to a credential generation instruction received from an identity control system, the credential generation instruction generated in response to at least one of an employee onboarding event, a role transition event, a contractor engagement event, and a credential rotation schedule event.
56. The method of clause 45, further comprising performing the identifying, the causing activation, and the providing on a recurring schedule for credential rotation, the recurring schedule comprising at least one of a daily, weekly, monthly, or configurable-interval rotation cycle, wherein the recurring schedule replaces an existing credential associated with the consumer application with a newly-created credential obtained from the producer application.
57. The method of clause 45, wherein the at least one credential comprises at least one of an application programming interface key, a password, an authentication token, an OAuth token, a session token, and an identity certificate.
58. The method of clause 45, wherein the identifying, the causing activation, and the providing are performed autonomously by the agent between receipt of a credential generation instruction and delivery of the at least one credential to the consumer application.
59. The method of clause 45, further comprising generating, for each performance of the method, a tamper-evident audit record stored in a secure audit repository, the tamper-evident audit record comprising an identifier of the producer application, an identifier of the consumer application, a timestamp of the credential generation, a type of the at least one credential generated, and an outcome status of the credential generation.
60. The method of clause 46, wherein the graphical user interface of the producer application provides an operational interface through which credential generation is effected, and wherein the causing activation effects credential generation of the producer application exclusively through interaction with the graphical user interface of the producer application.
61. A system for automating credential generation and propagation, the system comprising:
   one or more processors; and
   one or more non-transitory computer-readable memories storing instructions that, when executed by the one or more processors, implement:
   a credential generation agent comprising a trained machine learning model configured to identify, from visual content of a graphical user interface of a producer application, one or more credential interface elements that, upon activation, cause the producer application to output at least one credential for use by a consumer application other than the system, the trained machine learning model being configured to identify the credential interface elements based on learned visual features extracted from pixel-level rendering of the graphical user interface of the producer application, the credential generation agent being further configured to cause activation of the credential interface elements identified by the trained machine learning model such that the producer application generates the at least one credential in response to said activation and renders the at least one credential within the graphical user interface of the producer application following said activation; and
   a credential propagation system configured to provide the at least one credential to the consumer application, wherein the system, the producer application, and the consumer application comprise distinct computing processes executing in respective process contexts, and wherein the credential propagation system is configured to supply the at least one credential to the consumer application through interaction with an existing graphical user interface of the consumer application.
62. The system of clause 61, wherein the trained machine learning model comprises a trained autoencoder configured to produce visual feature representations of interface elements rendered in the graphical user interface of the producer application and to classify the visual feature representations to identify the credential interface elements.
63. The system of clause 61, wherein the credential propagation system comprises:
   a copy-paste interface automation module comprising a copy submodule configured to copy the at least one credential from the graphical user interface of the producer application and a paste submodule configured to inject the at least one credential into the existing graphical user interface of the consumer application; and
   a credential storage workflow engine configured to inject the at least one credential into a credential vault and to embed the at least one credential into the existing graphical user interface of the consumer application.
64. A non-transitory computer-readable medium storing instructions that, when executed by at least one processor, cause the at least one processor to perform operations comprising:
   identifying, using a trained machine learning model, from visual content of a graphical user interface of a producer application, one or more credential interface elements that, upon activation, cause the producer application to output at least one credential for use by a consumer application that is distinct from a computing system executing the instructions, the identifying being based on learned visual features extracted by the trained machine learning model from pixel-level rendering of the graphical user interface of the producer application;
   causing activation of the credential interface elements identified by the trained machine learning model to thereby obtain, from the producer application, the at least one credential generated by the producer application in response to said activation, wherein the at least one credential generated in response to said activation is rendered within the graphical user interface of the producer application following said activation; and
   providing the at least one credential to the consumer application for use by the consumer application, wherein the computing system executing the instructions, the producer application, and the consumer application comprise distinct computing processes executing in respective process contexts, and wherein the providing comprises supplying the at least one credential to the consumer application through interaction with an existing graphical user interface of the consumer application.

The above-described hardware description is a non-limiting example of corresponding structure for performing the functionality described herein.

Numerous modifications and variations of the present disclosure are possible in light of the above teachings. It is therefore to be understood that the invention may be practiced otherwise than as specifically described herein.

1. A method performed by an agent for automating credential-related transactions, the method comprising:
identifying, using a trained machine learning model of the agent, from visual content of a graphical user interface of a producer application, one or more credential interface elements that, upon activation, cause the producer application to output at least one credential for use by a consumer application other than the agent, the identifying being based on learned visual features extracted by the trained machine learning model from pixel-level rendering of the graphical user interface of the producer application;
causing activation of the credential interface elements identified by the trained machine learning model to thereby obtain, from the producer application, the at least one credential generated by the producer application in response to said activation, wherein the at least one credential generated in response to said activation is rendered within the graphical user interface of the producer application following said activation; and
providing the at least one credential to the consumer application for use by the consumer application, wherein the agent, the producer application, and the consumer application comprise distinct computing processes executing in respective process contexts, and wherein the providing comprises supplying the at least one credential to the consumer application through interaction with an existing graphical user interface of the consumer application.

2. The method of claim 1, wherein the trained machine learning model comprises a trained autoencoder configured to produce visual feature representations of interface elements rendered in the graphical user interface of the producer application and to classify the visual feature representations to identify the credential interface elements.

3. The method of claim 1, wherein the graphical user interface of the producer application provides an operational interface through which credential generation is effected, and wherein the causing activation effects credential generation of the producer application by interaction with the graphical user interface of the producer application.

4. The method of claim 2, wherein the trained autoencoder is further configured to classify interface elements of the graphical user interface of the producer application into (i) credential interface elements that change a state of the producer application upon activation and (ii) non-credential interface elements that provide contextual information in the graphical user interface.

5. The method of claim 1, wherein providing the at least one credential to the consumer application comprises:
copying the at least one credential from the graphical user interface of the producer application by activating copy interface elements of the graphical user interface of the producer application; and
injecting the at least one credential into the existing graphical user interface of the consumer application by activating paste interface elements of the existing graphical user interface of the consumer application.

6. The method of claim 1, further comprising injecting the at least one credential into a credential vault accessible by the consumer application, wherein the credential vault stores the at least one credential in encrypted form and provides retrieval of the at least one credential to the consumer application, and wherein the agent, through interaction with the existing graphical user interface of the consumer application, configures the consumer application to retrieve the at least one credential from the credential vault.

7. The method of claim 1, wherein the agent comprises:
a credential generation agent configured to detect the credential interface elements of the graphical user interface of the producer application using the trained machine learning model and to trigger activation of the credential interface elements;
a copy-paste interface automation module comprising a copy submodule configured to copy the at least one credential from the graphical user interface of the producer application and a paste submodule configured to inject the at least one credential into the existing graphical user interface of the consumer application; and
a credential storage workflow engine configured to inject the at least one credential into a credential vault and to embed the at least one credential into the existing graphical user interface of the consumer application.

8. The method of claim 7, wherein the credential generation agent is further configured to adapt to changes in the graphical user interface of the producer application by reapplying the trained machine learning model to a modified graphical user interface of the producer application, wherein reapplication of the trained machine learning model identifies repositioned credential interface elements, modified element labels, and updated interface layouts in the modified graphical user interface.

9. The method of claim 1, wherein the causing activation is performed in response to a credential generation instruction received from an identity control system, the credential generation instruction generated in response to at least one of an employee onboarding event, a role transition event, a contractor engagement event, and a credential rotation schedule event.

10. The method of claim 1, wherein the identifying, the causing activation, and the providing are performed autonomously by the agent between receipt of a credential generation instruction and delivery of the at least one credential to the consumer application.

11. The method of claim 1, further comprising generating, for each performance of the method, a tamper-evident audit record stored in a secure audit repository, the tamper-evident audit record comprising an identifier of the producer application, an identifier of the consumer application, a timestamp of the credential generation, a type of the at least one credential generated, and an outcome status of the credential generation.

12. A non-transitory computer-readable medium storing instructions that, when executed by at least one processor, cause the at least one processor to perform operations comprising:
identifying, using a trained machine learning model, from visual content of a graphical user interface of a producer application, one or more credential interface elements that, upon activation, cause the producer application to output at least one credential for use by a consumer application that is distinct from a computing system executing the instructions, the identifying being based on learned visual features extracted by the trained machine learning model from pixel-level rendering of the graphical user interface of the producer application;
causing activation of the credential interface elements identified by the trained machine learning model to thereby obtain, from the producer application, the at least one credential generated by the producer application in response to said activation, wherein the at least one credential generated in response to said activation is rendered within the graphical user interface of the producer application following said activation; and
providing the at least one credential to the consumer application for use by the consumer application, wherein the computing system executing the instructions, the producer application, and the consumer application comprise distinct computing processes executing in respective process contexts, and wherein the providing comprises supplying the at least one credential to the consumer application through interaction with an existing graphical user interface of the consumer application.

13. A method performed by an agent for automating identity lifecycle transactions, the method comprising:
receiving, by the agent from an authoritative system of record, a state-change signal corresponding to an identity lifecycle event affecting a user;
translating, by the agent, an identity lifecycle policy associated with the state-change signal into a sequence of one or more atomic identity lifecycle actions to be effected against one or more applications;
identifying, using a trained machine learning model of the agent, from visual content of a graphical user interface of an application against which an atomic identity lifecycle action of the sequence is to be effected, one or more identity lifecycle interface elements that, upon activation, cause the application to effect the atomic identity lifecycle action, the identifying being based on learned visual features extracted by the trained machine learning model from pixel-level rendering of the graphical user interface;
causing activation of the identity lifecycle interface elements identified by the trained machine learning model to thereby effect the atomic identity lifecycle action at the application; and
verifying, based on post-activation visual content of the graphical user interface of the application, at least one of (i) an identity-related artifact rendered within the graphical user interface of the application following said activation and (ii) an identity state change observable within the graphical user interface of the application following said activation,
wherein the agent and the one or more applications comprise distinct computing processes executing in respective process contexts.

14. The method of claim 13, wherein the authoritative system of record comprises at least one of a Human Resources Information System, an Identity Provider, and an Identity Governance and Administration platform.

15. The method of claim 13, wherein the identity lifecycle event comprises at least one of a joiner event, a mover event, and a leaver event, and wherein:
the joiner event comprises at least one of an employee onboarding event, a contractor engagement event, and a partner provisioning event;
the mover event comprises at least one of a role transition event, a department transfer event, a promotion event, a demotion event, a manager change event, a location change event, and a group membership modification event; and
the leaver event comprises at least one of an employee separation event, a contractor disengagement event, a partner offboarding event, and a retirement event.

16. The method of claim 13, wherein translating the identity lifecycle policy comprises:
providing the identity lifecycle policy, a current identity state of the user, and a target application context to a planning component, the planning component comprising at least one of a large language model, a rules engine, a decision tree, a state machine, and a pre-defined action template library; and
receiving from the planning component the sequence of one or more atomic identity lifecycle actions expressed as an ordered sequence of action records, each action record specifying an interface element class identifier, an action verb, and an action value where applicable.

17. The method of claim 16, wherein the identity lifecycle policy comprises an organizational policy assigning the user to a department, role, group, license, or entitlement, and wherein the sequence of one or more atomic identity lifecycle actions comprises locating a user profile interface, selecting a corresponding value using a dropdown, checkbox, radio button, text field, or selector, and activating a save or apply control.

18. The method of claim 13, wherein the one or more applications comprises a plurality of applications, and wherein the method further comprises:
enumerating the plurality of applications by consulting at least one of (i) an access map identifying applications in which the user holds access, (ii) federation records of an Identity Provider, and (iii) a directory enumeration in which the agent searches a configured set of applications for an account corresponding to the user; and
dispatching the sequence of one or more atomic identity lifecycle actions to the plurality of applications in parallel, in sequence, or in a hybrid order.

19. The method of claim 18, wherein the dispatching is performed within a cross-application atomic transaction boundary that produces a binary commit or rollback outcome based on collective success or failure of the atomic identity lifecycle actions across the plurality of applications, and wherein, upon failure of the cross-application atomic transaction, the agent emits one or more compensating atomic identity lifecycle actions to restore prior identity state at applications of the plurality of applications where corresponding atomic identity lifecycle actions had completed successfully.

20. The method of claim 13, wherein the identity lifecycle event comprises a leaver event indicated by a termination signal, and wherein causing activation of the identity lifecycle interface elements comprises navigating the graphical user interface of a disconnected application, locating a user account corresponding to the user, identifying at least one revocation interface element comprising a deactivate control, a suspend control, a delete control, an access removal control, or a role-removal control, and activating the at least one revocation interface element to revoke access of the user to the disconnected application.
